(19) United States
(12) Patent Application Publication
(10) Pub. No.: US 2002/0102484 A1
(43) Pub. Date: Aug. 1, 2002

(54) Electrophotosensitive material

(76) Inventors: Eiichi Miyamoto, Osaka -shi (JP); Yoshio Inagaki, Osaka-shi (JP); Hideaki Fukunaga, Yokaichi-shi (JP)

Correspondence Address: SMITH, GAMBRELL & RUSSELL, LLP, Suite 800, 1850 M Street, N.W., Washington, DC, 20036, US

(21) Appl. No.: 09/954,434

(22) Filed: Sep. 18, 2001

(30) Foreign Application Priority Data
Sep. 18, 2000 (JP) 2000-281049
Sep. 27, 2000 (JP) 2000-293942
Sep. 27, 2000 (JP) 2000-293943
Oct. 11, 2000 (JP) 2000-310165
Oct. 11, 2000 (JP) 2000-310166
Nov. 7, 2000 (JP) 2000-338417

(51) Int. Cl. G03G 5/047; G03G 5/06

(52) U.S. Cl. 430/58.25; 430/58.35; 430/66; 430/76; 430/56; 430/72; 430/70

(57) ABSTRACT

The invention relates to an electrophotosensitive material comprising an organic photosensitive layer and an inorganic surface protective layer, wherein at least an outermost part of the organic photosensitive layer contains any one of the compounds represented by formulas (1) to (4).

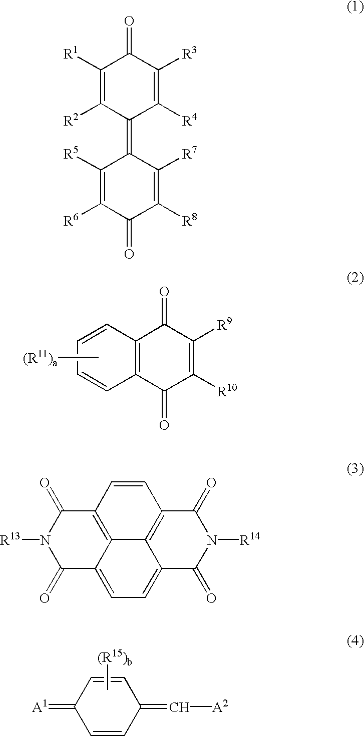

The electrophotosensitive material features more excellent durability because the compounds function as a binder for combining the organic photosensitive layer with the inorganic surface protective layer so that the surface protective layer is less prone to suffer cracks or delamination.

### TECHNICAL FIELD

The present invention relates to an electrophotosensitive material.

### BACKGROUND OF THE INVENTION

As an electrophotosensitive material for use in image forming apparatuses such as electrostatic copiers, laser beam printers, plain paper facsimiles and the like, a so-called organic electrophotosensitive material is widespread which comprises a combination of the following components:

a charge generating material for generating an electric charge (positive hole and electron) when exposed to light;

a charge transport material for transporting the generated electric charge; and

a binder resin.

The charge transport materials fall into two broad categories which include a positive-hole transport material for transporting positive holes of the electric charge, and an electron transport material for transporting electrons.

The organic electrophotosensitive material has an advantage over an inorganic electrophotosensitive material employing an inorganic semiconductor material in that the organic electrophotosensitive material is fabricated more easily at less production costs than the latter.

In addition, the organic electrophotosensitive material also has a merit of greater freedom of function design by virtue of a wide variety of options for materials including charge generating materials, charge transport materials, binder resins and the like.

The organic electrophotosensitive material is constructed by forming a single-layer or multi-layer photosensitive layer over a conductive substrate.

The single-layer photosensitive layer is formed by dispersing a charge generating material and a charge transport material (a positive-hole transport material and/or an electron transport material) in a binder resin.

The multi-layer photosensitive layer is formed by forming a lamination of the charge generating layer containing the charge generating material and the charge transport layer containing the charge transport material (the positive-hole transport material or the electron transport material).

Despite the aforementioned various merits, the organic electrophotosensitive material is susceptible to scratches, mars and the like in an actual use environment, thus suffering a smaller durability than the inorganic electrophotosensitive material.

With an aim at increasing the durability of the organic electrophotosensitive material by solving the above problem, study has been made on an approach to overlay a surface protective layer on an outermost layer.

The widely used surface protective layer is exemplified by an organic layer which is preferable in the light of adhesion to and affinity with the organic photosensitive layer, integrity as a lamination, and consistency in the film forming process. A usable surface protective layer includes, for example, a layer of binder resin, and a layer of binder resin having conductive particles, such as of metal oxides, dispersed therein.

However, the electrophotosensitive material employing such an organic layer as the surface protective layer suffers the drawbacks of an increased residual potential and a lowered chargeability when repeatedly used for image forming processes, and of significant variations in the photosensitivity characteristics due to environmental changes (temperature, humidity and the like).

In this connection, more recent years have seen investigations made on the use of an inorganic layer as the surface protective layer, the inorganic layer comprising an inorganic material such as metallic elements, carbon and inorganic compounds containing any of these elements, and having high hardness and wear resistance. The inorganic surface protective layer may be laid over the organic photosensitive layer by, for example, the vapor deposition method such as sputtering, plasma CVD, photo CVD or the like.

The inorganic surface protective layer is employed for the purposes of protecting the organic photosensitive layer and overcoming the above problem. specifically, the electrophotosensitive material with the inorganic surface protective layer laid over the organic photosensitive layer has functions associated with the characteristics of the individual layers thereof, the organic photosensitive layer involved in the generation and transport of the electric charge, the surface protective layer responsible for ensuring the good durability and environmental resistance.

As compared with the organic surface protective layer, however, the inorganic surface protective layer has a lower ability to achieve a sufficient adhesion to the organic photosensitive layer. Even if adjustments for the deposition process or the deposition conditions may provide the inorganic layer with a sufficient initial adhesion to the organic layer, the inorganic layer is prone to suffer cracks or delamination due to various stresses imposed thereon under the actual use environment or during the long-term storage thereof.

In the combination of the organic photosensitive layer and the inorganic surface protective layer, which are formed of different materials, there are not attained as good adhering relation, affinity and integrity as in the combination of the organic layers or of the inorganic layers. That is, the organic layer and the inorganic layer are often merely combined with each other through a very small binding strength.

Accordingly, when subjected to mechanical stresses such as of contact pressure from a cleaning blade of the image forming apparatus, or thermal stresses due to repeated cycles of heating during the operation of the apparatus and cooling during the nonoperation thereof, or temperature changes during storage, the electrophotosensitive material will suffer cracks in the inorganic surface protective layer or delamination of the surface protective layer from the organic photosensitive layer as a result of increased differences between the hardnesses, flexibilities, expansion/shrinkage properties or the like of these layers.

In the present conditions, therefore, the conventional inorganic surface protective layer is yet to be put to practical use because it has not achieved a sufficient effect to increase the durability of the organic photosensitive layer.

### SUMMARY OF THE INVENTION

It is an object of the invention to provide an organic electrophotosensitive material comprising an inorganic surface protective layer less prone to suffer cracks or delamination and excellent in physical stability, thereby achieving a greater durability as compared with the prior-art products.

For achieving the above object, the inventors have analyzed and investigated the film forming process for the inorganic surface protective layer.

As a result, the inventors have discovered that a condition of the surface protective layer initially deposited on the outermost part of the organic photosensitive layer has a significant influence on the physical stability of the surface protective layer subsequently deposited.

At an initial stage of the film formation, the inorganic material forming the surface protective layer is somehow combined with a part of the material of the organic photosensitive layer that is exposed at the outermost part thereof, thereby forming a nucleus for film growth. A film of the inorganic material grows about the resultant nucleus and thus, the surface protective layer is formed. In the surface protective layer thus formed, the nucleus portion functions as a binding point with the organic photosensitive layer, ensuring the good adhesion between these layers.

Therefore, the magnitude of binding strength between the organic photosensitive layer and the inorganic material at individual binding points as well as the per-area number of binding points namely the density of the binding points at an interface between the organic photosensitive layer and the surface protective layer give significant influences on the adhesion of the surface protective layer to the organic photosensitive layer and the physical stability of the surface protective layer.

Specifically, with increase in the binding strength between the organic photosensitive layer and the inorganic material and also in the density of the binding points at the interface between these layers, the surface protective layer is accordingly increased in the adhesion to the organic photosensitive layer, resulting in the greater physical stability.

As mentioned supra, the typical organic photosensitive layer has a structure wherein low molecular weight functional materials including the charge generating material, charge transport material and the like are dispersed in the binder resin forming the layer.

From the standpoint of the findings regarding the binding points, it is thought ideal that the binder resin, forming the layer and accounting for a major part thereof, acts as the nucleus of film growth so as to be combined with the inorganic material forming the surface protective layer.

In the actual process, however, because of the stability and reactivity of the molecules per se or of the reaction site, the formation of the surface protective layer proceeds with some of the low molecular weight materials, that is exposed at the outermost part of the organic photosensitive layer, functioning as the nuclei of film growth, the low-molecular weight materials including the charge generating material, charge transport material and the like which are dispersed in the layer.

Hence, the properties of the low molecular weight materials, which include the reactivity and binding strength with the inorganic material, the degrees of the compatibility and affinity with the binder resin forming the organic photosensitive layer, the dimensions of the materials themselves (including not only the molecular weight but also the molecular or spatial extent), also significantly affect the adhesion to the organic photosensitive layer and the physical stability of the surface protective layer.

That is, as the low molecular-weight materials are increased in the reactivity and binding strength with the inorganic material, the surface protective layer is accordingly improved in the adhesion to the organic photosensitive layer and in the physical stability thereof.

Furthermore, as the low molecular weight materials are increased in the compatibility and affinity with the binder resin forming the organic photosensitive layer as well as in the dimensions thereof, a so-called anchor effect is accordingly increased so that the surface protective layer is also improved in the adhesion to the organic photosensitive layer and the physical stability thereof.

As to the combined form between the low molecular weight materials and the inorganic material, the most preferred is molecular bond in the light of the magnitude of the binding strength. However, if this bond should change the molecular structure to cause the production of an electric charge trap, the photosensitivity of the electrophotosensitive material might be decreased.

Therefore, an important consideration in the use of the low-molecular weight materials influence the need to prevent the reaction from transforming the molecular structure to a state reduced in the electrical properties.

Thus, the inventors have found that a electrophotosensitive material capable of forming preferable images cannot be obtained simply by overlaying on the conventional organic photosensitive layer a surface protective layer containing an inorganic material of a greater hardness.

Only after the fabrication of electrophotosensitive materials satisfying the various conditions described above, the inventors have finally discovered that the inorganic surface protective layer contributes to the improvement of the durability and environmental resistance of the electrophotosensitive material while maintaining the electrical characteristics of the organic photosensitive layer as they are.

Taking these findings into consideration, the inventors have made investigation into various materials for forming the organic photosensitive layer. The invention has been achieved by the inventors' study that a suitable material satisfying these requirements is a compound represented by any one of the following formulas (1) to (4):

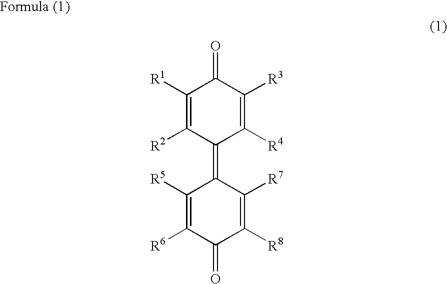

wherein R¹, R², R³, R⁴, R⁵, R⁶, R⁷ and R⁸ are the same or different and each denoting a hydrogen atom, alkyl group, alkoxy group, aryl group, cycloalkyl group or aralkyl group; and out of the groups R¹ to R⁸, two groups bonded to adjacent carbon atoms of the same ring may be linked together to form a condensed ring jointly with the ring;

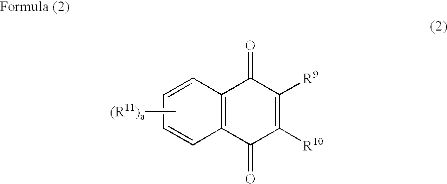

wherein R⁹ and R¹⁰ are the same or different and each denoting a hydrogen atom, alkyl group, alkoxy group, alkylthio group, aryl group, cycloalkyl group, aryloxy group, arylthio group or a group represented by a formula (2a)

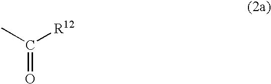

provided that R⁹ and R¹⁰ are not hydrogen atoms at the same time; R⁹ and R¹⁰ may be linked together to form a condensed ring jointly with the ring; R¹¹ denotes a hydrogen atom, halogen atom, alkyl group, alkoxy group, aryl group or aralkyl group; in which formula (2a), R¹² denotes an alkyl group, alkoxy group, aryl group or aryloxy group; and ‘a’ denotes an integer of 0 to 4;

Formula (3)

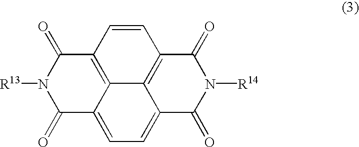

wherein R¹³ and R¹⁴ are the same or different and each denoting a hydrogen atom, alkyl group, alkoxy group, aryl group, cycloalkyl group or aralkyl group; and

Formula (4)

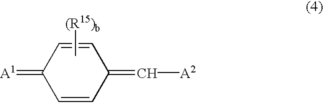

wherein R¹⁵ denotes a hydrogen atom, halogen atom, alkyl group, alkoxy group, aryl group, cycloalkyl group or aralkyl group; ‘b’ denotes an integer of 0 to 4, provided that when ‘b’ is 2 or more, the two groups R¹⁵ bonded to adjacent carbon atoms of the ring may be linked together to form a condensed ring jointly with the ring; A¹ denotes an oxygen atom or a group represented by a formula (4a):

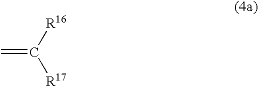

in which R¹⁶ and R¹⁷ are the same or different and each denoting a cyano group or alkoxycarbonyl group; A² denotes a group represented by a formula (4b):

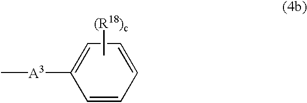

or a formula (4c):

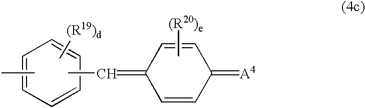

in which formula (4b), A³ denotes a —N═CH— group or —N═N— group; R¹⁸ denotes a hydrogen atom, halogen atom, alkyl group, alkoxy group, aryl group, cycloalkyl group or aralkyl group; and ‘c’ denotes an integer of 0 to 5, provided that when ‘c’ is 2 or more, the groups R¹⁸ may be linked together to form a condensed ring jointly with the ring;

in which formula (4c), R¹⁹ and R²⁰ are the same or different and each denoting a hydrogen atom, halogen atom, alkyl group, alkoxy group, aryl group, cycloalkyl group or aralkyl group; ‘d’ denotes an integer of 0 to 4, provided that when ‘d’ is 2 or more, the groups R¹⁹ may be linked together to form a condensed ring jointly with the ring; ‘e’ denotes an integer of 0 to 5, provided that when ‘e’ is 2 or more, the two groups R²⁰ bonded to adjacent carbon atoms of the ring may be linked together to form a condensed ring jointly with the ring; and A⁴ denotes an oxygen atom or a group represented by a formula (4d):

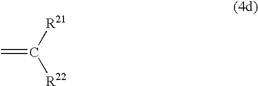

in which R²¹ and R²² are the same or different and each denoting a cyano group or alkoxycarbonyl group.

In short, the electrophotosensitive material of the invention comprises the organic photosensitive layer and the inorganic surface protective layer laid over the conductive substrate in this order, wherein at least an outermost part of the organic photosensitive layer that contacts the surface protective layer contains at least one compound selected from the group consisting of a diphenoquinone derivative of the formula (1), a naphthoquinone derivative of the formula (2), a naphthylene diimide derivative of the formula (3) and a quinone derivative of the formula (4).

The above compounds each having the following features:

a π-electron conjugated system is spread across the molecules thereof,

having the carbonyl group or the A¹=C< group,

has a molecular structure spread in a plane-like fashion as a whole, thus having a great molecular or spatial extent.

In detail,the above compounds each feature a great reactivity with the inorganic material forming the surface protective layer because a π-electron conjugated system is spread across the molecules thereof so that the compounds has a function to attract particularly a metallic element or carbon of the inorganic material at the initial stage of the film forming process.

Additionally, this function increases the ratio of the molecules of these compounds exposed at the outermost part of the organic photosensitive layer that are combined with the inorganic material to form the nuclei of film growth. This results in a higher density of the binding points at the interface between these layers.

Furthermore, the higher the density of the binding points, the greater the film growth rate. Therefore, the time for film forming process may be reduced thereby minimizing damage on the organic photosensitive layer during the deposition of the surface protective layer by the vapor deposition method or the like.

With a π-bond of a double bond in the molecules split off, each of the above compounds is rigidly combined with a metallic element, carbon or the like via molecular bond. Particularly in the π-bond of the carbonyl group in the compounds of the formulas (1) to (3) or of the A¹=C< group (including the carbonyl group) in the compound of the formula (4), there is a great difference of electronegativity between carbon and oxygen or between carbon and the group A¹. This provides a dipolar resonance structure wherein carbon has a positive polarity while oxygen or the group A¹ has a negative polarity. As a result, the compound is increased in reactivity, contributing to a significant increase in the binding strength between the organic photosensitive layer and the inorganic material.

In addition, each of the compounds has a molecular structure spread in a plane-like fashion as a whole, thus having a great molecular or spatial extent. Furthermore, the compounds are all excellent in compatibility and affinity with the binder resin, presenting a good anchor effect on the binder resin.

Therefore, the binding strength between the organic photosensitive layer and the inorganic material is increased.

According to the invention, the physical stability of the inorganic surface protective layer can be improved by increasing the adhesion thereof to the organic photosensitive layer. Thus, the surface protective layer is prevented from suffering the occurrence of cracks and delamination in the actual use environment or during the long-term storage. As a result, the electrophotosensitive material featuring a superior durability to the conventional ones is provided.

Furthermore, the compounds do not produce a deep electric charge trap even when they are changed in the molecular structures thereof due to the molecular bond with a metal or carbon. In addition, the molecular bond occurs only in a limited part of the compound that is exposed at the outermost part of the organic photosensitive layer, so that a major part of the compound in the organic photosensitive layer maintains its initial state as it is. Hence, there is no fear of reducing the photosensitivity of the electrophotosensitive material.

Besides the above merits, all the compounds are excellent in compatibility with the binder resin so that a large amount of each compound may be uniformly dispersed in the binder resin without producing particle aggregation. As a result, the electrophotosensitive material of the invention also features good photosensitivity characteristics.

### DETAILED DESCRIPTION OF THE INVENTION

The invention will be described as below.

In an electrophotosensitive material according to the invention, at least an outermost part of an organic photosensitive layer that is in contact with a surface protective layer contains any one of the above compounds represented by the formulas (1) to (4).

Examples of the alkyl group in the above formulas include alkyl groups having 1 to 12 carbon atoms, such as methyl, ethyl, n-propyl (n-Pr), isopropyl (i-Pr), n-butyl (n-Bu), isobutyl (i-Bu), sec-butyl (s-Bu), tert-butyl (t-Bu), pentyl (n-amyl), isopentyl (isoamyl), sec-amyl, tert-amyl, neopentyl, hexyl, heptyl, octyl, nonyl, decyl, undecyl, dodecyl and the like.

Examples of the alkoxy group include alkoxy groups having 1 to 12 carbon atoms, such as methoxy, ethoxy, n-propoxy, isopropoxy, n-butoxy, isobutoxy, sec-butoxy, tert-butoxy, pentyloxy, isopentyloxy, neopentyloxy, hexyloxy, heptyloxy, octyloxy, nonyloxy, decyloxy, undecyloxy, dodecyloxy and the like.

Examples of the aryl group include groups derived from aromatic compounds such as benzene, toluene, xylene, biphenyl, o-terphenyl, m-terphenyl, p-terphenyl, naphthalene, anthracene, phenanthrene, pyrene, indene, azulene, heptalene, biphenylene, fluorene and the like.

Examples of the aralkyl group include aralkyl groups having 4 to 10 carbon atoms in an aryl potion thereof, such as benzyl, benzhydryl, triphenylmethyl, phenethyl, thenyl, furfuryl and the like.

Examples of the alkylthio group include those represented by —S—R^{a} wherein R^{a} denotes the above alkyl group having 1 to 12 carbon atoms.

Examples of the aryloxy group include those represented by —O-Φ¹ wherein Φ¹ denotes the aforesaid aryl group.

Examples of the arylthio group include those represented by —S-Φ² wherein Φ² denotes the aforesaid aryl group.

Examples of the alkoxycarbonyl group include those represented by —COOR^{b} wherein R^{b} denotes the above alkyl group having 1 to 12 carbon atoms.

Examples of the cycloalkyl group include cycloalkyl groups having 5 to 12 carbon atoms, such as cyclopentyl, cyclohexyl, 1-cyclohexenyl, cycloheptyl, cyclooctyl, cyclononyl, cyclodecyl, cycloundecyl, cyclododecyl and the like.

Examples of the heterocyclic group include such as thienyl, furyl, pyrrolyl, pyrrolidinyl, oxazoly, isoxazolyl, thiazolyl, isothiazolyl, imidazolyl, 2H-imidazolyl, piperidyl, piperidino, 3-morpholinyl, morpholino and the like. In addition, it may be a heterocyclic group condensed with an aromatic ring.

These groups may contain a substituent which is exemplified by the above groups and halogen atoms. Other usable substituents include, for example, hydroxyalkyl groups; alkoxyalkyl groups; monoalkyl aminoalkyl groups; dialkyl aminoalkyl groups; halogen-substituted alkyl groups; alkoxycarbonylalkyl groups; carboxyalkyl groups; alkanoyloxyalkyl groups; aminoalkyl groups; amino group; hydroxy group; optionally esterified carboxyl groups; cyano group, nitro group and the like. The substituents are not particularly limited in the position and the number. Diphenoquinone Derivative Among the above compounds, an example of a preferred diphenoquinone derivative of the formula (1) includes at least one selected from the group consisting of a diphenoquinone compound represented by a formula (1-1):

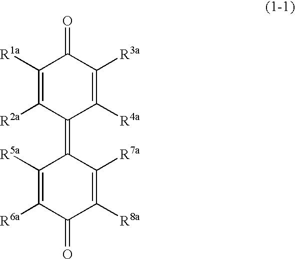

wherein R^{1a}, R^{2a}, R^{3a}, R^{4a}, R^{5a}, R^{6a}, R^{7a} and R^{8a} are the same or different and each denoting a hydrogen atom, alkyl group, alkoxy group, aryl group, cycloalkyl group or aralkyl group; and

a dinaphthoquinone compound represented by a formula (1-2):

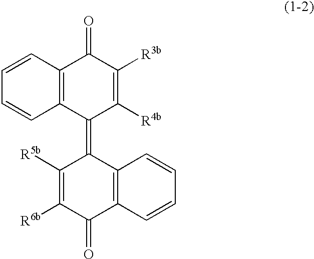

wherein R^{3b}, R^{4b}, R^{5b} and R^{6b} are the same or different and each denoting a hydrogen atom, alkyl group, alkoxy group, aryl group, cycloalkyl group or aralkyl group.

Specific examples of the diphenoquinone compound of the formula (1-1) include compounds represented by formulas (1-1-1) to (1-1-32).

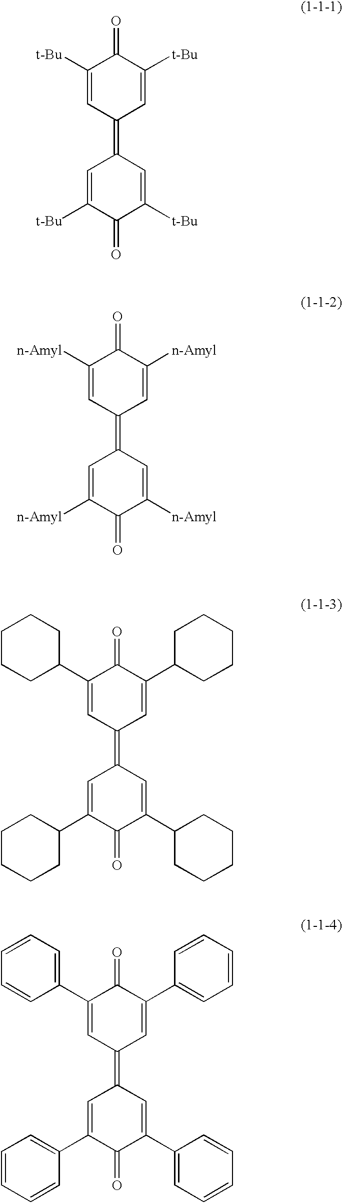

Specific examples of the dinaphthoquinone compound of the formula (1-2) include compounds represented by formulas (1-2-1) to (1-2-11).

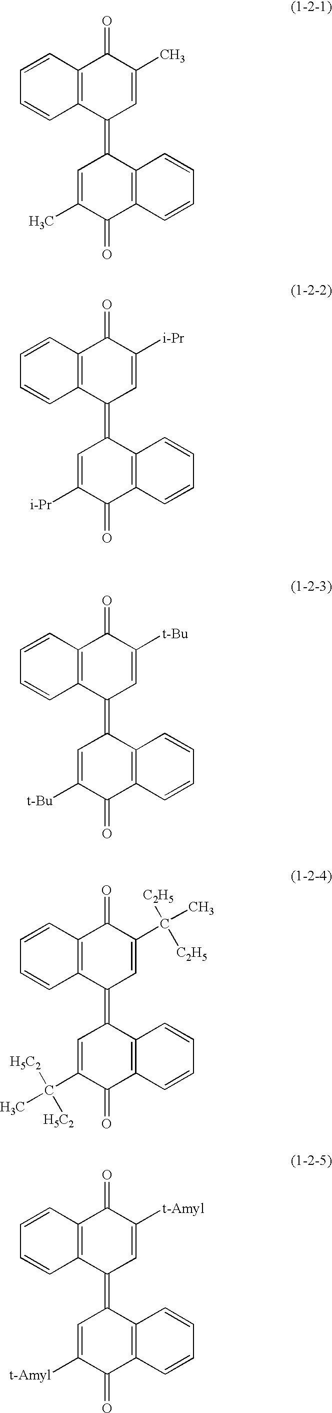

Naphthoquinone Derivative

An example of a preferred naphthoquinone derivative of the formula (2) includes at least one selected from the group consisting of a naphthoquinone compound represented by a formula (2-1):

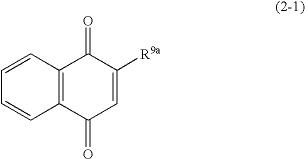

wherein R^{9a} denotes an alkyl group, cycloalkyl group or aryl group;

a naphthoquinone compound represented by a formula (2-2):

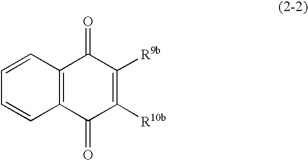

wherein R^{9b} and R^{10b} are the same or different and each denoting an alkoxy group, alkylthio group, aryloxy group or arylthio group;

a naphthoquinone compound represented by a formula (2-3):

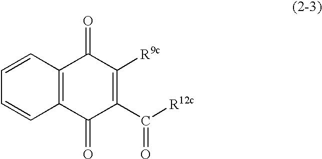

wherein R^{9c} denotes an alkyl group or aryl group; and R^{12c} denotes an alkyl group, alkoxy group, aryl group or aryloxy group;

a diindenopyrazine compound represented by a formula (2-4):

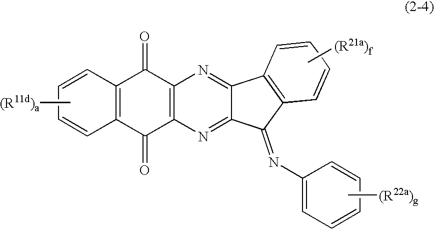

wherein R^{11d}, R^{21a} and R^{22a} are the same or different and each denoting a hydrogen atom, halogen atom, alkyl group, alkoxy group, aryl group or aralkyl group; ‘a’ and ‘f’ are the same or different and each denoting an integer of 0 to 4; and ‘g’ denotes an integer of 0 to 5; a diindenopyrazine compound represented by a formula (2-5):

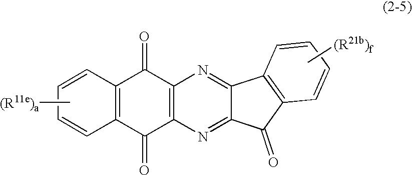

wherein R^{11e} and R^{21b} are the same or different and each denoting a hydrogen atom, halogen atom, alkyl group, alkoxy group, aryl group or aralkyl group; and ‘a’ and ‘f’ are the same or different and each denoting an integer of 0 to 4; and

a dioxotetracenedione compound represented by a formula (2-6):

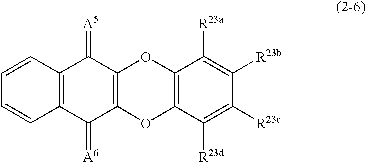

wherein A⁵ and A⁶ are the same or different and each denoting an oxygen atom or =N-CN group; and R^{23a}, R^{23b}, R^{23c} and R^{23d} are the same or different and each denoting a hydrogen atom, alkyl group, alkoxycarbonyl group, cycloalkyl group or group represented by a formula (2-6a):

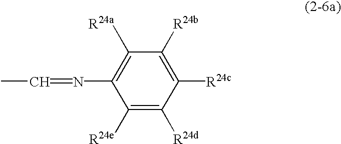

in which R^{24a}, R^{24b}, R^{24c}, R^{24d} and R^{24e} are the same or different and each denoting a hydrogen atom or alkyl group.

Specific examples of the naphthoquinone compound of the formula (2-1) include compounds represented by formulas (2-1-1) to (2-1-1-6).

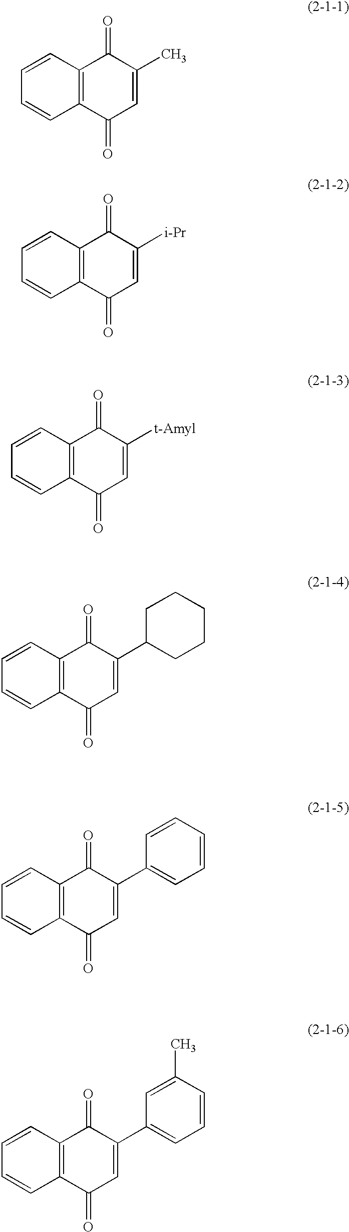

Specific examples of the naphthoquinone compound of the formula (2-2) include compounds represented by formulas (2-2-1) to (2-2-23).

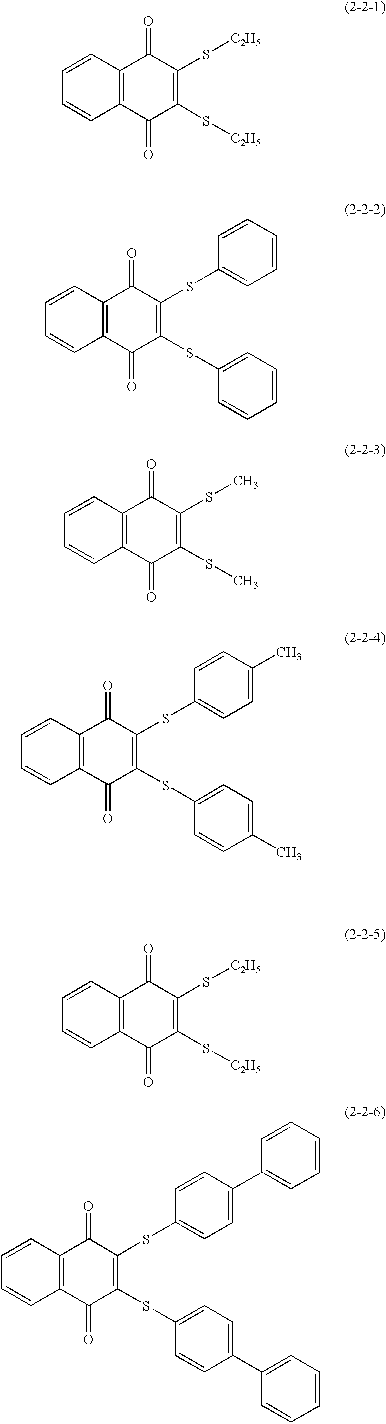

Specific examples of the naphthoquinone compound of the formula (2-3) include compounds represented by formulas (2-3-1) to (2-3-11).

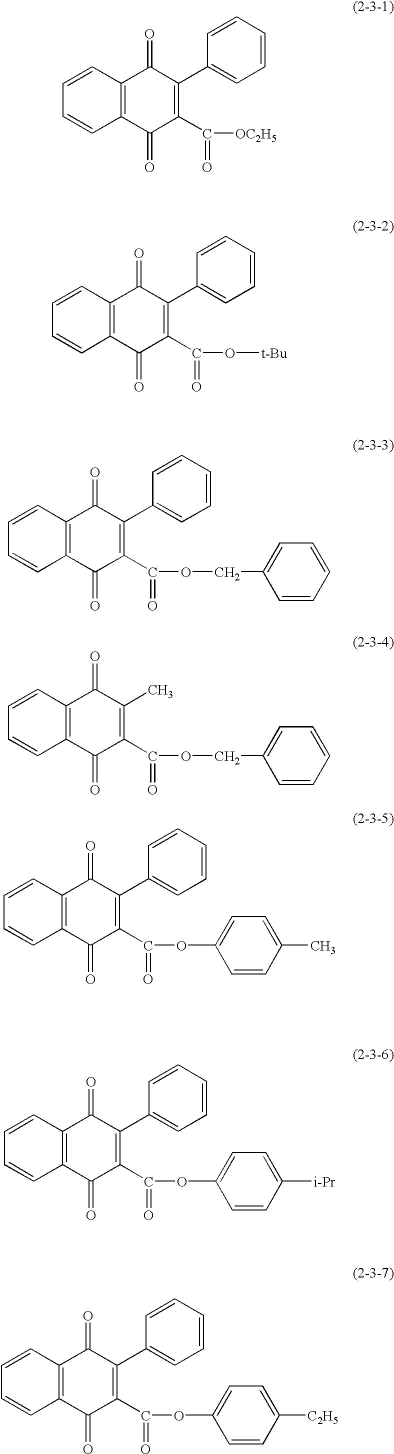

Specific examples of the diindenopyrazine compound of the formula (2-4) include compounds represented by formulas (2-4-1) to (2-4-4).

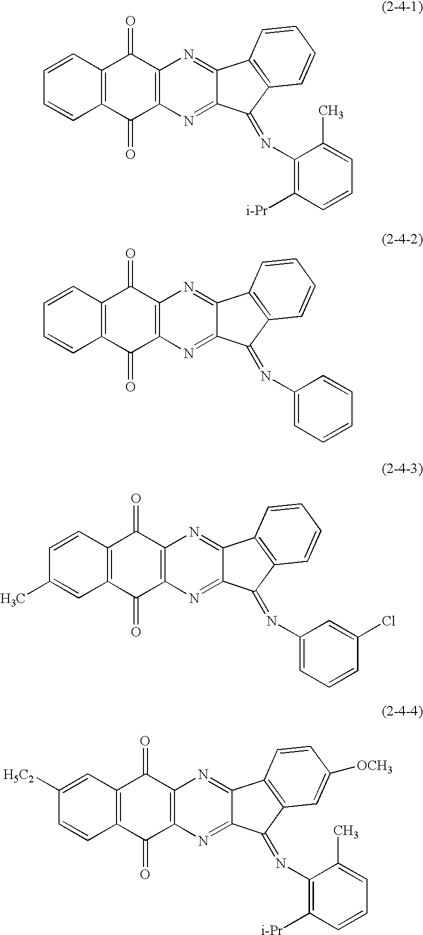

Specific examples of the diindenopyrazine compound of the formula (2-5) include compounds represented by formulas (2-5-1) to (2-5-4).

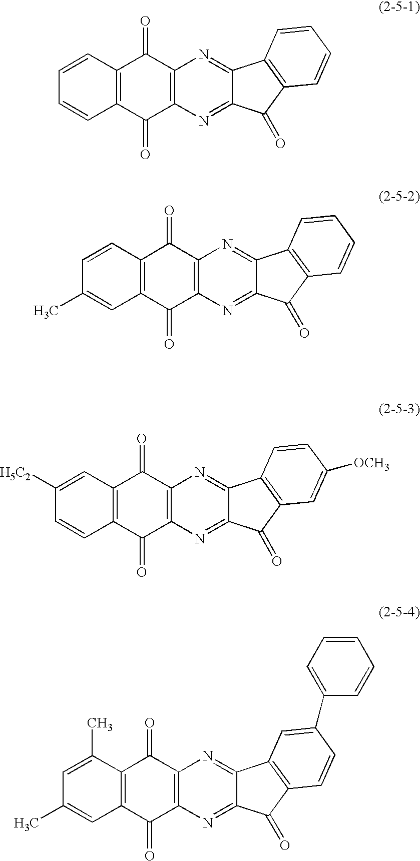

Specific examples of the dioxotetracenedione compound of the formula (2-6) include compounds represented by formulas (2-6-1) to (2-6-11).

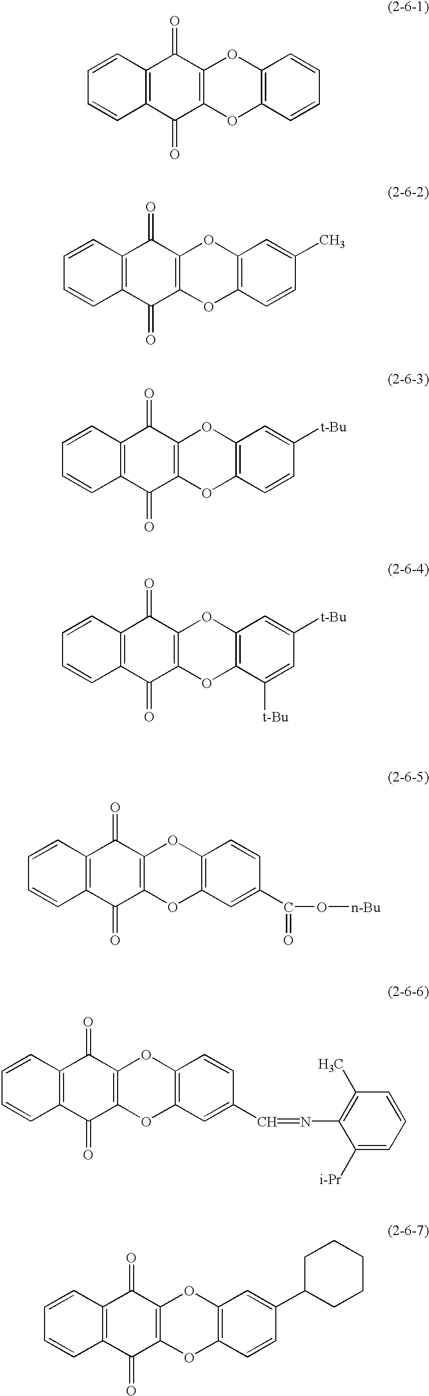

Naphthylene Diimide Derivative

Specific examples of the naphthylene diimide derivative of the formula (3) include compounds represented by formulas (3-1-1) to (3-1-13).

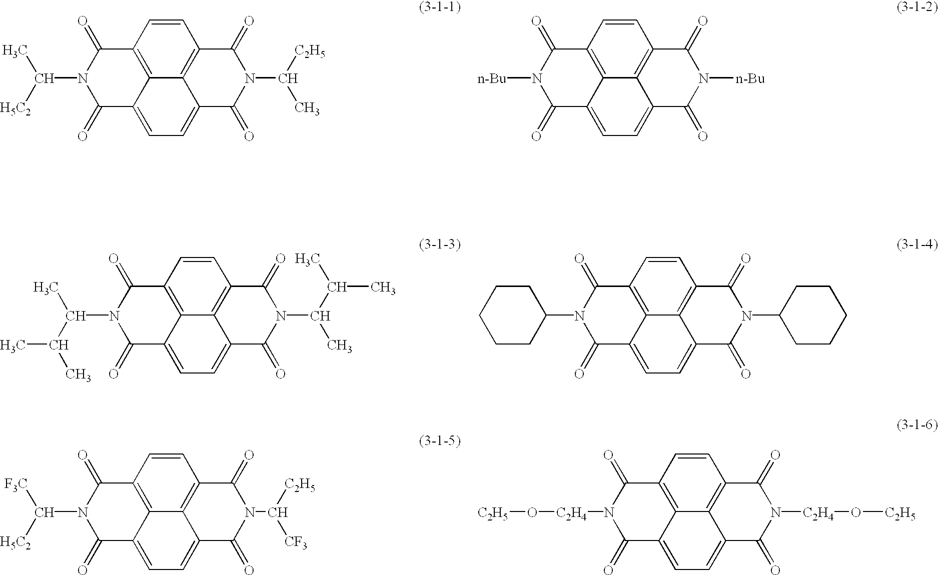

Quinone Derivative

An example of a preferred quinone derivative of the formula (4) includes at least one selected from the group consisting of a compound represented by a formula (4-1)

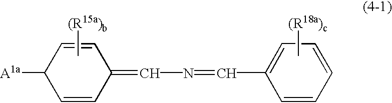

wherein R^{15a} and R^{18a} are the same or different and each denoting a hydrogen atom, halogen atom, alkyl group, alkoxy group, aryl group or aralkyl group; ‘b’ denotes an integer of 0 to 4, provided that when ‘b’ is 2 or more, the two groups R^{15a} bonded to adjacent carbon atoms of the ring may be linked together to form a condensed ring jointly with the ring; ‘c’ denotes an integer of 0 to 5, provided that when ‘c’ is 2 or more, the groups R^{18a} may be linked together to form a condensed ring jointly with the ring; and Ala denotes an oxygen atom or the group represented by the formula (4a);

a compound represented by a formula (4-2):

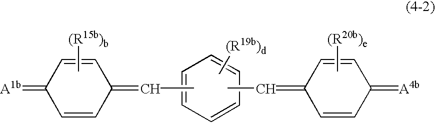

wherein R^{15b}, R^{19b} and R^{20b} are the same or different and each denoting a hydrogen atom, halogen atom, alkyl group, alkoxy group, aryl group, cycloalkyl group, hetero cyclic group or aralkyl group; ‘b’, ‘d’ and ‘e’ are the same or different and each denoting an integer of 0 to 4, provided that when ‘d’ is 2 or more, the groups may be linked together to form a condensed ring jointly with the ring; when ‘b’ or ‘e’ is 2 or more, the corresponding two groups bonded to adjacent carbon atoms of each ring may be linked together to form a condensed ring jointly with the ring; A^{1b} denotes an oxygen atom or the group represented by the formula (4a); and A^{4b} denotes an oxygen atom or the group represented by the formula (4d); and a compound represented by a formula (4-3):

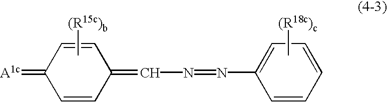

wherein R^{15c} and R^{18c} are the same or different and each denoting a hydrogen atom, halogen atom, alkyl group, alkoxy group, aryl group or aralkyl group; ‘b’ denotes an integer of 0 to 4, provided that when ‘b’ is 2 or more, the two groups R^{15c} bonded to adjacent carbon atoms of the ring may be linked together to form a condensed ring jointly with the ring; ‘c’ denotes an integer of 0 to 5, provided that when ‘c’ is 2 or more, the groups R^{18c} may be linked together to form a condensed ring jointly with the ring; and A^{1c} denotes an oxygen atom or the group represented by the formula (4a).

Specific examples of the compound of the formula (4-1) include compounds represented by formulas (4-1-1) to (4-1-16).

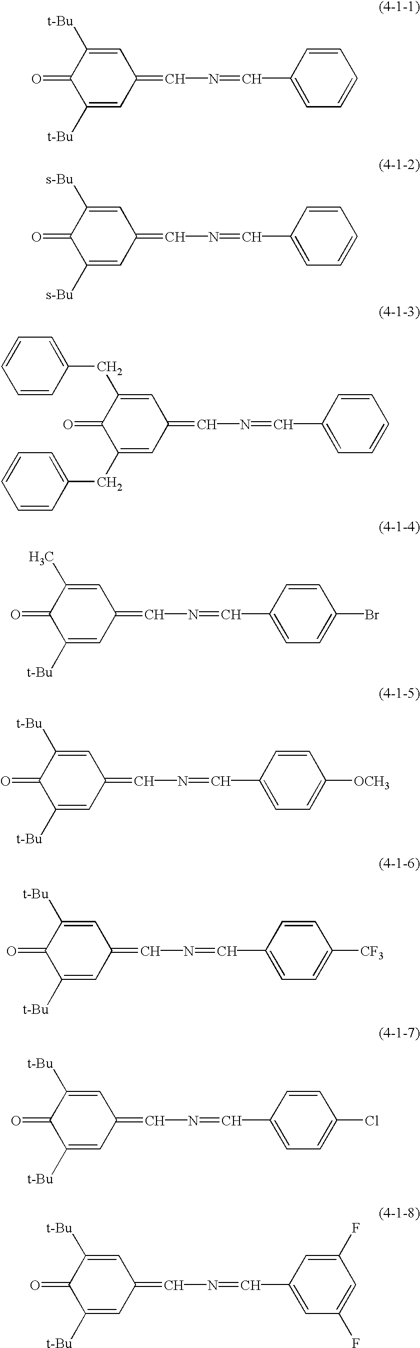

Specific examples of the compound of the formula (4-2) include compounds represented by formulas (4-2-1) to (4-2-20).

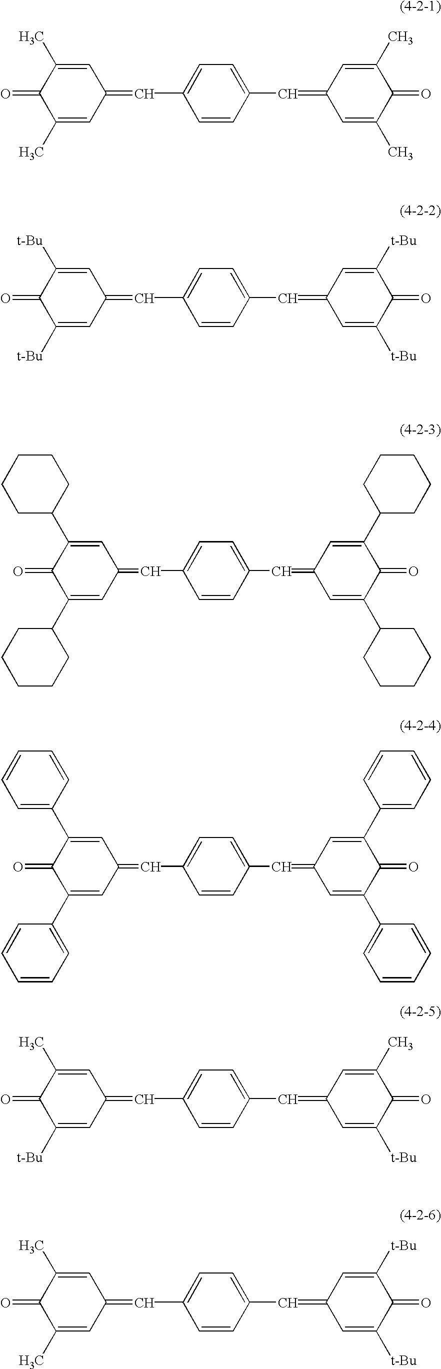

Specific examples of the compound of the formula (4-3) include compounds represented by formulas (4-3-1) to (4-3-15).

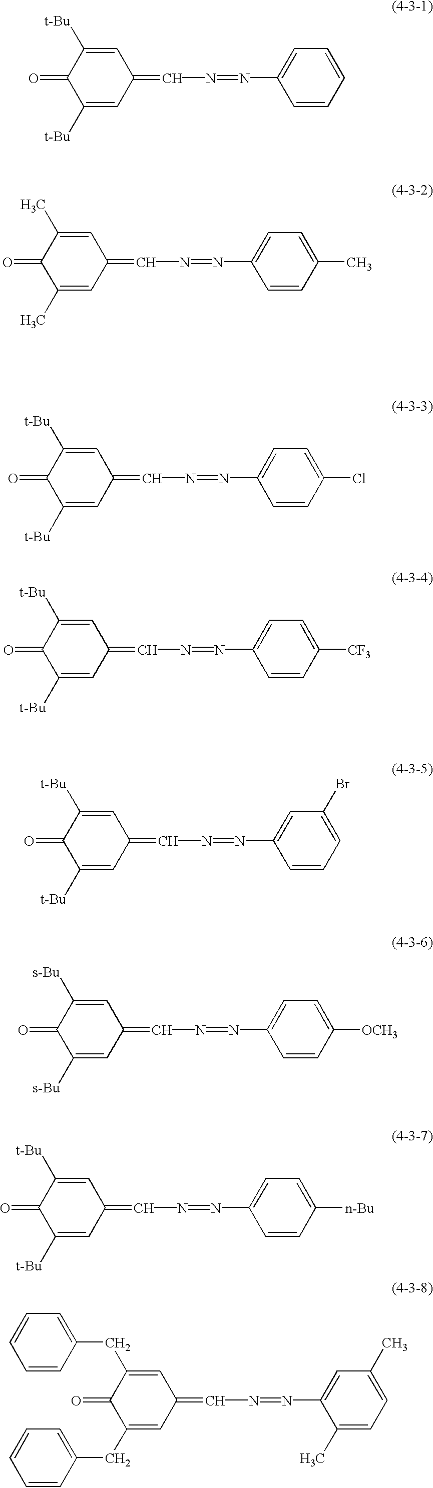

The above compounds of the formulas (1) to (4) may be used alone or in combination of two or more types. organic electrophotosensitive Layer The organic photosensitive layer includes a single layer type and a multi-layer type, and the invention may be applicable to both of the types.

The single-layer photosensitive layer is formed by the steps of applying a coating solution to a conductive substrate and drying the solution, the coating solution prepared by dissolving or dispersing in a suitable organic solvent, at least one of the compounds of the formulas (1) to (4), the charge generating material, the charge transport material and the binder resin.

The single-layer photosensitive layer features a simple layer construction and good productivity.

Since all the compounds of the formulas (1) to (4) have a function as the electron transport material, the charge transport material may be dispensed with. However, it is preferred to admix the charge transport material in order to attain preferable sensitivity characteristics.

As to the charge transport material, either of the positive-hole transport material and the electron-transport material may be used according to a charge polarity of the photosensitive layer.

Furthermore, both polarities charge transport materials may be used in combination with the above charge transport material. A photosensitive layer including such charge transport materials of opposite polarities is advantageous in that a single layer construction is positively and negatively chargeable.

The multi-layer photosensitive layer is formed by the steps of overlaying on the conductive substrate the charge generating layer containing the charge generating material, applying a coating solution containing the charge transport material and the binder resin onto the resultant charge generating layer, and drying the solution thereby forming the charge transport layer. Otherwise, the multi-layer photosensitive layer may also be obtained by forming the charge transport layer over the conductive substrate, followed by forming thereover the charge generating layer.

The charge generating layer may further contain a charge transport material of the opposite polarity to that of the charge transport layer.

There are a great variety of multi-layer photosensitive layers in correspondence to combinations of the orders of the formation of the charge generating layer and charge transport layer and the polarities of the charge transport materials contained in these layers.

Specific examples of the multi-layer photosensitive layer include the following four types:

(a) a negative-charge multi-layer photosensitive layer wherein the charge generating layer containing the charge generating material and, as required, the electron transport material is formed over the conductive substrate and then the charge transport layer containing the positive-hole transport material is laid over the charge generating layer;

(b) a negative-charge multi-layer photosensitive layer wherein the charge transport layer containing the electron transport material is formed over the conductive substrate, and then the charge generating layer containing the charge generating material and, as required, the positive-hole transport material is laid over the charge transport layer;

(c) a positive-charge multi-layer photosensitive layer wherein the charge generating layer containing the charge generating material and, as required, the positive-hole transport material is formed over the conductive substrate and then, the charge transport layer containing the electron transport material is laid over the charge generating layer; and

(d) a positive-charge multi-layer photosensitive layer wherein the charge transport layer containing the positive-hole transport material is formed over the conductive substrate and then, the charge generating layer containing the charge generating material and, as required, the electron transport material is laid over the charge transport layer.

As compared with the positive-charge photosensitive layers (c) and (d), the negative-charge photosensitive layers (a) and (b) are generally more preferred because of more excellent electrical characteristics thereof such as photosensitivity and residual potential.

In addition, the charge generating layer has quite a small thickness as compared with the charge transport layer and hence, the construction (a) with the charge transport layer laid on the upper side is more preferred.

According to the invention, the upper layer located at the outermost part of the above multi-layer photosensitive layer and contacting the surface protective layer is required to contain at least one of the compounds of the formulas (1) to (4).

Examples of a usable charge generating material include powders of inorganic photoconductive materials such as selenium, selenium-tellurium, selenium-arsenic, cadmium sulfide, α-silicon and the like; and a variety of known pigments including phthalocyanine pigments comprising crystalline phthalocyanine compounds of various crystalline forms such as metal-free phthalocyanine represented by a formula (CG-1):

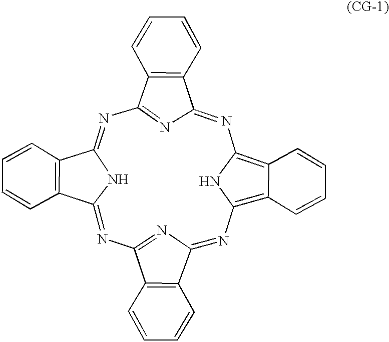

titanyl phthalocyanine represented by a formula (CG-2):

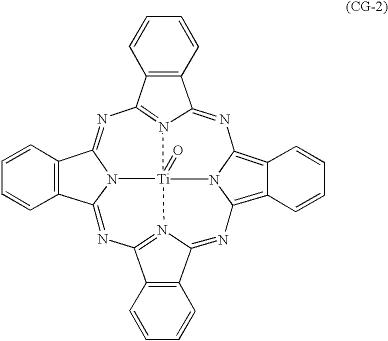

azo pigments, bisazo pigments, perylene pigments, anthanthrone pigments, indigo pigments, triphenylmethane pigments, threne pigments, toluidine pigments, pyrazoline pigments, quinacridone pigments, dithioketopyrolopyrrole pigments and the like.

The charge generating materials may be used alone or in combination of two or more types such that the photosensitive layer may have sensitivity at a desired wavelength range.

Particularly, a electrophotosensitive material having photosensitivity in the wavelength range of 700 nm or more is required by digital-optical image forming apparatuses such as laser beam printers, plain paper facsimiles and the like which utilize infrared light such as semiconductor laser beam. Accordingly, phthalocyanine pigments among the above exemplary compounds are preferably employed as the charge generating material.

Any of the various known electron-transporting compounds may be used as the electron transport material.

A preferred electron transport material include electron-attracting compounds which include, for example, benzoquinone compounds, diphenoquinone compounds, isatin compounds such as a compound represented by a formula (ET-1):

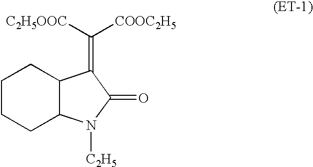

naphthoquinone compounds, malononitrile, thiopyran compounds, tetracyanoethylene, 2,4,8-trinitrilothioxanthone, fluorenone compounds such as 2,4,7-trinitrilo-9-fluorenone, dinitrobenzene, dinitroanthracene, dinitroacridine, nitroanthraquinone, succinic anhydride, maleic anhydride, dibromomaleic anhydride, 2,4,7-trinitrofluorenoneimine compounds, ethylated nitrofluorenoneimine compounds, tryptantrin compounds, tryptantrinimine compounds, azafluorenone compounds, dinitropyridoquinazoline compounds, thioxanthene compounds, 2-phenyl-1,4-benzoquinone compounds, 2-phenyl-1,4-naphthoquinone compounds, 5,12-naphthacenequinone compounds, α-cyanostilbene compounds, 4′-nitrostilbene compounds, salts formed by reaction between anionic radicals of benzoquinone compounds and cations.

These materials may be used alone or in combination of two or more types.

Any of the various known positive-hole transporting compounds may be used as the positive-hole transport material.

Examples of a particularly preferred positive-hole transport material include benzidine compounds, phenylenediamine compounds, naphthylenediamine compounds, phenantolylenediamine compounds, oxadiazole compounds such as 2,5-di(4-methylaminophenyl)-1,3,4-oxadiazole, styryl compounds such as 9-(4-diethylaminostyryl)anthracene, carbazole compounds such as poly-N-vinylcarbazole having a repeated unit represented by a formula (HT-1):

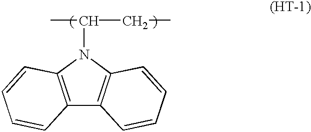

organic polysilane compounds having a repeated unit represented by a formula (HT-2):

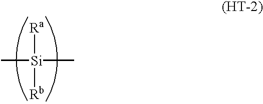

[wherein R^{a} and R^{b} are the same or different each denoting an alkyl group, alkoxy group, aryl group or aralkyl group], pyrazoline compounds such as 1-phenyl-3-(p-dimethylaminophenyl)pyrazoline, hydrazone compounds such as diethylaminobenzaldehyde diphenylhydrazone represented by a formula (HT-3):

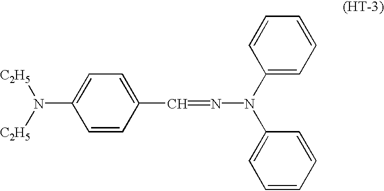

triphenylamine compounds such as tris(3-methylphenyl)amine, indole compounds, oxazole compounds, isooxazole compounds, thiazole compounds, thiadiazole compounds, imidazole compounds, pyrazole compounds, triazole compounds, butadiene compounds, pyrene-hydrazone compounds, acrolein compounds, carbazole-hydrazone compounds, quinoline-hydrazone compounds, stilbene-hydrazone compounds, diphenylenediamine compounds and the like.

These compounds may be used alone or in combination of two or more types.

Examples of a usable binder resin include thermoplastic resins such as styrene polymers, styrene-butadiene copolymers, styrene-acrylonitrile copolymers, styrene-maleic acid copolymers, acrylic polymers, styrene-acryl copolymers, polyethylene, ethylene-vinyl acetate copolymers, chlorinated polyethylene, polyvinyl chloride, polypropylene, copolymers of vinyl chloride and vinyl acetate, polyester, alkyd resins, polyamide, polyurethane, polycarbonate, polyarylate, polysulfone, diarylphthalate resins, ketone resins, polyvinylbutyral resins, polyether resins and the like;

crosslinking thermosetting resins such as silicone resins, epoxy resins, phenol resins, urea resins, melamine resins and the like; and

photosetting resins such as epoxy-acrylate, urethane-acrylate and the like.

These resins may be used alone or in combination of two or more types.

Where the aforesaid high-molecular positive-hole transport material such as poly-N-vinylcarbazole or organic polysilane compound is used, such a compound also serves as the binder resin and hence, the aforesaid binder resin may be dispensed with.

Additionally to the above components, the photosensitive layer may further contain any of the various additives such as fluorene compound, ultraviolet absorber, plasticizer, surfactant, leveling agent and the like. For an increased photosensitivity of the electrophotosensitive material, there may be further added a sensitizer such as terphenyl, halonaphthoquinone, acenaphthylene or the like.

The single-layer photosensitive layer may preferably contain 0.1 to 50 parts by weight or particularly 0.5 to 30 parts by weight of charge generating material, and 5 to 100 parts by weight or particularly 10 to 80 parts by weight of at least one of the compounds of the formulas (1) to (4), based on 100 parts by weight of binder resin.

The mixing ratio of the charge transport material may be suitably defined based on the charge polarity or construction of the photosensitive layer.

Where the positive-hole transport material is used alone as the charge transport material, for instance, the mixing ratio of the positive-hole transport material is preferably in the range of 5 to 500 parts by weight or particularly of 25 to 200 parts by weight based on 100 parts by weight of binder resin. It is also possible to employ the aforesaid positive-hole transport material also serving as the binder resin so as to dispense with the binder resin.

Where the electron transport material is used alone as the charge transport material, for instance, the mixing ratio of the electron transport material is preferably in the range of 5 to 100 parts by weight or particularly of 10 to 80 parts by weight based on 100 parts by weight of binder resin.

Where the positive-hole transport material and the electron transport material are used in combination as the charge transport material, for instance, these materials may preferably be present in total amount of 20 to 500 parts by weight or particularly of 30 to 200 parts by weight based on 100 parts by weight of binder resin.

The single-layer photosensitive layer may preferably have a thickness of 5 to 100 μm or particularly of 10 to 50 μm.

In the multi-layer photosensitive layer of the construction (a), the charge generating layer disposed on the lower side thereof may be formed from the charge generating material alone or from the binder resin in which the charge generating material and, as required, the electron transport material are dispersed. In the latter case, it is preferred that the charge generating material is present in the range of 5 to 1000 parts by weight or particularly of 30 to 500 parts by weight based on 100 parts by weight of binder resin while the electron transport material is present in the range of 1 to 200 parts by weight or particularly of 5 to 100 parts by weight based on 100 parts by weight of binder resin.

In the construction (a), the charge transport layer disposed on the upper side may preferably contain the positive-hole transport material in the range of 10 to 500 parts by weight or particularly of 25 to 200 parts by weight based on 100 parts by weight of binder resin, and at least one of the compounds of the formulas (1) to (4) in the range of 0.1 to 250 parts by weight or particularly of 0.5 to 150 parts by weight based on 100 parts by weight of binder resin. In this case, as well, the aforesaid positive-hole transport material also serving as the binder resin may be used so as to dispense with the binder resin.

As to the thickness of the multi-layer photosensitive layer, the charge generating layer may preferably have a thickness of about 0.01 to 5 μm or particularly of about 0.1 to 3 μm, whereas the charge transport layer may preferably have a thickness of about 2 to 100 μm or particularly of about 5 to 50 μm.

An intermediate layer or barrier layer may be formed between the single-layer or the multi-layer organic photosensitive layer and the conductive substrate or between the charge generating layer and the charge transport layer of the multi-layer photosensitive layer, so long as such a layer does not decrease the characteristics of the electrophotosensitive material.

Where each layer forming the electrophotosensitive material is formed by the coating method, the charge generating material, charge transport material, binder resin and the like may be dispersed, by mixing, into an organic solvent using a roll mill, ball mill, attritor, paint shaker, ultrasonic disperser or the like, thereby to prepare a coating solution, which may be applied and dried by the known means.

Examples of a usable organic solvent include alcohols such as methanol, ethanol, isopropanol, butanol and the like;

aliphatic hydrocarbons such as n-hexane, octane, cyclohexane and the like;

aromatic hydrocarbons such as benzene, toluene, xylene and the like;

halogenated hydrocarbons such as dichloromethane, dichloroethane, carbon tetrachloride, chlorobenzene and the like;

ethers such as dimethyl ether, diethyl ether, tetrahydrofuran, 1,4-dioxane, ethyleneglycol dimethyl ether, diethyleneglycol dimethyl ether and the like;

ketones such as acetone, methyl ethyl ketone, cyclohexanone and the like;

esters such as ethyl acetate, methyl acetate and the like; and

dimethylformaldehyde, dimethylformamide, dimethyl sulfoxide and the like. These solvents may be used alone or in combination of two or more types.

The coating solution may further contain a surfactant, leveling agent or the like for increasing the dispersibility of the charge generating material and charge transport material, and the surface smoothness of the photosensitive layer.

Surface Protective Layer

The inorganic surface protective layer is exemplified by a variety of surface protective layers comprising at least one element selected from the group consisting of metallic elements (the elements on the left side of a line interconnecting boron (B) and astatine (At) in the long-form periodic table) and carbon, or an inorganic compound containing any of these elements.

The surface protective layer may be formed by any of the various known vapor deposition methods including the chemical vapor deposition methods such as plasma CVD, photo CVD and the like, and the physical vapor deposition methods such as sputtering, vacuum deposition, ion plating and the like.

In the chemical vapor deposition method such as plasma CVD, there are formed:

1. a film comprising carbon (C) and/or silicon (Si) of the 14-group elements, that is, carbon (C) film, silicon (Si) film or silicon-carbon (Si—C) composite film;

2. a film comprising a compound containing the aforesaid carbon (C) and/or silicon (Si), and at least one element selected from the group consisting of boron (B) and aluminum (Al) of the 13-group elements; nitrogen (Ni) and phosphorus (P) of the 15-group elements; oxygen (0) and sulfur (S) of the 16-group elements; and fluorine (F), chlorine (Cl) and bromine (Br) of the 17-group elements; the film including, for example, silicon-nitrogen (SiN) composite film, silicon-oxygen (SiO) composite film, carbon-fluorine (CF) composite film, carbon-nitrogen (CN) composite film, carbon-boron (CB) composite film, carbon-oxygen (CO) composite film and the like; and

3. a film comprising a compound containing boron (B) and/or aluminum (Al) of the 13-group elements, and at least one element selected from the group consisting of the aforesaid elements including nitrogen (N), phosphorus (P), oxygen (O), sulfur (S), fluorine (F), chlorine (Cl) and bromine (Br), the film including, for example, boron-nitrogen (BN) composite film, aluminum-nitrogen (AlN) composite film and the like.

These films may contain a fractional amount of hydrogen (H) for improved electrical characteristics of the surface protective layer.

In the chemical vapor deposition method, a usable raw material gas for introduction of a constituent element of the surface protective layer include the molecules of the constituent elements, and compounds thereof such as oxides, hydrides, nitrides and halides thereof, the compounds capable of presenting a gaseous state under normal temperature and pressure conditions or of being readily gassified under film forming conditions. As required, these compounds may be diluted with a gas such as hydrogen gas (H₂), helium gas, argon gas, neon gas or the like.

Specific examples of the raw material gas include:

silane gas (SiH₄) and disilane gas (Si₂H₆) for silicon introduction;

methane gas (CH₄), ethane gas (C₂H₆), propane gas (C₃H₈) and ethylene gas (C₂H₄) for carbon introduction;

fluorine gas (F₂), bromine monofluoride gas (BrF), chlorine difluoride gas (ClF₂), carbon tetrafluoride gas (CF₄) and silicon tetrafluoride gas (SiF₄) for fluorine introduction;

nitrogen gas (N₂), ammonia gas (NH₃), nitrogen oxide gas (NOₓ) for nitrogen introduction; and

boron hydride gas such as diborane gas (B₂H₆), and tetraborane gas (B₄H₁₀) for boron introduction; and the like.

Similarly, the introduction of the other constituent elements may employ compounds capable of presenting a gaseous state under normal temperature and pressure conditions or of being readily gassified under film forming conditions.

In the physical vapor deposition method, or particularly in the sputtering or ion plating method, there may be formed films, besides the aforesaid films, which each comprise one or more than one metallic elements selected from the group consisting of, for example, gallium (Ga), indium (In) and the like of the 13-group elements; germanium (Ge), tin (Sn), lead (Pb) and the like of the 14-group elements; arsenic (As), antimony (Sb) and the like of the 15-group elements; and selenium (Se) and the like of the 16-group elements, or which each comprise an inorganic compound comprising any of the above metallic elements.

Preferred as the inorganic surface protective layer are, for example, the carbon (C) film, silicon-carbon (SiC) composite film and the like.

The thickness of the inorganic surface protective layer may preferably be in the range of 0.01 to 30 μm or particularly of 0.1 to 10 μm.

The inorganic film defining the surface protective layer may be in any of the amorphous form, microcrystalline form, and crystalline form. Further, the film may comprise a mixture of amorphous and crystalline particles.

Conductive Substrate

The conductive substrate may employ substrates formed from various materials having conductivity. Examples of a usable conductive substrate include those formed from metals such as iron, aluminum, copper, tin, platinum, silver, vanadium, molybdenum, chromium, cadmium, titanium, nickel, palladium, indium, stainless steel, brass and the like; those formed from a plastic material on which any of the above metals is deposited or laminated; and glass substrate coated with aluminum iodide, tin oxide, indium oxide or the like.

In short, the substrate itself may have the conductivity or the surface thereof may have the conductivity. It is preferred that the conductive substrate has a sufficient mechanical strength in use.

The conductive substrate may have any form, such as sheet, drum and the like, according to the construction of the image forming apparatus to which the conductive substrate is applied.

### EXAMPLES

The invention will hereinbelow be described by way of reference to examples and comparative examples thereof.

Single-layer Electrophotosensitive Material

### Example 1-1

Forming Single-layer Photosensitive Layer

A ball mill was operated for 50 hours for dispersing by mixing 5 parts by weight of crystalline X-type metal-free phthalocyanine as the charge generating material represented by the formula (CG-1); 100 parts by weight of poly-N-vinylcarbazole (number-average molecular weight Mn=9500) serving as the positive-hole transport material and the binder resin and having the repeated unit represented by the formula (HT-1); and 40 parts by weight of diphenoquinone compound represented by the formula (1-1-1) in 800 parts by weight of tetrahydrofuran, thereby to prepare a coating solution for single-layer photosensitive layer.

Subsequently, the resultant coating solution was dip coated on an aluminum tube as the conductive substrate and then was air dried at 100° C. for 30 minutes. Thus was obtained a single-layer photosensitive layer having a thickness of 25 μm.

Forming Surface Protective Layer

The aluminum tube formed with the single-layer photosensitive layer was placed in a chamber of a plasma CVD system. The air within the chamber was evacuated to reach a degree of vacuum of 0.67 Pa while a heater of the system was operated to adjust the temperature of the tube to 50° C.

Subsequently, methane gas (CH₄), silane gas (SiH₄) and hydrogen gas (H₂) were fed into the chamber at respective flow rates listed below, thereby to adjust the degree of vacuum to 0.47 hPa.

Methane gas: 208 SCCM

Silane gas: 2.5 SCCM

Hydrogen gas: 300 SCCM

In this state, a high-frequency electric field having a frequency of 13.56 MHz and an output of 133 W was applied for causing glow discharge in the chamber. The plasma CVD process was performed for depositing an amorphous silicon-carbon (Sic) composite film at a film growth rate of 0.2 μm/hr, thereby laying a surface protective layer having a thickness of 0.5 μm over the surface of the single-layer photosensitive layer. Thus was fabricated an electrophotosensitive material of Example 1-1.

### Examples 1-2 to 1-6

Electrophotosensitive materials of Examples 1-2 to 1-6 were fabricated the sameway as in Example 1-1, except that each of the examples used 40 parts by weight of diphenoquinone compound of the formula of a number listed in Table 1.

### Comparative Example 1-1

An electrophotosensitive material of Comparative Example 1-1 was fabricated the same way as in Example 1-1, except that the diphenoquinone compound was dispensed with.

### Examples 1-7 to 1-12, Comparative Example 1-2

Electrophotosensitive materials of Examples 1-7 to 1-12 and Comparative Example 1-2 were fabricated the same way as in Examples 1-1 to 1-6 and Comparative Example 1-1, except that the poly-N-vinylcarbazole was replaced by 80 parts by weight of diethylaminobenzaldehyde diphenylhydrazone as the positive-hole transport material represented by the formula (HT-3), and 100 parts by weight of Z-type polycarbonate (weight-average molecular weight Mw=20,000) as the binder resin.

Photosensitivity Test (I)

Each of the electrophotosensitive materials of the above examples and comparative examples was charged at +800±20V and the surface potential V₀(V) thereof was measured using a drum sensitivity tester available from GENTEC Co.

A bandpass filter was used to extract monochromatic light from white light from a halogen lamp as a light source of the tester, the monochromatic light having a wavelength of 780 nm and a half width of 20 nm. The surface of the above electrophotosensitive material was irradiated with the monochromatic light at a light intensity of 10 μW/cm² for 1.0 second while the half-life exposure E_{½} (μJ/cm²) was determined by measuring the time elapsed before the surface potential V₀(V) decreased to half. On the other hand, the residual potential Vᵣ(V) was determined by measuring a surface potential after a lapse of 0.5 seconds from the start of the light exposure.

Durability Test (I)

The electrophotosensitive materials of the above examples and comparative examples were each mounted in the drum sensitivity tester available from GENTEC co. The surface of each electrophotosensitive material was charged and exposed to light under the same conditions as in the photosensitivity test (I) and then was exposed to light (wavelength of 660 nm) from an erase lamp of the tester for static elimination. The process of charging, light exposure and static elimination was consecutively repeated in 2,000 cycles with a rotational speed of the electrophotosensitive material set to 40 rpm. Subsequent to the process repeated in cycles, the electrophotosensitive material was subjected to the photosensitivity test (I) again for determining the surface potential v₀(v), half-life exposure E_{½} (μJ/cm²) and residual potential Vr(V).

Solvent Resistance Test

The adhesion between the surface protective layer and the organic photosensitive layer was examined as follows. A pipette was used to apply methanol dropwise to the surface of each of the electrophotosensitive materials of the examples and comparative examples and changes of surface were visually observed. The solvent resistance of each electrophotosensitive material was evaluated based on the following criteria:

∘: a electrophotosensitive material having a good solvent resistance, suffering no cracks nor delamination of the surface protective layer;

Δ: a electrophotosensitive material more or less lower in solvent resistance, suffering cracks spread in the overall surface of the surface protective layer which, however, sustained no delamination; and

×: a electrophotosensitive material of an unacceptable solvent resistance, suffering the delamination of the surface protective layer. The results are listed in Table 1.

TABLE 1

| | | | | Initial | | | After durability test | | | |
|---|---|---|---|---|---|---|---|---|---|---|
| | | | | | | HLE | | | HLE | |
| | | P-H | | SP | RP | E_{½} | SP | RP | E_{½} | |
| | SPL | TM | DPQ | V₀(V) | Vr(V) | (μJ/cm²) | V₀(V) | Vr(V) | (μJ/cm²) | SRT |
| Ex. 1-1 | a-SiC | HT-1 | 1-1-1 | 812 | 178 | 1.251 | 817 | 185 | 1.269 | ◯ |
| Ex. 1-2 | a-SiC | HT-1 | 1-1-8 | 788 | 180 | 1.305 | 790 | 186 | 1.329 | ◯ |
| Ex. 1-3 | a-SiC | HT-1 | 1-1-18 | 798 | 166 | 1.201 | 790 | 164 | 1.205 | ◯ |
| Ex. 1-4 | a-SiC | HT-1 | 1-1-22 | 809 | 157 | 1.155 | 817 | 162 | 1.192 | ◯ |
| Ex. 1-5 | a-SiC | HT-1 | 1-1-24 | 814 | 154 | 1.112 | 809 | 158 | 1.131 | ◯ |
| Ex. 1-6 | a-SiC | HT-1 | 1-1-30 | 788 | 165 | 1.154 | 796 | 168 | 1.175 | ◯ |
| C. Ex. 1-1 | a-SiC | HT-1 | — | 817 | 205 | 1.500 | 745 | 244 | 1.785 | X |
| Ex. 1-7 | a-SiC | HT-3 | 1-1-1 | 780 | 199 | 1.401 | 790 | 194 | 1.366 | ◯ |
| Ex. 1-8 | a-SiC | HT-3 | 1-1-8 | 780 | 210 | 1.437 | 782 | 210 | 1.432 | ◯ |
| Ex. 1-9 | a-SiC | HT-3 | 1-1-18 | 804 | 189 | 1.324 | 796 | 191 | 1.338 | ◯ |
| Ex. 1-10 | a-SiC | HT-3 | 1-1-22 | 782 | 182 | 1.273 | 785 | 182 | 1.273 | ◯ |
| Ex. 1-11 | a-SiC | HT-3 | 1-1-24 | 780 | 180 | 1.226 | 792 | 170 | 1.158 | ◯ |
| Ex. 1-12 | a-SiC | HT-3 | 1-1-30 | 790 | 188 | 1.283 | 799 | 190 | 1.297 | ◯ |
| C. Ex. 1-2 | a-SiC | HT-3 | — | 804 | 232 | 1.667 | 748 | 252 | 1.810 | Δ |

SPL: Surface Protective Layer
P-H TM: Positive-hole Transport Material
DPQ: Diphenoquinone compound
SP: Surface Potential
RP: Residual Potential
HLE: Half-life Exposure
SRT: Solvent Resistance Test

It was found from the results of the solvent resistance test listed in the table that the electrophotosensitive material of Comparative Example 1-1 suffered the delamination of the surface protective layer while the electrophotosensitive material of Comparative Example 1-2 sustained cracks. It was thus concluded that where the photosensitive layer does not contain the diphenoquinone compound of the formula (1-1), the effect to improve the physical stability of the inorganic surface protective layer is not obtained.

It was also found that the electrophotosensitive materials of these comparative examples were significantly decreased in photosensitivity when formed with the surface protective layer, because they presented, in the initial stage, large residual potentials after light exposure and large half-life exposures.

Furthermore, the electrophotosensitive materials of these comparative examples were found to have poor durability because they were significantly increased in residual potential and half-life exposure after the durability test.

In contrast, all the electrophotosensitive materials of Examples 1-1 to 1-12 suffered no cracks nor delamination of the surface protective layer in the solvent resistance test. It was thus concluded that the use of the diphenoquinone compound of the formula (1-1) contributed the improvement of the physical stability of the inorganic surface protective layer.

It was also found that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

### Examples 1-13 to 1-24, Comparative Examples 1-3, 1-4

Electrophotosensitive materials of Examples 1-13 to 1-24 and of Comparative Examples 1-3, 1-4 were fabricated the same way as in Examples 1-1 to 1-12 and Comparative Examples 1-1, 1-2, except that the following procedure was taken to form a surface protective layer of amorphous carbon (C) having a thickness of 0.5 μm, instead of the silicon-carbon composite film, over the surface of the single-layer photosensitive layer.

Forming Surface Protective Layer

The aluminum tube formed with the single-layer photosensitive layer was placed in the chamber of the plasma CVD system. The air within the chamber was evacuated to reach a degree of vacuum of 0.67 Pa while the heater of the system was operated to adjust the temperature of the tube to 50° C.

Subsequently, methane gas (CH₄) and hydrogen gas (H₂) were fed into the chamber at respective flow rates listed below, thereby to adjust the degree of vacuum to 0.47 hPa.

Methane gas: 300 SCCM

Hydrogen gas: 300 SCCM

In this state, a high-frequency electric field having a frequency of 13.56 MHz and an output of 200 W was applied for causing glow discharge in the chamber. The plasma CVD process was performed for depositing a film of amorphous carbon (C) at a film growth rate of 0.15 μm/hr, thereby forming the surface protective layer of the aforesaid thickness over the surface of the single-layer photosensitive layer.

The electrophotosensitive materials of the above examples and comparative examples were subjected to the same photosensitivity test (I), durability test (I) and solvent resistance test as the above and evaluated for the characteristics thereof. The results are listed in Table 2.

TABLE 2

| | | | | Initial | | | After durability test | | | |
|---|---|---|---|---|---|---|---|---|---|---|
| | | | | | | HLE | | | HLE | |
| | | P-H | | SP | RP | E_{½} | SP | RP | E_{½} | |
| | SPL | TM | DPQ | V₀(V) | Vr(V) | (μJ/cm²) | V₀(V) | Vr(V) | (μJ/cm²) | SRT |
| Ex. 1-13 | a-C | HT-1 | 1-1-1 | 793 | 170 | 1.282 | 804 | 177 | 1.302 | ◯ |
| Ex. 1-14 | a-C | HT-1 | 1-1-8 | 793 | 180 | 1.336 | 785 | 177 | 1.321 | ◯ |
| Ex. 1-15 | a-C | HT-1 | 1-1-18 | 780 | 172 | 1.222 | 798 | 168 | 1.194 | ◯ |
| Ex. 1-16 | a-C | HT-1 | 1-1-22 | 809 | 163 | 1.194 | 801 | 159 | 1.165 | ◯ |
| Ex. 1-17 | a-C | HT-1 | 1-1-24 | 788 | 157 | 1.150 | 795 | 159 | 1.162 | ◯ |
| Ex. 1-18 | a-C | HT-1 | 1-1-30 | 798 | 161 | 1.175 | 803 | 161 | 1.169 | ◯ |
| C. Ex. 1-3 | a-C | HT-1 | — | 793 | 208 | 1.563 | 742 | 238 | 1.788 | X |
| Ex. 1-19 | a-C | HT-3 | 1-1-1 | 785 | 193 | 1.378 | 788 | 193 | 1.375 | ◯ |
| Ex. 1-20 | a-C | HT-3 | 1-1-8 | 780 | 195 | 1.413 | 788 | 197 | 1.427 | ◯ |
| Ex. 1-21 | a-C | HT-3 | 1-1-18 | 780 | 182 | 1.313 | 793 | 177 | 1.295 | ◯ |
| Ex. 1-22 | a-C | HT-3 | 1-1-22 | 801 | 168 | 1.264 | 806 | 175 | 1.288 | ◯ |
| Ex. 1-23 | a-C | HT-3 | 1-1-24 | 809 | 167 | 1.218 | 814 | 164 | 1.211 | ◯ |
| Ex. 1-24 | a-C | HT-3 | 1-1-30 | 796 | 179 | 1.273 | 814 | 176 | 1.252 | ◯ |
| C. Ex. 1-4 | a-C | HT-3 | — | 788 | 222 | 1.667 | 746 | 240 | 1.792 | X |

It was confirmed from the table that if the type of the surface protective layer was changed, the same results as the above were obtained according to the compositions of the single-layer photosensitive layer as the base.

Specifically, it was found in the solvent resistance test that both the electrophotosensitive materials of Comparative Examples 1-3, 1-4 suffered the delamination of the surface protective layer. It was thus concluded that where the photosensitive layer does not contain the diphenoquinone compound of the formula (1-1), the effect to improve the physical stability of the inorganic surface protective layer is not obtained.

It was also found that the electrophotosensitive materials of these comparative examples were significantly decreased in photosensitivity when formed with the surface protective layer, because they presented, in the initial stage, large residual potentials after light exposure and large half-life exposures.

Furthermore, the electrophotosensitive materials of these comparative examples were found to have poor durability because they were significantly increased in residual potential and half-life exposure after the durability test.

In contrast, all the electrophotosensitive materials of Examples 1-13 to 1-24 suffered no cracks nor delamination of the surface protective layer in the solvent resistance test. It was thus confirmed that the use of the diphenoquinone compound of the formula (1-1) contributed the improvement of the physical stability of the inorganic surface protective layer.

It was also found that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

### Examples 1-25, 1-26, Comparative Example 1-5

Electrophotosensitive materials of Examples 1-25, 1-26 and of Comparative Example 1-5 were fabricated the same way as in Examples 1-11, 1-12 and Comparative Examples 1-2, except that the following procedure was taken to form a surface protective layer of amorphous silicon-nitrogen (SiN) composite film having a thickness of 0.5 μm, instead of the silicon-carbon composite film, over the surface of the single-layer photosensitive layer.

Forming Surface Protective Layer

The aluminum tube formed with the single-layer photosensitive layer was placed in the chamber of the plasma CVD system. The air within the chamber was evacuated to reach a degree of vacuum of 0.67 Pa while the heater of the system was operated to adjust the temperature of the tube to 50° C.

Subsequently, silane gas (SiH₄), nitrogen gas (N₂) and hydrogen gas (H₂) were fed into the chamber at respective flow rates listed below, thereby to adjust the degree of vacuum to 0.47 hPa.

Silane gas: 15 SCCM

Nitrogen gas: 150 SCCM

Hydrogen gas: 75 SCCM

In this state, a high-frequency electric field having a frequency of 13.56 MHz and an output of 150 W was applied for causing glow discharge in the chamber. The plasma CVD process was performed for depositing a silicon-nitrogen (SiN) composite film at a film growth rate of 0.75 μm/hr, thereby forming the surface protective layer of the aforesaid thickness over the surface of the single-layer photosensitive layer.

### Examples 1-27, 1-28, Comparative Example 1-6

Electrophotosensitive materials of Examples 1-27, 1-28 and of Comparative Example 1-6 were fabricated the same way as in Examples 1-11, 1-12 and Comparative Examples 1-2, except that the following procedure was taken to form a surface protective layer of amorphous carbon-nitrogen (CN) composite film having a thickness of 0.5 μm, instead of the silicon-carbon composite film, over the surface of the single-layer photosensitive layer.

Forming Surface Protective Layer

The aluminum tube formed with the single-layer photosensitive layer was placed in the chamber of the plasma CVD system. The air within the chamber was evacuated to reach a degree of vacuum of 0.67 Pa while the heater of the system was operated to adjust the temperature of the tube to 50° C.

Subsequently, methane gas (CH₄), nitrogen gas (N₂) and hydrogen gas (H₂) were fed into the chamber at respective flow rates listed below, thereby to adjust the degree of vacuum to 0.47 hPa.

Methane gas: 100 SCCM

Nitrogen gas: 150 SCCM

Hydrogen gas: 100 SCCM

In this state, a high-frequency electric field having a frequency of 13.56 MHz and an output of 150 W was applied for causing glow discharge in the chamber. The plasma CVD process was performed for depositing a carbon-nitrogen (CN) composite film at a film growth rate of 0.10 μm/hr, thereby forming the surface protective layer of the aforesaid thickness over the surface of the single-layer photosensitive layer.

Examples 1-29, 1-30, Comparative Example 1-7

Electrophotosensitive materials of Examples 1-29, 1-30 and of Comparative Example 1-7 were fabricated the same way as in Examples 1-11, 1-12 and Comparative Examples 1-2, except that the following procedure was taken to form a surface protective layer of amorphous carbon-boron (CB) composite film having a thickness of 0.5 μm, instead of the silicon-carbon composite film, over the surface of the single-layer photosensitive layer.

Forming Surface Protective Layer

The aluminum tube formed with the single-layer photosensitive layer was placed in the chamber of the plasma CVD system. The air within the chamber was evacuated to reach a degree of vacuum of 0.67 Pa while the heater of the system was operated to adjust the temperature of the tube to 50° C.

Subsequently, methane gas (CH₄), diborane gas (B₂H₆) and hydrogen gas (H₂) were fed into the chamber at respective flow rates listed below, thereby to adjust the degree of vacuum to 0.47 hPa.

Methane gas: 100 SCCM

Diborane gas: 200 SCCM

Hydrogen gas: 100 SCCM

In this state, a high-frequency electric field having a frequency of 13.56 MHz and an output of 150 W was applied for causing glow discharge in the chamber. The plasma CVD process was performed for depositing a carbon-boron (CB) composite film at a film growth rate of 0.10 μm/hr, thereby forming the surface protective layer of the aforesaid thickness over the surface of the single-layer photosensitive layer.

### Examples 1-31, 1-32, Comparative Example 1-8

Electrophotosensitive materials of Examples 1-31, 1-32 and of Comparative Example 1-8 were fabricated the same way as in Examples 1-11, 1-12 and Comparative Examples 1-2, except that the following procedure was taken to form a surface protective layer of amorphous carbon-fluorine (CF) composite film having a thickness of 0.5 μm, instead of the silicon-carbon composite film, over the surface of the single-layer photosensitive layer.

Forming Surface Protective Layer

The aluminum tube formed with the single-layer photosensitive layer was placed in the chamber of the plasma CVD system. The air within the chamber was evacuated to reach a degree of vacuum of 0.67 Pa while the heater of the system was operated to adjust the temperature of the tube to 50° C.

Subsequently, methane gas (CH₄), carbon tetrafluoride gas (CF₄) and hydrogen gas (H₂) were fed into the chamber at respective flow rates listed below, thereby to adjust the degree of vacuum to 0.47 hPa.

Methane gas: 100 SCCM

Carbon tetrafluoride gas: 100 SCCM

Hydrogen gas: 100 SCCM

In this state, a high-frequency electric field having a frequency of 13.56 MHz and an output of 150 W was applied for causing glow discharge in the chamber. The plasma CVD process was performed for depositing a carbon-fluorine (CF) composite film at a film growth rate of 0.10 μm/hr, thereby forming the surface protective layer of the aforesaid thickness over the surface of the single-layer photosensitive layer.

### Examples 1-33, 1-34, Comparative Example 1-9

Electrophotosensitive materials of Examples 1-33, 1-34 and of Comparative Example 1-9 were fabricated the same way as in Examples 1-11, 1-12 and Comparative Examples 1-2, except that the following procedure was taken to form a surface protective layer of amorphous boron-nitrogen (BN) composite film having a thickness of 0.5 μm, instead of the silicon-carbon composite film, over the surface of the single-layer photosensitive layer.

Forming Surface Protective Layer

The aluminum tube formed with the single-layer photosensitive layer was placed in the chamber of the plasma CVD system. The air within the chamber was evacuated to reach a degree of vacuum of 0.67 Pa while the heater of the system was operated to adjust the temperature of the tube to 50° C.

Subsequently, diborane gas (B₂H₆), nitrogen gas (N₂) and hydrogen gas (H₂) were fed into the chamber at respective flow rates listed below, thereby to adjust the degree of vacuum to 0.47 hPa.

Diborane gas: 200 SCCM

Nitrogen gas: 150 SCCM

Hydrogen gas: 150 SCCM

In this state, a high-frequency electric field having a frequency of 13.56 MHz and an output of 150 W was applied for causing glow discharge in the chamber. The plasma CVD process was performed for depositing a boron-nitrogen (BN) composite film at a film growth rate of 0.08 μm/hr, thereby forming the surface protective layer of the aforesaid thickness over the surface of the single-layer photosensitive layer.

The electrophotosensitive materials of the above examples and comparative examples were subjected to the same photosensitivity test (I), durability test (I) and solvent resistance test as the above and evaluated for the characteristics thereof. The results are listed in Table 3.

TABLE 3

| | | | | Initial | | | After durability test | | | |
|---|---|---|---|---|---|---|---|---|---|---|
| | | | | | | HLE | | | HLE | |
| | | P-H | | SP | RP | E_{½} | SP | RP | E_{½} | |
| | SPL | TM | DPQ | V₀(V) | Vr(V) | (μJ/cm²) | V₀(V) | Vr(V) | (μJ/cm²) | SRT |
| Ex. 1-25 | a-SiN | HT-3 | 1-1-24 | 798 | 187 | 1.334 | 795 | 190 | 1.355 | ◯ |
| Ex. 1-26 | a-SiN | HT-3 | 1-1-30 | 798 | 192 | 1.386 | 809 | 190 | 1.372 | ◯ |
| C. Ex. 1-5 | a-SiN | HT-3 | — | 812 | 245 | 1.787 | 749 | 263 | 1.918 | Δ |
| Ex. 1-27 | a-CN | HT-3 | 1-1-24 | 801 | 194 | 1.389 | 793 | 194 | 1.389 | ◯ |
| Ex. 1-28 | a-CN | HT-3 | 1-1-30 | 780 | 203 | 1.443 | 804 | 205 | 1.457 | ◯ |
| C. Ex. 1-6 | a-CN | HT-3 | — | 790 | 252 | 1.875 | 752 | 270 | 2.009 | Δ |
| Ex. 1-29 | a-CB | HT-3 | 1-1-24 | 798 | 166 | 1.235 | 812 | 164 | 1.220 | ◯ |
| Ex. 1-30 | a-CB | HT-3 | 1-1-30 | 806 | 175 | 1.282 | 812 | 180 | 1.319 | ◯ |
| C. Ex. 1-7 | a-CB | HT-3 | — | 801 | 222 | 1.667 | 746 | 238 | 1.787 | X |
| Ex. 1-31 | a-CF | HT-3 | 1-1-24 | 782 | 180 | 1.284 | 796 | 182 | 1.298 | ◯ |
| Ex. 1-32 | a-CF | HT-3 | 1-1-30 | 790 | 187 | 1.353 | 796 | 185 | 1.339 | ◯ |
| C. Ex. 1-8 | a-CF | HT-3 | — | 788 | 232 | 1.745 | 734 | 248 | 1.865 | X |
| Ex. 1-33 | a-BN | HT-3 | 1-1-24 | 788 | 155 | 1.165 | 802 | 157 | 1.180 | ◯ |
| Ex. 1-34 | a-BN | HT-3 | 1-1-30 | 785 | 155 | 1.199 | 789 | 162 | 1.253 | ◯ |
| C. Ex. 1-9 | a-BN | HT-3 | — | 785 | 203 | 1.595 | 752 | 233 | 1.831 | X |

It was confirmed from the table that if the type of the surface protective layer was further changed, the same results as the above were obtained according to the compositions of the single-layer photosensitive layer as the base.

Specifically, it was found from the results of the solvent resistance test that all the electrophotosensitive materials of Comparative Examples 1-7 to 1-9 suffered the delamination of the surface protective layer. The electrophotosensitive materials of Comparative Examples 1-5, 1-6 were found to sustain cracks. It was thus concluded that where the photosensitive layer does not contain the diphenoquinone compound of the formula (1-1), the effect to improve the physical stability of the inorganic surface protective layer is not obtained.

It was also found that the electrophotosensitive materials of these comparative examples were significantly decreased in photosensitivity when formed with the surface protective layer, because they presented, in the initial stage, large residual potentials after light exposure and large half-life exposures.

Furthermore, the electrophotosensitive materials of these comparative examples were found to have poor durability because they were significantly increased in residual potential and half-life exposure after the durability test.

In contrast, all the electrophotosensitive materials of Examples 1-25 to 1-34 suffered no cracks nor delamination of the surface protective layer in the solvent resistance test. It was thus confirmed that the use of the diphenoquinone compound of the formula (1-1) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

Multi-layer Electrophotosensitive Material

### Example 1-35

Forming Multi-layer Photosensitive Layer

The ball mill was operated for dispersing by mixing 2.5 parts by weight of crystalline X-type metal-free phthalocyanine as the charge generating material represented by the formula (CG-1), and 1 part by weight of polyvinylbutyral as the binder resin in 15 parts by weight of tetrahydrofuran, thereby to prepare a coating solution for charge generating layer of the multi-layer photosensitive layer.

Subsequently, the resultant coating solution was dip coated on the aluminum tube as the conductive substrate and then was air dried at 110° C. for 30 minutes. Thus was formed a charge generating layer having a thickness of 0.5 μm.

The ball mill was operated for dispersing by mixing 1 part by weight of poly-N-vinylcarbazole (number-average molecular weight Mn=9500) serving as the positive-hole transport material and the binder resin and having the repeated unit represented by the formula (HT-1), and 0.2 parts by weight of diphenoquinone compound represented by the formula (1-1-1) in 10 parts by weight of tetrahydrofuran, thereby to prepare a coating solution for charge transport layer of the multi-layer photosensitive layer.

Subsequently, the resultant coating solution was dip coated on the above charge generating layer and then was air dried at 110° C. for 30 minutes, thereby to form a charge transport layer having a thickness of 20 μm. Thus was formed a negative-charge multi-layer photosensitive layer.

Forming Surface Protective Layer

The plasma CVD process was performed under the same conditions as in Example 1-1, thereby forming a surface protective layer of amorphous silicon-carbon (SiC) composite film having a thickness of 0.5 μm. Thus was fabricated an electrophotosensitive material of Example 1-35.

### Examples 1-36 to 1-40

Electrophotosensitive materials of Examples 1-36 to 1-40 were fabricated the same way as in Example 1-35 except that each of the examples used 0.2 parts by weight of diphenoquinone compound of the formula of a number listed in Table 4.

### Comparative Example 1-10

An electrophotosensitive material of Comparative Example 1-10 was fabricated the same way as in Example 1-35 except that the diphenoquinone compound was dispensed with.

### Examples 1-41 to 1-46, Comparative Example 1-11

Electrophotosensitive materials of Examples 1-41 to 1-46 and Comparative Example 1-11 were fabricated the same way as in Examples 1-35 to 1-40 and Comparative Example 1-10, except that the poly-N-vinylcarbazole was replaced by 0.8 parts by weight of diethylaminobenzaldehyde diphenylhydrazone as the positive-hole transport material represented by the formula (HT-3) and 1 part by weight of Z-type polycarbonate (weight-average molecular weight Mw=20,000) as the binder resin.

Photosensitivity Test (II)

Each of the electrophotosensitive materials of the above examples and comparative examples was charged at −800±20V and the surface potential V₀(V) thereof was measured using a drum sensitivity tester available from GENTEC Co.

A bandpass filter was used to extract monochromatic light from white light from a halogen lamp as a light source of the tester, the monochromatic light having a wavelength of 780 nm and a half width of 20 nm. The surface of the above electrophotosensitive material was irradiated with the monochromatic light at a light intensity of 10 μW/cm² for 1.0 second while the half-life exposure E_{½} (μJ/cm²) was determined by measuring the time elapsed before the surface potential V₀(V) decreased to half. On the other hand, the residual potential Vr(V) was determined by measuring a surface potential after a lapse of 0.5 seconds from the start of the light exposure.

Durability Test (II)

The electrophotosensitive materials of the above examples and comparative examples were each mounted in the drum sensitivity tester available from GENTEC Co. The surface of each electrophotosensitive material was charged and exposed to light under the same conditions as in the photosensitivity test (II) and then was exposed to light (wavelength of 660 nm) from an erase lamp of the tester for static elimination. The process of charging, light exposure and static elimination was consecutively repeated in 2,000 cycles with a rotational speed of the electrophotosensitive material set to 40 rpm. Subsequent to the process repeated in cycles, the electrophotosensitive material was subjected to the photosensitivity test (II) again for determining the surface potential V₀(V), half-life exposure E_{½} (μJ/cm²) and residual potential Vᵣ(V).

The results of the above tests as well as those of the aforementioned solvent resistance test are listed in Table 4.

TABLE 4

| | | | | Initial | | | After durability test | | | |
|---|---|---|---|---|---|---|---|---|---|---|
| | | | | | | HLE | | | HLE | |
| | | P-H | | SP | RP | E_{½} | SP | RP | E_{½} | |
| | SPL | TM | DPQ | V₀(V) | Vr(V) | (μJ/cm²) | V₀(V) | Vr(V) | (μJ/cm²) | SRT |
| Ex. 1-35 | a-SiC | HT-1 | 1-1-1 | −782 | −161 | 0.911 | −785 | −163 | 0.922 | ◯ |
| Ex. 1-36 | a-SiC | HT-1 | 1-1-8 | −804 | −153 | 0.911 | −805 | −158 | 0.941 | ◯ |
| Ex. 1-37 | a-SiC | HT-1 | 1-1-18 | −812 | −164 | 0.929 | −810 | −167 | 0.946 | ◯ |
| Ex. 1-38 | a-SiC | HT-1 | 1-1-22 | −804 | −155 | 0.920 | −806 | −160 | 0.950 | ◯ |
| Ex. 1-39 | a-SiC | HT-1 | 1-1-24 | −790 | −156 | 0.885 | −798 | −154 | 0.881 | ◯ |
| Ex. 1-40 | a-SiC | HT-1 | 1-1-30 | −809 | −158 | 0.894 | −813 | −160 | 0.905 | ◯ |
| C. Ex. 1-10 | a-SiC | HT-1 | — | −806 | −165 | 0.938 | −782 | −192 | 1.052 | X |
| Ex. 1-41 | a-SiC | HT-3 | 1-1-1 | −809 | −137 | 0.985 | −798 | −139 | 0.999 | ◯ |
| Ex. 1-42 | a-SiC | HT-3 | 1-1-8 | −780 | −140 | 1.005 | −796 | −146 | 1.048 | ◯ |
| Ex. 1-43 | a-SiC | HT-3 | 1-1-18 | −814 | −137 | 1.025 | −802 | −140 | 1.047 | ◯ |
| Ex. 1-44 | a-SiC | HT-3 | 1-1-22 | −806 | −142 | 0.985 | −801 | −148 | 1.027 | ◯ |
| Ex. 1-45 | a-SiC | HT-3 | 1-1-24 | −790 | −138 | 0.957 | −782 | −135 | 0.936 | ◯ |
| Ex. 1-46 | a-SiC | HT-3 | 1-1-30 | −798 | −134 | 0.985 | −788 | −132 | 0.970 | ◯ |
| C. Ex. 1-11 | a-SiC | HT-3 | — | −814 | −147 | 1.024 | −776 | −176 | 1.226 | X |

It was confirmed from the table that if the single-layer photosensitive layer was replaced by the multi-layer photosensitive layer, the same results as the above were obtained according to the compositions of the charge-transport layer defining the outermost part thereof.

Specifically, it was found in the solvent resistance test that both the electrophotosensitive materials of Comparative Examples 1-10, 1-11 suffered the delamination of the surface protective layer. It was thus concluded that where the photosensitive layer does not contain the diphenoquinone compound of the formula (1-1), the effect to improve the physical stability of the inorganic surface protective layer is not obtained.

It was also found that the electrophotosensitive materials of these comparative examples were significantly decreased in photosensitivity when formed with the surface protective layer, because they presented, in the initial stage, large residual potentials after light exposure and large half-life exposures.

Furthermore, the electrophotosensitive materials of these comparative examples were found to have poor durability because they were significantly increased in residual potential and half-life exposure after the durability test.

In contrast, all the electrophotosensitive materials of Examples 1-35 to 1-46 suffered no cracks nor delamination of the surface protective layer in the solvent resistance test. It was thus confirmed that the use of the diphenoquinone compound of the formula (1-1) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

### Examples 1-47 to 1-58, Comparative Examples 1-12, 1-13

Electrophotosensitive materials of these examples and comparative examples were fabricated the same way as in Examples 1-35 to 1-46 and Comparative Examples 1-10, 1-11, except that the same procedure as in Examples 1-13 to 1-24 and Comparative Examples 1-3, 1-4 was taken to form a surface protective layer of amorphous carbon (C) having a thickness of 0.5 μm, instead of the silicon-carbon composite film, over a surface of the multi-layer photosensitive layer.

The electrophotosensitive materials of the above examples and comparative examples were subjected to the same photosensitivity test (II), durability test (II) and solvent resistance test as the above and were evaluated for the characteristics thereof. The results are listed in Table 5

TABLE 5

| | | | | Initial | | | After durability test | | | |
|---|---|---|---|---|---|---|---|---|---|---|
| | | | | | | HLE | | | HLE | |
| | | P-H | | SP | RP | E_{½} | SP | RP | E_{½} | |
| | SPL | TM | DPQ | V₀(V) | Vr(V) | (μJ/cm²) | V₀(V) | Vr(V) | (μJ/cm²) | SRT |
| Ex. 1-47 | a-C | HT-1 | 1-1-1 | −788 | −161 | 1.170 | −790 | −163 | 1.184 | ◯ |
| Ex. 1-48 | a-C | HT-1 | 1-1-8 | −809 | −166 | 1.205 | −798 | −163 | 1.181 | ◯ |
| Ex. 1-49 | a-C | HT-1 | 1-1-18 | −798 | −163 | 1.204 | −795 | −169 | 1.242 | ◯ |
| Ex. 1-50 | a-C | HT-1 | 1-1-22 | −801 | −164 | 1.192 | −812 | −162 | 1.177 | ◯ |
| Ex. 1-51 | a-C | HT-1 | 1-1-24 | −798 | −162 | 1.158 | −790 | −164 | 1.172 | ◯ |
| Ex. 1-52 | a-C | HT-1 | 1-1-30 | −785 | −165 | 1.181 | −798 | −170 | 1.215 | ◯ |
| C. Ex. 1-12 | a-C | HT-1 | — | −785 | −172 | 1.216 | −748 | −198 | 1.400 | X |
| Ex. 1-53 | a-C | HT-3 | 1-1-1 | −814 | −141 | 1.056 | −806 | −143 | 1.071 | ◯ |
| Ex. 1-54 | a-C | HT-3 | 1-1-8 | −809 | −134 | 1.077 | −814 | −139 | 1.107 | ◯ |
| Ex. 1-55 | a-C | HT-3 | 1-1-18 | −793 | −135 | 1.088 | −790 | −141 | 1.116 | ◯ |
| Ex. 1-56 | a-C | HT-3 | 1-1-22 | −817 | −144 | 1.077 | −807 | −146 | 1.092 | ◯ |
| Ex. 1-57 | a-C | HT-3 | 1-1-24 | −780 | −141 | 1.056 | −793 | −143 | 1.071 | ◯ |
| Ex. 1-58 | a-C | HT-3 | 1-1-30 | −812 | −136 | 1.056 | −814 | −140 | 1.077 | ◯ |
| C. Ex. 1-13 | a-C | HT-3 | — | −817 | −146 | 1.098 | −771 | −178 | 1.339 | X |

It was confirmed from the table that if the type of the surface protective layer was changed, the same results as the above were obtained according to the compositions of the charge-transport layer of the multi-layer photosensitive layer as the base.

Specifically, it was found in the solvent resistance test that both the electrophotosensitive materials of Comparative Examples 1-12, 1-13 suffered the delamination of the surface protective layer. It was thus concluded that where the photosensitive layer does not contain the diphenoquinone compound of the formula (1-1), the effect to improve the physical stability of the inorganic surface protective layer is not obtained.

It was also found that the electrophotosensitive materials of these comparative examples were significantly decreased in photosensitivity when formed with the surface protective layer, because they presented, in the initial stage, large residual potentials after light exposure and large half-life exposures.

Furthermore, the electrophotosensitive materials of these comparative examples were found to have poor durability because they were significantly increased in residual potential and half-life exposure after the durability test.

In contrast, all the electrophotosensitive materials of Examples 1-47 to 1-58 suffered no cracks nor delamination of the surface protective layer in the solvent resistance test. It was thus confirmed that the use of the diphenoquinone compound of the formula (1-1) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

### Examples 1-59, 1-60, Comparative Example 1-14

Electrophotosensitive materials of these examples and comparative example were fabricated the same way as in Examples 1-45, 1-46 and Comparative Example 1-11, except that the same procedure as in Examples 1-25, 1-26 and Comparative Example 1-5 was taken to form a surface protective layer of amorphous silicon-nitrogen (SiN) composite film having a thickness of 0.5 μm, instead of the silicon-carbon composite film, over the surface of the multi-layer photosensitive layer.

### Examples 1-61, 1-62, Comparative Example 1-15

Electrophotosensitive materials of these examples and comparative example were fabricated the same way as in Examples 1-45, 1-46 and Comparative Example 1-11, except that the same procedure as in Examples 1-27, 1-28 and Comparative Example 1-6 was taken to form a surface protective layer of amorphous carbon-nitrogen (CN) composite film having a thickness of 0.5 μm, instead of the silicon-carbon composite film, over the surface of the multi-layer photosensitive layer.

### Examples 1-63, 1-64, Comparative Example 1-16

Electrophotosensitive materials of these examples and comparative example were fabricated the same way as in Examples 1-45, 1-46 and Comparative Example 1-11, except that the same procedure as in Examples 1-29, 1-30 and Comparative Example 1-7 was taken to form a surface protective layer of amorphous carbon-boron (CB) composite film having a thickness of 0.5 μm, instead of the silicon-carbon composite film, over the surface of the multi-layer photosensitive layer.

### Examples 1-65, 1-66, Comparative Example 1-17

Electrophotosensitive materials of these examples and comparative example were fabricated the same way as in Examples 1-45, 1-46 and Comparative Example 1-11, except that the same procedure as in Examples 1-31, 1-32 and Comparative Example 1-8 was taken to form a surface protective layer of amorphous carbon-fluorine (CF) composite film having a thickness of 0.5 μm, instead of the silicon-carbon composite film, over the surface of the multi-layer photosensitive layer.

### Examples 1-67, 1-68, Comparative Example 1-18

Electrophotosensitive materials of these examples and comparative example were fabricated the same way as in Examples 1-45, 1-46 and Comparative Example 1-11, except that the same procedure as in Examples 1-33, 1-34 and Comparative Example 1-9 was taken to form a surface protective layer of amorphous boron-nitrogen (BN) composite film having a thickness of 0.5 μm, instead of the silicon-carbon composite film, over the surface of the multi-layer photosensitive layer.

The electrophotosensitive materials of the above examples and comparative examples were subjected to the same photosensitivity test (II), durability test (II) and solvent resistance test as the above and were evaluated for the characteristics thereof. The results are listed in Table 6.

TABLE 6

| | | | | Initial | | | After durability test | | | |
|---|---|---|---|---|---|---|---|---|---|---|
| | | | | | | HLE | | | HLE | |
| | | P-H | | SP | RP | E_{½} | SP | RP | E_{½} | |
| | SPL | TM | DPQ | V₀(V) | Vr(V) | (μJ/cm²) | V₀(V) | Vr(V) | (μJ/cm²) | SRT |
| Ex. 1-59 | a-SiN | HT-3 | 1-1-24 | −788 | −145 | 1.085 | −780 | −143 | 1.087 | ◯ |
| Ex. 1-60 | a-SiN | HT-3 | 1-1-30 | −793 | −144 | 1.064 | −804 | −138 | 1.060 | ◯ |
| C. Ex. 1-14 | a-SiN | HT-3 | — | −785 | −149 | 1.095 | −758 | −186 | 1.367 | Δ |
| Ex. 1-61 | a-CN | HT-3 | 1-1-24 | −801 | −148 | 1.132 | −801 | −144 | 1.112 | ◯ |
| Ex. 1-62 | a-CN | HT-3 | 1-1-30 | −804 | −157 | 0.902 | −804 | −158 | 0.914 | ◯ |
| C. Ex. 1-15 | a-CN | HT-3 | — | −793 | −148 | 1.156 | −762 | −177 | 1.381 | X |
| Ex. 1-63 | a-CB | HT-3 | 1-1-24 | −798 | −126 | 0.951 | −790 | −134 | 1.001 | ◯ |
| Ex. 1-64 | a-CB | HT-3 | 1-1-30 | −806 | −124 | 0.951 | −817 | −134 | 1.016 | ◯ |
| C. Ex. 1-16 | a-CB | HT-3 | — | −793 | −137 | 0.979 | −746 | −167 | 1.193 | X |
| Ex. 1-65 | a-CF | HT-3 | 1-1-24 | −790 | −129 | 1.000 | −788 | −132 | 1.023 | ◯ |
| Ex. 1-66 | a-CF | HT-3 | 1-1-30 | −782 | −127 | 0.991 | −788 | −138 | 1.047 | ◯ |
| C. Ex. 1-17 | a-CF | HT-3 | — | −793 | −139 | 1.021 | −766 | −178 | 1.307 | X |
| Ex. 1-67 | a-BN | HT-3 | 1-1-24 | −790 | −117 | 0.903 | −780 | −120 | 0.926 | ◯ |
| Ex. 1-68 | a-BN | HT-3 | 1-1-30 | −806 | −116 | 0.895 | −814 | −114 | 0.897 | ◯ |
| C. Ex. 1-18 | a-BN | HT-3 | — | −780 | −117 | 0.904 | −748 | −146 | 1.128 | X |

It was confirmed from the table that if the type of the surface protective layer was further changed, the same results as the above were obtained according to the compositions of the charge-transport layer of the multi-layer photosensitive layer as the base.

Specifically, it was found from the results of the solvent resistance test that both the electrophotosensitive materials of Comparative Examples 1-15 to 1-18 suffered the delamination of the surface protective layer. The electrophotosensitive material of Comparative Example 1-14 was found to sustain cracks. It was thus concluded that where the photosensitive layer does not contain the diphenoquinone compound of the formula (1-1), the effect to improve the physical stability of the inorganic surface protective layer is not obtained.

It was also found that the electrophotosensitive materials of these comparative examples were significantly decreased in photosensitivity when formed with the surface protective layer, because they presented, in the initial stage, large residual potentials after light exposure and large half-life exposures.

Furthermore, the electrophotosensitive materials of these comparative examples were found to have poor durability because they were significantly increased in residual potential and half-life exposure after the durability test.

In contrast, all the electrophotosensitive materials of Examples 1-59 to 1-68 suffered no cracks nor delamination of the surface protective layer in the solvent resistance test. It was thus confirmed that the use of the diphenoquinone compound of the formula (1-1) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

Single-layer Electrophotosensitive Material

### Examples 2-1 to 2-5

Electrophotosensitive materials of Examples 2-1 to 2-5 were fabricated the same way as in Example 1-1, except that each of the examples used 40 parts by weight of dinaphthoquinone compound of the formula of a number listed in Table 7.

### Examples 2-6 to 2-10

Electrophotosensitive materials of Examples 2-6 to 2-10 were fabricated the same way as in Example 1-7, except that each of the examples used 40 parts by weight of dinaphthoquinone compound of the formula of a number listed in Table 7.

The electrophotosensitive materials of the above examples were subjected to the same photosensitivity test (I), durability test (I) and solvent resistance test as the above and were evaluated for the characteristics thereof. The results as well as those of Comparative Examples 1-1, 1-2 are listed in Table 7.

TABLE 7

| | | | | Initial | | | After durability test | | | |
|---|---|---|---|---|---|---|---|---|---|---|
| | | | | | | HLE | | | HLE | |
| | | P-H | | SP | RP | E_{½} | SP | RP | E_{½} | |
| | SPL | TM | DNQ | V₀(V) | Vr(V) | (μJ/cm²) | V₀(V) | Vr(V) | (μJ/cm²) | SRT |
| Ex. 2-1 | a-SiC | HT-1 | 1-2-3 | 814 | 141 | 1.035 | 812 | 143 | 1.050 | ◯ |
| Ex. 2-2 | a-SiC | HT-1 | 1-2-4 | 782 | 156 | 1.072 | 793 | 153 | 1.051 | ◯ |
| Ex. 2-3 | a-SiC | HT-1 | 1-2-5 | 780 | 146 | 1.001 | 782 | 139 | 0.953 | ◯ |
| Ex. 2-4 | a-SiC | HT-1 | 1-2-6 | 812 | 167 | 1.154 | 804 | 160 | 1.106 | ◯ |
| Ex. 2-5 | a-SiC | HT-1 | 1-2-8 | 790 | 166 | 1.200 | 798 | 169 | 1.222 | ◯ |
| C. Ex. 1-1 | a-SiC | HT-1 | — | 817 | 205 | 1.500 | 745 | 244 | 1.785 | X |
| Ex. 2-6 | a-SiC | HT-3 | 1-2-3 | 788 | 158 | 1.143 | 782 | 165 | 1.194 | ◯ |
| Ex. 2-7 | a-SiC | HT-3 | 1-2-4 | 817 | 170 | 1.209 | 809 | 168 | 1.195 | ◯ |
| Ex. 2-8 | a-SiC | HT-3 | 1-2-5 | 780 | 160 | 1.097 | 785 | 160 | 1.097 | ◯ |
| Ex. 2-9 | a-SiC | HT-3 | 1-2-6 | 814 | 175 | 1.264 | 814 | 175 | 1.264 | ◯ |
| Ex. 2-10 | a-SiC | HT-3 | 1-2-8 | 793 | 191 | 1.303 | 788 | 188 | 1.283 | ◯ |
| C. Ex. 1-2 | a-SiC | HT-3 | — | 804 | 232 | 1.667 | 748 | 252 | 1.810 | Δ |

DNQ: Dinaphtoquinone compound

According to the results of the solvent resistance test, all the electrophotosensitive materials of Examples 2-1 to 2-10 suffered no cracks nor delamination of the surface protective layer. It was thus concluded that the use of the dinaphthoquinone compound of the formula (1-2) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, becausethey had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

### Examples 2-11 to 2-20

Electrophotosensitive materials of Examples 2-11 to 2-20 were fabricated the same way as in Examples 2-1 to 2-10, except that the same procedure as in Examples 1-13 to 1-24 was taken to form a surface protective layer of amorphous carbon (C) having a thickness of 0.5 μm, instead of the silicon-carbon composite film, over the surface of the single-layer photosensitive layer.

The electrophotosensitive materials of these examples were subjected to the same photosensitivity test (I), durability test (I) and solvent resistance test as the above and were evaluated for the characteristics thereof. The results as well as those of Comparative Examples 1-3, 1-4 are listed in Table 8.

TABLE 8

| | | | | Initial | | | After durability test | | | |
|---|---|---|---|---|---|---|---|---|---|---|
| | | | | | | HLE | | | HLE | |
| | | P-H | | SP | RP | E_{½} | SP | RP | E_{½} | |
| | SPL | TM | DNQ | V₀(V) | Vr(V) | (μJ/cm²) | V₀(V) | Vr(V) | (μJ/cm²) | SRT |
| Ex. 2-11 | a-C | HT-1 | 1-2-3 | 793 | 146 | 1.086 | 801 | 151 | 1.123 | ◯ |
| Ex. 2-12 | a-C | HT-1 | 1-2-4 | 804 | 157 | 1.150 | 795 | 162 | 1.187 | ◯ |
| Ex. 2-13 | a-C | HT-1 | 1-2-5 | 806 | 145 | 1.056 | 814 | 145 | 1.056 | ◯ |
| Ex. 2-14 | a-C | HT-1 | 1-2-6 | 804 | 172 | 1.222 | 801 | 162 | 1.151 | ◯ |
| Ex. 2-15 | a-C | HT-1 | 1-2-8 | 801 | 166 | 1.251 | 809 | 166 | 1.251 | ◯ |
| C. Ex. 1-3 | a-C | HT-1 | — | 793 | 208 | 1.563 | 742 | 238 | 1.788 | X |
| Ex. 2-16 | a-C | HT-3 | 1-2-3 | 814 | 153 | 1.150 | 798 | 155 | 1.203 | ◯ |
| Ex. 2-17 | a-C | HT-3 | 1-2-4 | 806 | 171 | 1.235 | 801 | 174 | 1.257 | ◯ |
| Ex. 2-18 | a-C | HT-3 | 1-2-5 | 785 | 158 | 1.119 | 801 | 151 | 1.069 | ◯ |
| Ex. 2-19 | a-C | HT-3 | 1-2-6 | 793 | 170 | 1.283 | 817 | 170 | 1.283 | ◯ |
| Ex. 2-20 | a-C | HT-3 | 1-2-8 | 817 | 179 | 1.345 | 814 | 184 | 1.383 | ◯ |
| C. Ex. 1-4 | a-C | HT-3 | — | 788 | 222 | 1.667 | 746 | 240 | 1.792 | X |

It was confirmed from the table that if the type of the surface protective layer was changed, the same results as the above were obtained according to the compositions of the single-layer photosensitive layer as the base.

Specifically, it was found from the results of the solvent resistance test that all the electrophotosensitive materials of Examples 2-11 to 2-20 suffered no cracks nor delamination of the surface protective layer. It was thus confirmed that the use of the dinaphthoquinone compound of the formula (1-2) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

### Examples 2-21, 2-22

Electrophotosensitive materials of Examples 2-21, 2-22 were fabricated the same way as in Examples 2-7, 2-8 except that the same procedure as in Examples 1-25, 1-26 was taken to form a surface protective layer of amorphous silicon-nitrogen (SiN) composite film having a thickness of 0.5 μm, instead of the silicon-carbon composite film, over the surface of the single-layer photosensitive layer.

### Examples 2-23, 2-24

Electrophotosensitive materials of Examples 2-23, 2-24 were fabricated the same way as in Examples 2-7, 2-8 except that the same procedure as in Examples 1-27, 1-28 was taken to form a surface protective layer of amorphous carbon-nitrogen (CN) composite film having a thickness of 0.5 μm, instead of the silicon-carbon composite film, over the surface of the single-layer photosensitive layer.

### Examples 2-25, 2-26

Electrophotosensitive materials of Examples 2-25, 2-26 were fabricated the same way as in Examples 2-7, 2-8 except that the same procedure as in Examples 1-29, 1-30 was taken to form a surface protective layer of amorphous carbon-boron (CB) composite film having a thickness of 0.5 μm, instead of the silicon-carbon composite film, over the surface of the single-layer photosensitive layer.

### Examples 2-27, 2-28

Electrophotosensitive materials of Examples 2-27, 2-28 were fabricated the same way as in Examples 2-7, 2-8 except that the same procedure as in Examples 1-31, 1-32 was taken to form a surface protective layer of amorphous carbon-fluorine (CF) composite film having a thickness of 0.5 μm, instead of the silicon-carbon composite film, over the surface of the single-layer photosensitive layer.

### Examples 2-29, 2-30

Electrophotosensitive materials of Examples 2-29, 2-30 were fabricated the same way as in Examples 2-7, 2-8 except that the same procedure as in Examples 1-33, 1-34 was taken to form a surface protective layer of amorphous boron-nitrogen (BN) composite film having a thickness of 0.5 μm, instead of the silicon-carbon composite film, over the surface of the single-layer photosensitive layer.

The electrophotosensitive materials of the above examples were subjected to the same photosensitivity test (I), durability test (I) and solvent resistance test as the above and were evaluated for the characteristics thereof. The results as well as those of Comparative Examples 1-5 to 1-9 are listed in Table 9.

TABLE 9

| | | | | Initial | | | After durability test | | | |
|---|---|---|---|---|---|---|---|---|---|---|
| | | | | | | HLE | | | HLE | |
| | | P-H | | SP | RP | E_{½} | SP | RP | E_{½} | |
| | SPL | TM | DNQ | V₀(V) | Vr(V) | (μJ/cm²) | V₀(V) | Vr(V) | (μJ/cm²) | SRT |
| Ex. 2-21 | a-SiN | HT-3 | 1-2-4 | 817 | 185 | 1.334 | 806 | 187 | 1.331 | ◯ |
| Ex. 2-22 | a-SiN | HT-3 | 1-2-5 | 788 | 189 | 1.386 | 798 | 197 | 1.382 | ◯ |
| C. Ex. 1-5 | a-SiN | HT-3 | — | 812 | 245 | 1.787 | 749 | 263 | 1.918 | Δ |
| Ex. 2-23 | a-CN | HT-3 | 1-2-4 | 796 | 186 | 1.389 | 814 | 186 | 1.392 | ◯ |
| Ex. 2-24 | a-CN | HT-3 | 1-2-5 | 809 | 193 | 1.443 | 809 | 193 | 1.442 | ◯ |
| C. Ex. 1-6 | a-CN | HT-3 | — | 790 | 252 | 1.875 | 752 | 270 | 2.009 | Δ |
| Ex. 2-25 | a-CB | HT-3 | 1-2-4 | 785 | 171 | 1.235 | 780 | 171 | 1.236 | ◯ |
| Ex. 2-26 | a-CB | HT-3 | 1-2-5 | 812 | 173 | 1.283 | 801 | 175 | 1.281 | ◯ |
| C. Ex. 1-7 | a-CB | HT-3 | — | 801 | 222 | 1.667 | 746 | 238 | 1.787 | X |
| Ex. 2-27 | a-CF | HT-3 | 1-2-4 | 801 | 180 | 1.283 | 814 | 180 | 1.285 | ◯ |
| Ex. 2-28 | a-CF | HT-3 | 1-2-5 | 790 | 187 | 1.353 | 801 | 187 | 1.351 | ◯ |
| C. Ex. 1-8 | a-CF | HT-3 | — | 788 | 232 | 1.745 | 734 | 248 | 1.865 | X |
| Ex. 2-29 | a-BN | HT-3 | 1-2-4 | 806 | 150 | 1.164 | 806 | 153 | 1.226 | ◯ |
| Ex. 2-30 | a-BN | HT-3 | 1-2-5 | 806 | 155 | 1.199 | 812 | 160 | 1.238 | ◯ |
| C. Ex. 1-9 | a-BN | HT-3 | — | 785 | 203 | 1.595 | 752 | 233 | 1.831 | X |

It was confirmed from the table that if the type of the surface protective layer was further changed, the same results as the above were obtained according to the compositions of the single-layer photosensitive layer as the base.

According to the results of the solvent resistance test listed in the table, all the electrophotosensitive materials of Examples 2-21 to 2-30 suffered no cracks nor delamination of the surface protective layer. It was thus concluded that the use of the dinaphthoquinone compound of the formula (1-2) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

Multi-layer Electrophotosensitive Material

### Examples 2-31 to 2-35

Electrophotosensitive materials of Examples 2-31 to 2-35 were fabricated the same way as in Example 1-35, except that each of the examples used 0.2 parts by weight of dinaphthoquinone compound of the formula of a number listed in Table 10. Examples 2-36 to 2-40 Electrophotosensitive materials of Examples 2-36 to 2-40 were fabricated the same way as in Example 1-41, except that each of the examples used 40 parts by weight of dinaphthoquinone compound of the formula of a number listed in Table 10.

The electrophotosensitive materials of the above examples were subjected to the same sensitivity test (II), durability test (II) and solvent resistance test as the above and evaluated for the characteristics thereof. The results as well as those of Comparative Examples 1-10, 1-11 are listed in Table 10.

TABLE 10

| | | | | Initial | | | After durability test | | | |
|---|---|---|---|---|---|---|---|---|---|---|
| | | | | | | HLE | | | HLE | |
| | | P-H | | SP | RP | E_{½} | SP | RP | E_{½} | |
| | SPL | TM | DNQ | V₀(V) | Vr(V) | (μJ/cm²) | V₀(V) | Vr(V) | (μJ/cm²) | SRT |
| Ex. 2-31 | a-SiC | HT-1 | 1-2-3 | −804 | −157 | 0.902 | −806 | −152 | 0.873 | ◯ |
| Ex. 2-32 | a-SiC | HT-1 | 1-2-4 | −809 | −150 | 0.894 | −812 | −151 | 0.891 | ◯ |
| Ex. 2-33 | a-SiC | HT-1 | 1-2-5 | −804 | −155 | 0.878 | −805 | −152 | 0.861 | ◯ |
| Ex. 2-34 | a-SiC | HT-1 | 1-2-6 | −817 | −149 | 0.885 | −813 | −146 | 0.867 | ◯ |
| Ex. 2-35 | a-SiC | HT-1 | 1-2-8 | −804 | −157 | 0.911 | −812 | −158 | 0.908 | ◯ |
| C. Ex. 1-10 | a-SiC | HT-1 | — | −806 | −165 | 0.938 | −782 | −192 | 1.052 | X |
| Ex. 2-36 | a-SiC | HT-3 | 1-2-3 | −809 | −134 | 0.985 | −809 | −132 | 0.970 | ◯ |
| Ex. 2-37 | a-SiC | HT-3 | 1-2-4 | −812 | −130 | 0.976 | −802 | −138 | 1.036 | ◯ |
| Ex. 2-38 | a-SiC | HT-3 | 1-2-5 | −802 | −138 | 0.948 | −809 | −128 | 0.931 | ◯ |
| Ex. 2-39 | a-SiC | HT-3 | 1-2-6 | −811 | −132 | 0.967 | −799 | −129 | 0.945 | ◯ |
| Ex. 2-40 | a-SiC | HT-3 | 1-2-8 | −801 | −138 | 0.995 | −809 | −136 | 0.981 | ◯ |
| C. Ex. 1-11 | a-SiC | HT-3 | — | −814 | −147 | 1.024 | −776 | −176 | 1.226 | X |

It was confirmed from the table that if the single-layer photosensitive layer was replaced by the multi-layer photosensitive layer, the same results as the above were obtained according to the compositions of the charge transport layer defining the outermost part thereof.

According to the results of the solvent resistance test listed in the table, all the electrophotosensitive materials of Examples 2-31 to 2-40 suffered no cracks nordelamination of the surface protective layer. It was thus concluded that the use of the dinaphthoquinone compound of the formula (1-2) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

### Examples 2-41 to 2-50

Electrophotosensitive materials of these examples were fabricated the same way as in Examples 2-31 to 2-40, except that the same procedure as in Examples 1-13 to 1-24 was taken to form a surface protective layer of amorphous carbon (C) having a thickness of 0.5 μm, instead of the silicon-carbon composite film, over a surface of the multi-layer photosensitive layer.

The electrophotosensitive materials of these examples were subjected to the same photosensitivity test (II), durability test (II) and solvent resistance test as the above and were evaluated for the characteristics thereof. The results as well as those of Comparative Examples 1-12, 1-13, are listed in Table 11.

TABLE 11

| | | | | Initial | | | After durability test | | | |
|---|---|---|---|---|---|---|---|---|---|---|
| | | | | | | HLE | | | HLE | |
| | | P-H | | SP | RP | E_{1/2} | SP | RP | E_{1/2} | |
| | SPL | TM | DNQ | V₀(V) | Vr(V) | (μJ/cm²) | V₀(V) | Vr(V) | (μJ/cm²) | SRT |
| Ex. 2-41 | a-C | HT-1 | 1-2-3 | −824 | −166 | 1.169 | −817 | −163 | 1.148 | ∘ |
| Ex. 2-42 | a-C | HT-1 | 1-2-4 | −790 | −157 | 1.159 | −790 | −162 | 1.186 | ∘ |
| Ex. 2-43 | a-C | HT-1 | 1-2-5 | −798 | −161 | 1.136 | −795 | −165 | 1.154 | ∘ |
| Ex. 2-44 | a-C | HT-1 | 1-2-6 | −796 | −160 | 1.148 | −799 | −162 | 1.162 | ∘ |
| Ex. 2-45 | a-C | HT-1 | 1-2-8 | −802 | −162 | 1.181 | −795 | −164 | 1.196 | ∘ |
| C. Ex. 1-12 | a-C | HT-1 | — | −785 | −172 | 1.216 | −748 | −198 | 1.400 | x |
| Ex. 2-46 | a-C | HT-3 | 1-2-3 | −807 | −136 | 1.056 | −792 | −133 | 1.043 | ∘ |
| Ex. 2-47 | a-C | HT-3 | 1-2-4 | −817 | −132 | 1.046 | −805 | −130 | 1.030 | ∘ |
| Ex. 2-48 | a-C | HT-3 | 1-2-5 | −782 | −132 | 1.027 | −795 | −137 | 1.066 | ∘ |
| Ex. 2-49 | a-C | HT-3 | 1-2-6 | −785 | −138 | 1.032 | −793 | −131 | 0.993 | ∘ |
| Ex. 2-50 | a-C | HT-3 | 1-2-8 | −806 | −132 | 1.067 | −804 | −132 | 1.061 | ∘ |
| C. Ex. 1-13 | a-C | HT-3 | — | −817 | −146 | 1.098 | −771 | −178 | 1.339 | x |

It was confirmed from the table that if the type of the surface protective layer was changed, the same results as the above were obtained according to the compositions of the charge transport layer of the multi-layer photosensitive layer as the base.

According to the results of the solvent resistance test listed in the table, all the electrophotosensitive materials of Examples 2-41 to 2-50 suffered no cracks nor delamination of the surface protective layer. It was thus concluded that the use of the dinaphthoquinone compound of the formula (1-2) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

### Examples 2-51 to 2-52

Electrophotosensitive materials of these examples were fabricated the same way as in Examples 2-37, 2-38 except that the same procedure as in Examples 1-25, 1-26 was taken to form a surface protective layer of amorphous silicon-nitrogen (SiN) composite film having a thickness of 0.5 μm, instead of the silicon-carbon composite film, over the surface of the multi-layer photosensitive layer.

### Examples 2-53, 2-54

Electrophotosensitive materials of these examples were fabricated the same way as in Examples 2-37, 2-38 except that the same procedure as in Examples 1-27, 1-28 was taken to form a surface protective layer of amorphous carbon-nitrogen (CN) composite film having a thickness of 0.5 μm, instead of the silicon-carbon composite film, over the surface of the multi-layer photosensitive layer.

### Examples 2-55, 2-56

Electrophotosensitive materials of these examples were fabricated the same way as in Examples 2-37, 2-38 except that the same procedure as in Examples 1-29, 1-30 was taken to form a surface protective layer of amorphous carbon-boron (CB) composite film having a thickness of 0.5 μm, instead of the silicon-carbon composite film, over the surface of the multi-layer photosensitive layer.

### Examples 2-57, 2-58

Electrophotosensitive materials of these examples were fabricated the same way as in Examples 2-37, 2-38 except that the same procedure as in Examples 1-31, 1-32 was taken to form a surface protective layer of amorphous carbon-fluorine (CF) composite film having a thickness of 0.5 μm, instead of the silicon-carbon composite film, over the surface of the multi-layer photosensitive layer.

### Examples 2-59, 2-60

Electrophotosensitive materials of these examples were fabricated the same way as in Examples 2-37, 2-38 except that the same procedure as in Examples 1-33, 1-34 was taken to form a surface protective layer of amorphous boron-nitrogen (BN) composite film having a thickness of 0.5 μm, instead of the silicon-carbon composite film, over the surface of the multi-layer photosensitive layer.

The electrophotosensitive materials of the above examples were subjected to the same photosensitivity test (II), durability test (II) and solvent resistance test as the above and were evaluated for the characteristics thereof. The results as well as those of Comparative Examples 1-14 to 1-18 are listed in Table 12.

TABLE 12

| | | | | Initial | | | After durability test | | | |
|---|---|---|---|---|---|---|---|---|---|---|
| | | | | | | HLE | | | HLE | |
| | | P-H | | SP | RP | E_{1/2} | SP | RP | E_{1/2} | |
| | SPL | TM | DNQ | V₀(V) | Vr(V) | (μJ/cm²) | V₀(V) | Vr(V) | (μJ/cm²) | SRT |
| Ex. 2-51 | a-SiN | HT-3 | 1-2-4 | −812 | −133 | 1.064 | −803 | −131 | 1.048 | ∘ |
| Ex. 2-52 | a-SiN | HT-3 | 1-2-5 | −804 | −134 | 1.064 | −796 | −124 | 0.993 | ∘ |
| C. Ex. 1-14 | a-SiN | HT-3 | — | −785 | −139 | 1.096 | −758 | −186 | 1.367 | Δ |
| Ex. 2-53 | a-CN | HT-3 | 1-2-4 | −806 | −136 | 1.133 | −803 | −135 | 1.131 | ∘ |
| Ex. 2-54 | a-CN | HT-3 | 1-2-5 | −790 | −157 | 0.902 | −796 | −152 | 0.873 | ∘ |
| C. Ex. 1-15 | a-CN | HT-3 | — | −793 | −146 | 1.156 | −762 | −177 | 1.381 | x |
| Ex. 2-55 | a-CB | HT-3 | 1-2-4 | −793 | −129 | 0.951 | −791 | −122 | 0.936 | ∘ |
| Ex. 2-56 | a-CB | HT-3 | 1-2-5 | −814 | −124 | 0.951 | −808 | −122 | 0.936 | ∘ |
| C. Ex. 1-16 | a-CB | HT-3 | — | −793 | −137 | 0.979 | −746 | −167 | 1.193 | x |
| Ex. 2-57 | a-CF | HT-3 | 1-2-4 | −788 | −132 | 0.982 | −792 | −134 | 0.997 | ∘ |
| Ex. 2-58 | a-CF | HT-3 | 1-2-5 | −796 | −135 | 0.992 | −801 | −130 | 0.965 | ∘ |
| C. Ex. 1-17 | a-CF | HT-3 | — | −793 | −139 | 1.021 | −766 | −178 | 1.307 | x |
| Ex. 2-59 | a-BN | HT-3 | 1-2-4 | −793 | −103 | 0.870 | −788 | −101 | 0.954 | ∘ |
| Ex. 2-60 | a-BN | HT-3 | 1-2-5 | −814 | −107 | 0.861 | −812 | −103 | 0.841 | ∘ |
| C. Ex. 1-18 | a-BN | HT-3 | — | −780 | −117 | 0.904 | −748 | −146 | 1.128 | x |

It was confirmed from the table that if the type of the surface protective layer was further changed, the same results as the above were obtained according to the compositions of the charge transport layer of the multi-layer photosensitive layer as the base.

According to the results of the solvent resistance test listed in the table, all the electrophotosensitive materials of Examples 2-51 to 2-60 suffered no cracks nor delamination of the surface protective layer. It was thus concluded that the use of the dinaphthoquinone compound of the formula (1-2) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

Single-layer Electrophotosensitive Material

### Examples 3-1 to 3-7

Electrophotosensitive materials of Examples 3-1 to 3-7 were fabricated the same way as in Example 1-1, except that each of the examples used 40 parts by weight of naphthoquinone compound of the formula of a number listed in Table 13.

### Examples 3-8 to 3-14

Electrophotosensitive materials of Examples 3-8 to 3-14 were fabricated the same way as in Example 1-7, except that each of the examples used 40 parts by weight of naphthoquinone compound of the formula of a number listed in Table 13.

The electrophotosensitive materials of the above examples were subjected to the same photosensitivity test (I), durability test (I) and solvent resistance test as the above and were evaluated for the characteristics thereof. The results as well as those of Comparative Examples 1-1, 1-2 are listed in Table 13.

TABLE 13

| | | | | Initial | | | After durability test | | | |
|---|---|---|---|---|---|---|---|---|---|---|
| | | | | | | HLE | | | HLE | |
| | | P-H | | SP | RP | E_{1/2} | SP | RP | E_{1/2} | |
| | SPL | TM | NQC | V₀(V) | Vr(V) | (μJ/cm²) | V₀(V) | Vr(V) | (μJ/cm²) | SRT |
| Ex. 3-1 | a-SiC | HT-1 | 2-1-5 | 809 | 196 | 1.390 | 795 | 201 | 1.455 | ∘ |
| Ex. 3-2 | a-SiC | HT-1 | 2-2-4 | 793 | 178 | 1.304 | 801 | 185 | 1.355 | ∘ |
| Ex. 3-3 | a-SiC | HT-1 | 2-2-9 | 802 | 183 | 1.271 | 798 | 181 | 1.257 | ∘ |
| Ex. 3-4 | a-SiC | HT-1 | 2-3-1 | 785 | 162 | 1.155 | 795 | 165 | 1.176 | ∘ |
| Ex. 3-5 | a-SiC | HT-1 | 2-3-3 | 796 | 163 | 1.181 | 788 | 161 | 1.167 | ∘ |
| Ex. 3-6 | a-SiC | HT-1 | 2-3-8 | 796 | 175 | 1.226 | 788 | 168 | 1.198 | ∘ |
| Ex. 3-7 | a-SiC | HT-1 | 2-3-11 | 806 | 170 | 1.251 | 795 | 168 | 1.236 | ∘ |
| C. Ex. 1-1 | a-SiC | HT-1 | — | 817 | 205 | 1.500 | 745 | 244 | 1.785 | x |
| Ex. 3-8 | a-SiC | HT-3 | 2-1-5 | 814 | 219 | 1.544 | 809 | 226 | 1.593 | ∘ |
| Ex. 3-9 | a-SiC | HT-3 | 2-2-4 | 793 | 206 | 1.450 | 802 | 204 | 1.436 | ∘ |
| Ex. 3-10 | a-SiC | HT-3 | 2-2-9 | 812 | 204 | 1.414 | 795 | 199 | 1.383 | ∘ |
| Ex. 3-11 | a-SiC | HT-3 | 2-3-1 | 814 | 188 | 1.282 | 815 | 182 | 1.261 | ∘ |
| Ex. 3-12 | a-SiC | HT-3 | 2-3-3 | 788 | 187 | 1.313 | 804 | 190 | 1.334 | ∘ |
| Ex. 3-13 | a-SiC | HT-3 | 2-3-8 | 798 | 192 | 1.367 | 780 | 195 | 1.388 | ∘ |
| Ex. 3-14 | a-SiC | HT-3 | 2-3-11 | 812 | 198 | 1.390 | 796 | 195 | 1.369 | ∘ |
| C. Ex. 1-2 | a-SiC | HT-3 | — | 804 | 232 | 1.667 | 748 | 252 | 1.810 | Δ |

NQC: Naphtoquinone compound

According to the results of the solvent resistance test listed in the table, all the electrophotosensitive materials of Examples 3-1 to 3-14 suffered no cracks nor delamination of the surface protective layer. It was thus concluded that the use of the naphthoquinone compounds of the formulas (2-1) to (2-3) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

### Examples 3-15 to 3-28

Electrophotosensitive materials of Examples 3-15 to 3-28 were fabricated the same way as in Examples 3-1 to 3-14 except that the same procedure as in Examples 1-13 to 1-24 was taken to form a surface protective layer of amorphous carbon (C) having a thickness of 0.5 μm, instead of the silicon-carbon composite film, over the surface of the single-layer photosensitive layer.

The electrophotosensitive materials of the above examples were subjected to the same photosensitivity test (I), durability test (I) and solvent resistance test as the above and were evaluated for the characteristics thereof. The results as well as those of Comparative Examples 1-3, 1-4 are listed in Table 14.

TABLE 14

| | | | | Initial | | | After durability test | | | |
|---|---|---|---|---|---|---|---|---|---|---|
| | | | | | | HLE | | | HLE | |
| | | P-H | | SP | RP | E_{1/2} | SP | RP | E_{1/2} | |
| | SPL | TM | NQC | V₀(V) | Vr(V) | (μJ/cm²) | V₀(V) | Vr(V) | (μJ/cm²) | SRT |
| Ex. 3-15 | a-C | HT-1 | 2-1-5 | 794 | 192 | 1.448 | 786 | 210 | 1.584 | ∘ |
| Ex. 3-16 | a-C | HT-1 | 2-2-4 | 795 | 185 | 1.360 | 796 | 180 | 1.343 | ∘ |
| Ex. 3-17 | a-C | HT-1 | 2-2-9 | 808 | 181 | 1.325 | 817 | 183 | 1.340 | ∘ |
| Ex. 3-18 | a-C | HT-1 | 2-3-1 | 812 | 162 | 1.203 | 804 | 160 | 1.188 | ∘ |
| Ex. 3-19 | a-C | HT-1 | 2-3-3 | 804 | 173 | 1.231 | 798 | 166 | 1.211 | ∘ |
| Ex. 3-20 | a-C | HT-1 | 2-3-8 | 788 | 172 | 1.282 | 785 | 175 | 1.304 | ∘ |
| Ex. 3-21 | a-C | HT-1 | 2-3-11 | 796 | 178 | 1.303 | 804 | 179 | 1.310 | ∘ |
| C. Ex. 1-3 | a-C | HT-1 | — | 793 | 208 | 1.563 | 742 | 238 | 1.788 | x |
| Ex. 3-22 | a-C | HT-3 | 2-1-5 | 817 | 213 | 1.544 | 804 | 221 | 1.631 | ∘ |
| Ex. 3-23 | a-C | HT-3 | 2-2-4 | 803 | 193 | 1.450 | 809 | 190 | 1.427 | ∘ |
| Ex. 3-24 | a-C | HT-3 | 2-2-9 | 796 | 188 | 1.413 | 806 | 190 | 1.428 | ∘ |
| Ex. 3-25 | a-C | HT-3 | 2-3-1 | 785 | 170 | 1.283 | 780 | 168 | 1.268 | ∘ |
| Ex. 3-26 | a-C | HT-3 | 2-3-3 | 809 | 177 | 1.313 | 806 | 179 | 1.328 | ∘ |
| Ex. 3-27 | a-C | HT-3 | 2-3-8 | 804 | 184 | 1.367 | 793 | 181 | 1.345 | ∘ |
| Ex. 3-28 | a-C | HT-3 | 2-3-11 | 806 | 185 | 1.389 | 796 | 190 | 1.427 | ∘ |
| C. Ex. 1-4 | a-C | HT-3 | — | 788 | 222 | 1.667 | 746 | 240 | 1.792 | x |

It was confirmed from the table that if the type of the surface protective layer was changed, the same results as the above were obtained according to the compositions of the single-layer photosensitive layer as the base.

According to the results of the solvent resistance test listed in the table, all the electrophotosensitive materials of Examples 3-15 to 3-28 suffered no cracks nor delamination of the surface protective layer. It was thus concluded that the use of the naphthoquinone compounds of the formulas (2-1) to (2-3) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

### Examples 3-29 to 3-32

Electrophotosensitive materials of Examples 3-29 to 3-32 were fabricated the same way as in Examples 3-8, 3-10, 3-12 and 3-13 except that the same procedure as in Examples 1-25, 1-26 was taken to form a surface protective layer of amorphous silicon-nitrogen (SiN) composite film having a thickness of 0.5 μm, instead of the silicon-carbon composite film, over the surface of the single-layer photosensitive layer.

### Examples 3-33 to 3-36

Electrophotosensitive materials of Examples 3-33 to 3-36 were fabricated the same way as in Examples 3-8, 3-10, 3-12 and 3-13 except that the same procedure as in Examples 1-27, 1-28 was taken to form a surface protective layer of amorphous carbon-nitrogen (CN) composite film having a thickness of 0.5 μm, instead of the silicon-carbon composite film, over the surface of the single-layer photosensitive layer.

### Examples 3-37 to 3-40

Electrophotosensitive materials of Examples 3-37 to 3-40 were fabricated the same way as in Examples 3-8, 3-10, 3-12 and 3-13 except that the same procedure as in Examples 1-29, 1-30 was taken to form a surface protective layer of amorphous carbon-boron (CB) composite film having a thickness of 0.5 μm, instead of the silicon-carbon composite film, over the surface of the single-layer photosensitive layer.

### Examples 3-41 to 3-44

Electrophotosensitive materials of Examples 3-41 to 3-44 were fabricated the same way as in Examples 3-8, 3-10, 3-12 and 3-13 except that the same procedure as in Examples 1-31, 1-32 was taken to form a surface protective layer of amorphous carbon-fluorine (CF) composite film having a thickness of 0.5 μm, instead of the silicon-carbon composite film, over the surface of the single-layer photosensitive layer.

### Examples 3-45 to 3-48

Electrophotosensitive materials of Examples 3-45 to 3-48 were fabricated the same way as in Examples 3-8, 3-10, 3-12 and 3-13 except that the same procedure as in Examples 1-33, 1-34 was taken to form a surface protective layer of amorphous boron-nitrogen (BN) composite film having a thickness of 0.5 μm, instead of the silicon-carbon composite film, over the surface of the single-layer photosensitive layer.

The electrophotosensitive materials of the above examples were subjected to the same photosensitivity test (I), durability test (I) and solvent resistance test as the above and were evaluated for the characteristics thereof. The results as well as those of Comparative Examples 1-5 to 1-9 are listed in Tables 15a and 15b.

TABLE 15

| | | | | Initial | | | After durability test | | | |
|---|---|---|---|---|---|---|---|---|---|---|
| | | | | | | HLE | | | HLE | |
| | | P-H | | SP | RP | E_{1/2} | SP | RP | E_{1/2} | |
| | SPL | TM | NQC | V₀(V) | Vr(V) | (μJ/cm²) | V₀(V) | Vr(V) | (μJ/cm²) | SRT |
| Ex. 3-29 | a-SiN | HT-3 | 2-1-5 | 814 | 231 | 1.655 | 804 | 238 | 1.705 | ∘ |
| Ex. 3-30 | a-SiN | HT-3 | 2-2-9 | 780 | 212 | 1.515 | 793 | 217 | 1.531 | ∘ |
| Ex. 3-31 | a-SiN | HT-3 | 2-3-3 | 785 | 202 | 1.408 | 809 | 202 | 1.411 | ∘ |
| Ex. 3-32 | a-SiN | HT-3 | 2-3-8 | 812 | 203 | 1.465 | 801 | 206 | 1.478 | ∘ |
| C. Ex. 1-5 | a-SiN | HT-3 | — | 812 | 245 | 1.787 | 749 | 263 | 1.918 | Δ |
| Ex. 3-33 | a-CN | HT-3 | 2-1-5 | 798 | 240 | 1.737 | 802 | 248 | 1.795 | ∘ |
| Ex. 3-34 | a-CN | HT-3 | 2-2-9 | 793 | 203 | 1.443 | 796 | 201 | 1.432 | ∘ |
| Ex. 3-35 | a-CN | HT-3 | 2-3-3 | 812 | 191 | 1.389 | 798 | 194 | 1.411 | ∘ |
| Ex. 3-36 | a-CN | HT-3 | 2-3-8 | 814 | 196 | 1.443 | 806 | 200 | 1.465 | ∘ |
| C. Ex. 1-6 | a-CN | HT-3 | — | 790 | 252 | 1.875 | 752 | 270 | 2.009 | Δ |
| Ex. 3-37 | a-CB | HT-3 | 2-1-5 | 806 | 205 | 1.544 | 794 | 215 | 1.619 | ∘ |
| Ex. 3-38 | a-CB | HT-3 | 2-2-9 | 817 | 170 | 1.283 | 806 | 177 | 1.343 | ∘ |
| Ex. 3-39 | a-CB | HT-3 | 2-3-3 | 793 | 174 | 1.235 | 782 | 171 | 1.215 | ∘ |
| Ex. 3-40 | a-CB | HT-3 | 2-3-8 | 796 | 173 | 1.283 | 801 | 178 | 1.320 | ∘ |
| C. Ex. 1-7 | a-CB | HT-3 | — | 801 | 222 | 1.667 | 746 | 238 | 1.787 | x |
| Ex. 3-41 | a-CF | HT-3 | 2-1-5 | 809 | 222 | 1.616 | 817 | 228 | 1.660 | ∘ |
| Ex. 3-42 | a-CF | HT-3 | 2-2-9 | 801 | 192 | 1.353 | 809 | 197 | 1.388 | ∘ |
| Ex. 3-43 | a-CF | HT-3 | 2-3-3 | 806 | 182 | 1.284 | 809 | 186 | 1.296 | ∘ |
| Ex. 3-44 | a-CF | HT-3 | 2-3-8 | 788 | 197 | 1.354 | 785 | 192 | 1.338 | ∘ |
| C. Ex. 1-8 | a-CF | HT-3 | — | 788 | 232 | 1.745 | 734 | 248 | 1.865 | x |
| Ex. 3-45 | a-BN | HT-3 | 2-1-5 | 801 | 192 | 1.478 | 804 | 206 | 1.586 | ∘ |
| Ex. 3-46 | a-BN | HT-3 | 2-2-9 | 810 | 152 | 1.200 | 812 | 160 | 1.263 | ∘ |
| Ex. 3-47 | a-BN | HT-3 | 2-3-3 | 812 | 155 | 1.165 | 814 | 155 | 1.165 | ∘ |
| Ex. 3-48 | a-BN | HT-3 | 2-3-8 | 808 | 157 | 1.200 | 812 | 152 | 1.162 | ∘ |
| C. Ex. 1-9 | a-BN | HT-3 | — | 785 | 203 | 1.595 | 752 | 233 | 1.831 | x |

It was confirmed from the tables that if the type of the surface protective layer was further changed, the same results as the above were obtained according to the compositions of the single-layer photosensitive layer as the base.

According to the results of the solvent resistance test listed in the tables, all the electrophotosensitive materials of Examples 3-29 to 3-48 suffered no cracks nor delamination of the surface protective layer. It was thus concluded that the use of the naphthoquinone compounds of the formulas (2-1) to (2-3) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

Multi-layer Electrophotosensitive Material

### Examples 3-49 to 3-55

Electrophotosensitive materials of Examples 3-49 to 3-55 were fabricated the same way as in Example 1-35, except that each of the examples used 0.2 parts by weight of naphthoquinone compound of the formula of a number listed in Table 16.

### Examples 3-56 to 3-62

Electrophotosensitive materials of Examples 3-56 to 3-62 were fabricated the same way as in Example 1-41, except that each of the examples used 40 parts by weight of naphthoquinone compound of the formula of a number listed in Table 16.

The electrophotosensitive materials of the above examples were subjected to the same photosensitivity test (II), durability test (II) and solvent resistance test as the above and were evaluated for the characteristics thereof. The results as well as the those of Comparative Examples 1-10, 1-11 are listed in Table 16.

TABLE 16

| | | | | Initial | | | After durability test | | | |
|---|---|---|---|---|---|---|---|---|---|---|
| | | | | | | HLE | | | HLE | |
| | | P-H | | SP | RP | E_{1/2} | SP | RP | E_{1/2} | |
| | SPL | TM | NQC | V₀(V) | Vr(V) | (μJ/cm²) | V₀(V) | Vr(V) | (μJ/cm²) | SRT |
| Ex. 3-49 | a-SiC | HT-1 | 2-1-5 | −812 | −160 | 0.920 | −817 | −164 | 0.943 | ∘ |
| Ex. 3-50 | a-SiC | HT-1 | 2-2-4 | −801 | −153 | 0.912 | −798 | −151 | 0.900 | ∘ |
| Ex. 3-51 | a-SiC | HT-1 | 2-2-9 | −792 | −158 | 0.911 | −787 | −161 | 0.928 | ∘ |
| Ex. 3-52 | a-SiC | HT-1 | 2-3-1 | −806 | −145 | 0.877 | −798 | −148 | 0.895 | ∘ |
| Ex. 3-53 | a-SiC | HT-1 | 2-3-3 | −809 | −150 | 0.893 | −802 | −154 | 0.917 | ∘ |
| Ex. 3-54 | a-SiC | HT-1 | 2-3-8 | −796 | −157 | 0.902 | −801 | −158 | 0.908 | ∘ |
| Ex. 3-55 | a-SiC | HT-1 | 2-3-11 | −812 | −153 | 0.911 | −803 | −156 | 0.929 | ∘ |
| C. Ex. 1-10 | a-SiC | HT-1 | — | −806 | −165 | 0.938 | −782 | −192 | 1.052 | x |
| Ex. 3-56 | a-SiC | HT-3 | 2-1-5 | −812 | −140 | 0.994 | −793 | −152 | 1.079 | ∘ |
| Ex. 3-57 | a-SiC | HT-3 | 2-2-4 | −812 | −133 | 0.995 | −817 | −138 | 0.991 | ∘ |
| Ex. 3-58 | a-SiC | HT-3 | 2-2-9 | −809 | −136 | 0.994 | −802 | −133 | 0.983 | ∘ |
| Ex. 3-59 | a-SiC | HT-3 | 2-3-1 | −802 | −133 | 0.957 | −806 | −135 | 0.971 | ∘ |
| Ex. 3-60 | a-SiC | HT-3 | 2-3-3 | −798 | −130 | 0.976 | −792 | −135 | 0.981 | ∘ |
| Ex. 3-61 | a-SiC | HT-3 | 2-3-8 | −790 | −137 | 0.986 | −804 | −134 | 0.985 | ∘ |
| Ex. 3-62 | a-SiC | HT-3 | 2-3-11 | −795 | −138 | 0.994 | −804 | −136 | 0.980 | ∘ |
| C. Ex. 1-11 | a-SiC | HT-3 | — | −814 | −147 | 1.024 | −776 | −176 | 1.226 | x |

It was confirmed from the table that if the single-layer photosensitive layer was replaced by the multi-layer photosensitive layer, the same results as the above were obtained according to the compositions of the charge transport layer defining the outermost part thereof.

According to the results of the solvent resistance test listed in the table, all the electrophotosensitive materials of Examples 3-49 to 3-62 suffered no cracks nor delamination of the surface protective layer. It was thus concluded that the use of the naphthoquinone compounds of the formulas (2-1) to (2-3) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

### Examples 3-63 to 3-76

Electrophotosensitive materials of these examples were fabricated the same way as in Examples 3-49 to 3-62 except that the same procedure as in Examples 1-13 to 1-24 was taken to form a surface protective layer of amorphous carbon (C) having a thickness of 0.5 μm, instead of the silicon-carbon composite film, over the surface of the multi-layer photosensitive layer.

The electrophotosensitive materials of the above examples were subjected to the same photosensitivity test (II), durability test (II) and solvent resistance test as the above and were evaluated for the characteristics thereof. The results as well as those of Comparative Examples 1-12, 1-13 are listed in Table 17.

TABLE 17

| | | | | Initial | | | After durability test | | | |
|---|---|---|---|---|---|---|---|---|---|---|
| | | | | | | HLE | | | HLE | |
| | | P-H | | SP | RP | E_{1/2} | SP | RP | E_{1/2} | |
| | SPL | TM | NQC | V₀(V) | Vr(V) | (μJ/cm²) | V₀(V) | Vr(V) | (μJ/cm²) | SRT |
| Ex. 3-63 | a-C | HT-1 | 2-1-5 | −794 | −165 | 1.181 | −782 | −173 | 1.238 | ∘ |
| Ex. 3-64 | a-C | HT-1 | 2-2-4 | −785 | −165 | 1.181 | −791 | −157 | 1.144 | ∘ |
| Ex. 3-65 | a-C | HT-1 | 2-2-9 | −782 | −167 | 1.182 | −780 | −165 | 1.168 | ∘ |
| Ex. 3-66 | a-C | HT-1 | 2-3-1 | −806 | −159 | 1.137 | −798 | −151 | 1.115 | ∘ |
| Ex. 3-67 | a-C | HT-1 | 2-3-3 | −814 | −162 | 1.158 | −802 | −164 | 1.172 | ∘ |
| Ex. 3-68 | a-C | HT-1 | 2-3-8 | −804 | −166 | 1.170 | −812 | −158 | 1.144 | ∘ |
| Ex. 3-69 | a-C | HT-1 | 2-3-11 | −798 | −167 | 1.181 | −787 | −159 | 1.154 | ∘ |
| C. Ex. 1-12 | a-C | HT-1 | — | −785 | −172 | 1.216 | −748 | −198 | 1.400 | x |
| Ex. 3-70 | a-C | HT-3 | 2-1-5 | −801 | −137 | 1.067 | −782 | −147 | 1.145 | ∘ |
| Ex. 3-71 | a-C | HT-3 | 2-2-4 | −806 | −137 | 1.067 | −801 | −135 | 1.051 | ∘ |
| Ex. 3-72 | a-C | HT-3 | 2-2-9 | −817 | −132 | 1.066 | −814 | −137 | 1.106 | ∘ |
| Ex. 3-73 | a-C | HT-3 | 2-3-1 | −814 | −132 | 1.026 | −817 | −127 | 0.997 | ∘ |
| Ex. 3-74 | a-C | HT-3 | 2-3-3 | −817 | −135 | 1.046 | −810 | −137 | 1.061 | ∘ |
| Ex. 3-75 | a-C | HT-3 | 2-3-8 | −804 | −141 | 1.056 | −795 | −136 | 1.039 | ∘ |
| Ex. 3-76 | a-C | HT-3 | 2-3-11 | −798 | −132 | 1.067 | −804 | −138 | 1.088 | ∘ |
| C. Ex. 1-13 | a-C | HT-3 | — | −817 | −146 | 1.098 | −771 | −178 | 1.339 | x |

It was confirmed from the table that if the type of the surface protective layer was changed, the same results as the above were obtained according to the compositions of the charge transport layer of the multi-layer photosensitive layer as the base.

According to the results of the solvent resistance test listed in the table, all the electrophotosensitive materials of Examples 3-63 to 3-76 suffered no cracks nor delamination of the surface protective layer. It was thus concluded that the use of the naphthoquinone compounds of the formulas (2-1) to (2-3) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

### Examples 3-77 to 3-80

Electrophotosensitive materials of these examples were fabricated the same way as in Examples 3-56, 3-58, 3-60 and 3-61 except that the same procedure as in Examples 1-25, 1-26 was taken to form a surface protective layer of amorphous silicon-nitrogen (SiN) composite film having a thickness of 0.5 μm, instead of the silicon-carbon composite film, over the surface of the multi-layer photosensitive layer.

### Examples 3-81 to 3-84

Electrophotosensitive materials of these examples were fabricated the same way as in Examples 3-56, 3-58, 3-60 and 3-61 except that the same procedure as in Examples 1-27, 1-28 was taken to form a surface protective layer of amorphous carbon-nitrogen (CN) composite film having a thickness of 0.5 μm, instead of the silicon-carbon composite film, over the surface of the multi-layer photosensitive layer.

### Examples 3-85 to 3-88

Electrophotosensitive materials of these examples were fabricated the same way as in Examples 3-56, 3-58, 3-60 and 3-61 except that the same procedure as in Examples 1-29, 1-30 was taken to form a surface protective layer of amorphous carbon-boron (CB) composite film having a thickness of 0.5 μm, instead of the silicon-carbon composite film, over the surface of the multi-layer photosensitive layer.

### Examples 3-89 to 3-92

Electrophotosensitive materials of these examples were fabricated the same way as in Examples 3-56, 3-58, 3-60 and 3-61 except that the same procedure as in Examples 1-31, 1-32 was taken to form a surface protective layer of amorphous carbon-fluorine (CF) composite film having a thickness of 0.5 μm, instead of the silicon-carbon composite film, over the surface of the multi-layer photosensitive layer.

Examples 3-93 to 3-96

Electrophotosensitive materials of these examples were fabricated the same way as in Examples 3-56, 3-58, 3-60 and 3-61 except that the same procedure as in Examples 1-33, 1-34 was taken to form a surface protective layer of amorphous boron-nitrogen (BN) composite film having a thickness of 0.5 μm, instead of the silicon-carbon composite film, over the surface of the multi-layer photosensitive layer.

The electrophotosensitive materials of the above examples were subjected to the same photosensitivity test (II), durability test (II) and solvent resistance test as the above and were evaluated for the characteristics thereof. The results as well as those of Comparative Examples 1-14 to 1-18 are listed in Tables 18a, 18b.

TABLE 18

| | | | | Initial | | | After durability test | | | |
|---|---|---|---|---|---|---|---|---|---|---|
| | | | | | | HLE | | | HLE | |
| | | P-H | | SP | RP | E_{1/2} | SP | RP | E_{1/2} | |
| | SPL | TM | NQC | V₀(V) | Vr(V) | (μJ/cm²) | V₀(V) | Vr(V) | (μJ/cm²) | SRT |
| Ex. 3-77 | a-SiN | HT-3 | 2-1-5 | −812 | −133 | 1.086 | −806 | −148 | 1.208 | ∘ |
| Ex. 3-78 | a-SiN | HT-3 | 2-2-9 | −788 | −124 | 1.054 | −792 | −128 | 1.078 | ∘ |
| Ex. 3-79 | a-SiN | HT-3 | 2-3-3 | −798 | −128 | 1.064 | −814 | −133 | 1.089 | ∘ |
| Ex. 3-80 | a-SiN | HT-3 | 2-3-8 | −783 | −134 | 1.054 | −796 | −132 | 1.038 | ∘ |
| C. Ex. 1-14 | a-SiN | HT-3 | — | −785 | −139 | 1.095 | −758 | −186 | 1.367 | Δ |
| Ex. 3-81 | a-CN | HT-3 | 2-1-5 | −790 | −138 | 1.146 | −796 | −154 | 1.279 | ∘ |
| Ex. 3-82 | a-CN | HT-3 | 2-2-9 | −801 | −155 | 0.903 | −809 | −157 | 0.913 | ∘ |
| Ex. 3-83 | a-CN | HT-3 | 2-3-3 | −798 | −136 | 1.134 | −814 | −141 | 1.156 | ∘ |
| Ex. 3-84 | a-CN | HT-3 | 2-3-8 | −809 | −154 | 0.902 | −796 | −149 | 0.896 | ∘ |
| C. Ex. 1-15 | a-CN | HT-3 | — | −793 | −146 | 1.156 | −762 | −177 | 1.381 | x |
| Ex. 3-85 | a-CB | HT-3 | 2-1-5 | −788 | −133 | 0.969 | −783 | −147 | 1.071 | ∘ |
| Ex. 3-86 | a-CB | HT-3 | 2-2-9 | −790 | −129 | 0.951 | −802 | −124 | 0.924 | ∘ |
| Ex. 3-87 | a-CB | HT-3 | 2-3-3 | −817 | −131 | 0.951 | −814 | −126 | 0.935 | ∘ |
| Ex. 3-88 | a-CB | HT-3 | 2-3-8 | −788 | −126 | 0.951 | −780 | −122 | 0.924 | ∘ |
| C. Ex. 1-16 | a-CB | HT-3 | — | −793 | −137 | 0.979 | −746 | −167 | 1.193 | x |
| Ex. 3-89 | a-CF | HT-3 | 2-1-5 | −809 | −135 | 1.011 | −783 | −148 | 1.108 | ∘ |
| Ex. 3-90 | a-CF | HT-3 | 2-2-9 | −804 | −135 | 0.992 | −798 | −125 | 0.979 | ∘ |
| Ex. 3-91 | a-CF | HT-3 | 2-3-3 | −801 | −134 | 0.982 | −796 | −132 | 0.967 | ∘ |
| Ex. 3-92 | a-CF | HT-3 | 2-3-8 | −802 | −130 | 0.992 | −793 | −128 | 0.977 | ∘ |
| C. Ex. 1-17 | a-CF | HT-3 | — | −793 | −139 | 1.021 | −766 | −178 | 1.307 | x |
| Ex. 3-93 | a-BN | HT-3 | 2-1-5 | −804 | −106 | 0.895 | −790 | −114 | 0.963 | ∘ |
| Ex. 3-94 | a-BN | HT-3 | 2-2-9 | −793 | −102 | 0.862 | −806 | −104 | 0.879 | ∘ |
| Ex. 3-95 | a-BN | HT-3 | 2-3-3 | −812 | −110 | 0.870 | −806 | −108 | 0.854 | ∘ |
| Ex. 3-96 | a-BN | HT-3 | 2-3-8 | −817 | −112 | 0.861 | −813 | −109 | 0.838 | ∘ |
| C. Ex. 1-18 | a-BN | HT-3 | — | −780 | −117 | 0.904 | −748 | −146 | 1.128 | x |

It was confirmed from the tables that if the type of the surface protective layer was further changed, the same results as the above were obtained according to the compositions of the charge transport layer of the multi-layer photosensitive layer as the base.

According to the results of the solvent resistance test listed in the table, all the electrophotosensitive materials of Examples 3-77 to 3-96 suffered no cracks nor delamination of the surface protective layer. It was thus concluded that the use of the naphthoquinone compounds of the formulas (2-1) to (2-3) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

Single-layer Electrophotosensitive Material

### Examples 4-1 to 4-4

Electrophotosensitive materials of Examples 4-1 to 4-4 were fabricated the same way as in Example 1-1 except that each of the examples used 40 parts by weight of diindenopyrazine compound of the formula of a number listed in Table 19.

### Examples 4-5 to 4-8

Electrophotosensitive materials of Examples 4-5 to 4-8 were fabricated the same way as in Example 1-7 except that each of the examples used 40 parts by weight of diindenopyrazine compound of the formula of a number listed in Table 19.

The electrophotosensitive materials of the above examples were subjected to the same photosensitivity test (I), durability test (I) and solvent resistance test as the above and were evaluated for the characteristics thereof. The results as well as those of Comparative Examples 1-1, 1-2 are listed in Table 19.

TABLE 19

| | | | | Initial | | | After durability test | | | |
|---|---|---|---|---|---|---|---|---|---|---|
| | | | | | | HLE | | | HLE | |
| | | P-H | | SP | RP | E_{1/2} | SP | RP | E_{1/2} | |
| | SPL | TM | DIP | V₀(V) | Vr(V) | (μJ/cm²) | V₀(V) | Vr(V) | (μJ/cm²) | SRT |
| Ex. 4-1 | a-SiC | HT-1 | 2-4-1 | 817 | 191 | 1.328 | 805 | 186 | 1.293 | ∘ |
| Ex. 4-2 | a-SiC | HT-1 | 2-4-3 | 797 | 188 | 1.364 | 806 | 186 | 1.349 | ∘ |
| Ex. 4-3 | a-SiC | HT-1 | 2-5-2 | 809 | 175 | 1.282 | 801 | 173 | 1.276 | ∘ |
| Ex. 4-4 | a-SiC | HT-1 | 2-5-3 | 796 | 193 | 1.340 | 804 | 188 | 1.305 | ∘ |
| C. Ex. 1-1 | a-SiC | HT-1 | — | 817 | 205 | 1.500 | 745 | 244 | 1.785 | x |
| Ex. 4-5 | a-SiC | HT-3 | 2-4-1 | 812 | 215 | 1.476 | 798 | 212 | 1.455 | ∘ |
| Ex. 4-6 | a-SiC | HT-3 | 2-4-3 | 806 | 220 | 1.529 | 803 | 216 | 1.501 | ∘ |
| Ex. 4-7 | a-SiC | HT-3 | 2-5-2 | 796 | 200 | 1.437 | 808 | 202 | 1.451 | ∘ |
| Ex. 4-8 | a-SiC | HT-3 | 2-5-3 | 796 | 220 | 1.516 | 798 | 218 | 1.502 | ∘ |
| C. Ex. 1-2 | a-SiC | HT-3 | — | 804 | 232 | 1.667 | 748 | 252 | 1.810 | Δ |

DIP: Diindenopyradine compound

According to the results of the solvent resistance test listed in the table, all the electrophotosensitive materials of Examples 4-1 to 4-8 suffered no cracks nor delamination of the surface protective layer. It was thus concluded that the use of the diindenopyrazine compounds of the formulas (2-4), (2-5) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

### Examples 4-9 to 4-16

Electrophotosensitive materials of Examples 4-9 to 4-16 were fabricated the same way as in Examples 4-1 to 4-8 except that the same procedure as in Examples 1-13to 1-24 was taken to form a surface protective layer of amorphous carbon (C) having a thickness of 0.5 μm, instead of the silicon-carbon composite film, over the surface of the single-layer photosensitive layer.

The electrophotosensitive materials of the above examples were subjected to the same photosensitivity test (I), durability test (I) and solvent resistance test as the above and were evaluated for the characteristics thereof. The results as well as those of Comparative Examples 1-3, 1-4 are listed in Table 20.

TABLE 20

| | | | | Initial | | | After durability test | | | |
|---|---|---|---|---|---|---|---|---|---|---|
| | | | | | | HLE | | | HLE | |
| | | P-H | | SP | RP | E_{1/2} | SP | RP | E_{1/2} | |
| | SPL | TM | DIP | V₀(V) | Vr(V) | (μJ/cm²) | V₀(V) | Vr(V) | (μJ/cm²) | SRT |
| Ex. 4-9 | a-C | HT-1 | 2-4-1 | 804 | 181 | 1.347 | 798 | 186 | 1.384 | ∘ |
| Ex. 4-10 | a-C | HT-1 | 2-4-3 | 780 | 187 | 1.409 | 785 | 182 | 1.371 | ∘ |
| Ex. 4-11 | a-C | HT-1 | 2-5-2 | 796 | 176 | 1.325 | 792 | 170 | 1.280 | ∘ |
| Ex. 4-12 | a-C | HT-1 | 2-5-3 | 793 | 189 | 1.384 | 799 | 190 | 1.391 | ∘ |
| C. Ex. 1-3 | a-C | HT-1 | — | 793 | 208 | 1.563 | 742 | 238 | 1.788 | x |
| Ex. 4-13 | a-C | HT-3 | 2-4-1 | 790 | 205 | 1.489 | 804 | 203 | 1.474 | ∘ |
| Ex. 4-14 | a-C | HT-3 | 2-4-3 | 796 | 194 | 1.516 | 785 | 191 | 1.493 | ∘ |
| Ex. 4-15 | a-C | HT-3 | 2-5-2 | 809 | 192 | 1.463 | 798 | 190 | 1.448 | ∘ |
| Ex. 4-16 | a-C | HT-3 | 2-5-3 | 796 | 198 | 1.588 | 801 | 203 | 1.628 | ∘ |
| C. Ex. 1-4 | a-C | HT-3 | — | 788 | 222 | 1.667 | 746 | 240 | 1.792 | x |

It was confirmed from the table that if the type of the surface protective layer was changed, the same results as the above were obtained according to the compositions of the single-layer photosensitive layer as the base.

According to the results of the solvent resistance test listed in the table, all the electrophotosensitive materials of Examples 4-9 to 4-16 suffered no cracks nor delamination of the surface protective layer. It was thus concluded that the use of the diindenopyrazine compounds of the formulas (2-4), (2-5) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

### Examples 4-17, 4-18

Electrophotosensitive materials of Examples 4-17, 4-18 were fabricated the same way as in Examples 4-5, 4-8 except that the same procedure as in Examples 1-25, 1-26 was taken to form a surface protective layer of amorphous silicon-nitrogen (SiN) composite film having a thickness of 0.5 μm, instead of the silicon-carbon composite film, over the surface of the single-layer photosensitive layer.

### Examples 4-19, 4-20

Electrophotosensitive materials of Examples 4-19, 4-20 were fabricated the same way as in Examples 4-5, 4-8 except that the same procedure as in Examples 1-27, 1-28 was taken to form a surface protective layer of amorphous carbon-nitrogen (CN) composite film having a thickness of 0.5 μm, instead of the silicon-carbon composite film, over the surface of the single-layer photosensitive layer.

### Examples 4-21, 4-22

Electrophotosensitive materials of Examples 4-21, 4-22 were fabricated the same way as in Examples 4-5, 4-8 except that the same procedure as in Examples 1-29, 1-30 was taken to form a surface protective layer of amorphous carbon-boron (CB) composite film having a thickness of 0.5 μm, instead of the silicon-carbon composite film, over the surface of the single-layer photosensitive layer.

### Examples 4-23, 4-24

Electrophotosensitive materials of Examples 4-23, 4-24 were fabricated the same way as in Examples 4-5, 4-8 except that the same procedure as in Examples 1-31, 1-32 was taken to form a surface protective layer of amorphous carbon-fluorine (CF) composite film having a thickness of 0.5 μm, instead of the silicon-carbon composite film, over the surface of the single-layer photosensitive layer.

### Examples 4-25, 4-26

Electrophotosensitive materials of Examples 4-25, 4-26 were fabricated the same way as in Examples 4-5, 4-8 except that the same procedure as in Examples 1-33, 1-34 was taken to form a surface protective layer of amorphous boron-nitrogen (BN) composite film having a thickness of 0.5 μm, instead of the silicon-carbon composite film, over the surface of the single-layer photosensitive layer.

The electrophotosensitive materials of the above examples were subjected to the same photosensitivity test (I), durabilitytest (I) and solvent resistance test as the above and were evaluated for the characteristics thereof. The results as well as those of Comparative Examples 1-5 to 1-9 are listed in Table 21.

TABLE 21

| | | | | Initial | | | After durability test | | | |
|---|---|---|---|---|---|---|---|---|---|---|
| | | | | | | HLE | | | HLE | |
| | | P-H | | SP | RP | E½ | SP | RP | E½ | |
| | SPL | TM | DIP | V₀(V) | Vr(V) | (μJ/cm²) | V₀(V) | Vr(V) | (μJ/cm²) | SRT |
| Ex. 4-17 | a-SiN | HT-3 | 2-4-1 | 801 | 223 | 1.610 | 809 | 225 | 1.624 | ∘ |
| Ex. 4-18 | a-SiN | HT-3 | 2-5-3 | 785 | 216 | 1.582 | 788 | 219 | 1.604 | ∘ |
| C. Ex. 1-5 | a-SiN | HT-3 | — | 812 | 245 | 1.787 | 749 | 263 | 1.918 | Δ |
| Ex. 4-19 | a-CN | HT-3 | 2-4-1 | 809 | 227 | 1.675 | 801 | 225 | 1.660 | ∘ |
| Ex. 4-20 | a-CN | HT-3 | 2-5-3 | 812 | 226 | 1.645 | 803 | 228 | 1.660 | ∘ |
| C. Ex. 1-6 | a-CN | HT-3 | — | 790 | 252 | 1.875 | 752 | 270 | 2.009 | Δ |
| Ex. 4-21 | a-CB | HT-3 | 2-4-1 | 809 | 191 | 1.438 | 817 | 194 | 1.461 | ∘ |
| Ex. 4-22 | a-CB | HT-3 | 2-5-3 | 780 | 192 | 1.389 | 798 | 190 | 1.375 | ∘ |
| C. Ex. 1-7 | a-CB | HT-3 | — | 801 | 222 | 1.667 | 746 | 238 | 1.787 | x |
| Ex. 4-23 | a-CF | HT-3 | 2-4-1 | 801 | 212 | 1.559 | 798 | 209 | 1.537 | ∘ |
| Ex. 4-24 | a-CF | HT-3 | 2-5-3 | 806 | 208 | 1.531 | 801 | 208 | 1.511 | ∘ |
| C. Ex. 1-8 | a-CF | HT-3 | — | 788 | 232 | 1.745 | 734 | 248 | 1.865 | x |
| Ex. 4-25 | a-BN | HT-3 | 2-4-1 | 809 | 182 | 1.376 | 790 | 175 | 1.323 | ∘ |
| Ex. 4-26 | a-BN | HT-3 | 2-5-3 | 796 | 174 | 1.330 | 812 | 169 | 1.292 | ∘ |
| C. Ex. 1-9 | a-BN | HT-3 | — | 785 | 203 | 1.595 | 752 | 233 | 1.831 | x |

It was confirmed from the table that if the type of the surface protective layer was further changed, the same results as the above were obtained according to the compositions of the single-layer photosensitive layer as the base.

According to the results of the solvent resistance test listed in the table, all the electrophotosensitive materials of Examples 4-17 to 4-26 suffered no cracks nor delamination of the surface protective layer. It was thus concluded that the use of the diindenopyrazine compounds of the formulas (2-4), (2-5) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

Multi-layer Electrophotosensitive Material

### Examples 4-27 to 4-30

Electrophotosensitive materials of Examples 4-27 to 4-30 were fabricated the same way as in Example 1-35 except that each of the examples used 0.2 parts by weight of diindenopyrazine compound of the formula of a number listed in Table 22.

### Examples 4-31 to 4-34

Electrophotosensitive materials of Examples 4-31 to 4-34 were fabricated the same way as in Example 1-41 except that each of the examples used 40 parts by weight of diindenopyrazine compound of the formula of a number listed in Table 22.

The electrophotosensitive materials of the above examples were subjected to the same photosensitivity test (II), durability test (II) and solvent resistance test as the above and were evaluated for the characteristics thereof. The results as well as those of Comparative Examples 1-10, 1-11 are listed in Table 22.

TABLE 22

| | | | | Initial | | | After durability test | | | |
|---|---|---|---|---|---|---|---|---|---|---|
| | | | | | | HLE | | | HLE | |
| | | P-H | | SP | RP | E½ | SP | RP | E½ | |
| | SPL | TM | DIP | V₀(V) | Vr(V) | (μJ/cm²) | V₀(V) | Vr(V) | (μJ/cm²) | SRT |
| Ex. 4-27 | a-SiC | HT-1 | 2-4-1 | −806 | −147 | 0.830 | −798 | −142 | 0.811 | ∘ |
| Ex. 4-28 | a-SiC | HT-1 | 2-4-3 | −808 | −148 | 0.853 | −798 | −145 | 0.836 | ∘ |
| Ex. 4-29 | a-SiC | HT-1 | 2-5-2 | −807 | −132 | 0.802 | −804 | −131 | 0.796 | ∘ |
| Ex. 4-30 | a-SiC | HT-1 | 2-5-3 | −808 | −145 | 0.838 | −801 | −148 | 0.855 | ∘ |
| C. Ex. 1-10 | a-SiC | HT-1 | — | −806 | −165 | 0.938 | −782 | −192 | 1.052 | x |
| Ex. 4-31 | a-SiC | HT-3 | 2-4-1 | −792 | −124 | 0.915 | −798 | −127 | 0.937 | ∘ |
| Ex. 4-32 | a-SiC | HT-3 | 2-4-3 | −804 | −125 | 0.923 | −812 | −130 | 0.960 | ∘ |
| Ex. 4-33 | a-SiC | HT-3 | 2-5-2 | −814 | −123 | 0.869 | −812 | −125 | 0.883 | ∘ |
| Ex. 4-34 | a-SiC | HT-3 | 2-5-3 | −817 | −128 | 0.923 | −810 | −125 | 0.901 | ∘ |
| C. Ex. 1-11 | a-SiC | HT-3 | — | −814 | −147 | 1.024 | −776 | −176 | 1.226 | x |

It was confirmed from the table that if the single-layer photosensitive layer was replaced by the multi-layer photosensitive layer, the same results as the above were obtained according to the compositions of the charge transport layer defining the outermost part thereof.

According to the results of the solvent resistance test listed in the table, all the electrophotosensitive materials of Examples 4-27 to 4-34 suffered no cracks nor delamination of the surface protective layer. It was thus concluded that the use of the diindenopyrazine compounds of the formulas (2-4), (2-5) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

### Examples 4-35 to 4-42

Electrophotosensitive materials of these examples were fabricated the same way as in Examples 4-27 to 4-34 except that the same procedure as in Examples 1-13 to 1-24 was taken to form a surface protective layer of amorphous carbon (C) having a thickness of 0.5 μm, instead of the silicon-carbon composite film, over the surface of the multi-layer photosensitive layer.

The electrophotosensitive materials of the above examples were subjected to the same photosensitivity test (II), durability test (II) and solvent resistance test as the above and were evaluated for the characteristics thereof. The results as well as those of Comparative Examples 1-12, 1-13 are listed in Table 23.

TABLE 23

| | | | | Initial | | | After durability test | | | |
|---|---|---|---|---|---|---|---|---|---|---|
| | | | | | | HLE | | | HLE | |
| | | P-H | | SP | RP | E½ | SP | RP | E½ | |
| | SPL | TM | DIP | V₀(V) | Vr(V) | (μJ/cm²) | V₀(V) | Vr(V) | (μJ/cm²) | SRT |
| Ex. 4-35 | a-C | HT-1 | 2-4-1 | −814 | −152 | 1.086 | −806 | −148 | 1.057 | ∘ |
| Ex. 4-36 | a-C | HT-1 | 2-4-3 | −788 | −158 | 1.116 | −796 | −160 | 1.130 | ∘ |
| Ex. 4-37 | a-C | HT-1 | 2-5-2 | −802 | −150 | 1.058 | −814 | −148 | 1.044 | ∘ |
| Ex. 4-38 | a-C | HT-1 | 2-5-3 | −812 | −152 | 1.106 | −817 | −157 | 1.142 | ∘ |
| C. Ex. 1-12 | a-C | HT-1 | — | −785 | −172 | 1.216 | −748 | −198 | 1.400 | x |
| Ex. 4-39 | a-C | HT-3 | 2-4-1 | −785 | −130 | 0.990 | −788 | −128 | 0.975 | ∘ |
| Ex. 4-40 | a-C | HT-3 | 2-4-3 | −802 | −136 | 1.017 | −806 | −134 | 1.002 | ∘ |
| Ex. 4-41 | a-C | HT-3 | 2-5-2 | −798 | −122 | 0.947 | −806 | −126 | 0.978 | ∘ |
| Ex. 4-42 | a-C | HT-3 | 2-5-3 | −780 | −138 | 0.990 | −785 | −132 | 0.957 | ∘ |
| C. Ex. 1-13 | a-C | HT-3 | — | −817 | −146 | 1.098 | −771 | −178 | 1.339 | x |

It was confirmed from the table that if the type of the surface protective layer was changed, the same results as the above were obtained according to the compositions of the charge transport layer of the multi-layer photosensitive layer as the base.

According to the results of the solvent resistance test listed in the table, all the electrophotosensitive materials of Examples 4-35 to 4-42 suffered no cracks nor delamination of the surface protective layer. It was thus concluded that the use of the diindenopyrazine compounds of the formulas (2-4), (2-5) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

### Examples 4-43, 4-44

Electrophotosensitive materials of these examples were fabricated the same way as in Examples 4-31, 4-34 except that the same procedure as in Examples 1-25, 1-26 was taken to form a surface protective layer of amorphous silicon-nitrogen (SiN) composite film having a thickness of 0.5 μm, instead of the silicon-carbon composite film, over the surface of the multi-layer photosensitive layer.

### Examples 4-45, 4-46

Electrophotosensitive materials of these examples were fabricated the same way as in Examples 4-31, 4-34 except that the same procedure as in Examples 1-27, 1-28 was taken to form a surface protective layer of amorphous carbon-nitrogen (CN) composite film having a thickness of 0.5 μm, instead of the silicon-carbon composite film, over the surface of the multi-layer photosensitive layer.

### Examples 4-47, 4-48

Electrophotosensitive materials of these examples were fabricated the same way as in Examples 4-31, 4-34 except that the same procedure as in Examples 1-29, 1-30 was taken to form a surface protective layer of amorphous carbon-boron (CB) composite film having a thickness of 0.5 μm, instead of the silicon-carbon composite film, over the surface of the multi-layer photosensitive layer.

### Examples 4-49, 4-50

Electrophotosensitive materials of these examples were fabricated the same way as in Examples 4-31, 4-34 except that the same procedure as in Examples 1-31, 1-32 was taken to form a surface protective layer of amorphous carbon-fluorine (CF) composite film having a thickness of 0.5 μm, instead of the silicon-carbon composite film, over the surface of the multi-layer photosensitive layer.

### Examples 4-51, 4-52

Electrophotosensitive materials of these examples were fabricated the same way as in Examples 4-31, 4-34 except that the same procedure as in Examples 1-33, 1-34 was taken to form a surface protective layer of amorphous boron-nitrogen (BN) composite film having a thickness of 0.5 μm, instead of the silicon-carbon composite film, over the surface of the multi-layer photosensitive layer.

The electrophotosensitive materials of the above examples were subjected to the same photosensitivity test (II), durability test (II) and solvent resistance test as the above and were evaluated for the characteristics thereof. The results as well as those of Comparative Examples 1-14 to 1-18 are listed in Table 24.

TABLE 24

| | | | | Initial | | | After durability test | | | |
|---|---|---|---|---|---|---|---|---|---|---|
| | | | | | | HLE | | | HLE | |
| | | P-H | | SP | RP | E½ | SP | RP | E½ | |
| | SPL | TM | DIP | V₀(V) | Vr(V) | (μJ/cm²) | V₀(V) | Vr(V) | (μJ/cm²) | SRT |
| Ex. 4-43 | a-SiN | HT-3 | 2-4-1 | −802 | −132 | 0.987 | −812 | −130 | 0.972 | ∘ |
| Ex. 4-44 | a-SiN | HT-3 | 2-5-3 | −795 | −125 | 0.970 | −785 | −122 | 0.947 | ∘ |
| C. Ex. 1-14 | a-SiN | HT-3 | — | −785 | −149 | 1.095 | −758 | −186 | 1.367 | Δ |
| Ex. 4-45 | a-CN | HT-3 | 2-4-1 | −801 | −123 | 1.032 | −796 | −133 | 1.116 | ∘ |
| Ex. 4-46 | a-CN | HT-3 | 2-5-3 | −788 | −138 | 0.823 | −782 | −136 | 0.811 | ∘ |
| C. Ex. 1-15 | a-CN | HT-3 | — | −793 | −148 | 1.155 | −762 | −177 | 1.381 | x |
| Ex. 4-47 | a-CB | HT-3 | 2-4-1 | −814 | −111 | 0.845 | −805 | −109 | 0.830 | ∘ |
| Ex. 4-48 | a-CB | HT-3 | 2-5-3 | −806 | −112 | 0.816 | −804 | −110 | 0.801 | ∘ |
| C. Ex. 1-16 | a-CB | HT-3 | — | −793 | −137 | 0.979 | −746 | −167 | 1.193 | x |
| Ex. 4-49 | a-CF | HT-3 | 2-4-1 | −817 | −115 | 0.912 | −809 | −117 | 0.928 | ∘ |
| Ex. 4-50 | a-CF | HT-3 | 2-5-3 | −809 | −112 | 0.896 | −817 | −117 | 0.936 | ∘ |
| C. Ex. 1-17 | a-CF | HT-3 | — | −793 | −139 | 1.021 | −766 | −178 | 1.307 | x |
| Ex. 4-51 | a-BN | HT-3 | 2-4-1 | −789 | −98 | 0.790 | −796 | −101 | 0.804 | ∘ |
| Ex. 4-52 | a-BN | HT-3 | 2-5-3 | −790 | −96 | 0.753 | −782 | −98 | 0.769 | ∘ |
| C. Ex. 1-18 | a-BN | HT-3 | — | −780 | −117 | 0.904 | −748 | −146 | 1.128 | x |

It was confirmed from the table that if the type of the surface protective layer was further changed, the same results as the above were obtained according to the compositions of the charge transport layer of the multi-layer photosensitive layer as the base.

According to the results of the solvent resistance test listed in the table, all the electrophotosensitive materials of Examples 4-43 to 4-52 suffered no cracks nor delamination of the surface protective layer. It was thus concluded that the use of the diindenopyrazine compounds of the formulas (2-4), (2-5) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

Single-layer Electrophotosensitive Material

### Examples 5-1 to 5-4

Electrophotosensitive materials of Examples 5-1 to 5-4 were fabricated the same way as in Example 1-1 except that each of the examples used 40 parts by weight of dioxotetracenedione compound of the formula of a number listed in Table 25.

### Examples 5-5 to 5-8

Electrophotosensitive materials of Examples 5-5 to 5-8 were fabricated the same way as in Example 1-7 except that each of the examples used 40 parts by weight of dioxotetracenedione compound of the formula of a number listed in Table 25.

The electrophotosensitive materials of the above examples were subjected to the same photosensitivity test (I), durabilitytest (I) andsolvent resistancetest as the above and were evaluated for the characteristics thereof. The results as well as those of Comparative Examples 1-1, 1-2 are listed in Table 25.

TABLE 25

| | | | | Initial | | | After durability test | | | |
|---|---|---|---|---|---|---|---|---|---|---|
| | | | | | | HLE | | | HLE | |
| | | P-H | | SP | RP | E½ | SP | RP | E½ | |
| | SPL | TM | DOT | V₀(V) | Vr(V) | (μJ/cm²) | V₀(V) | Vr(V) | (μJ/cm²) | SRT |
| Ex. 5-1 | a-SiC | HT-1 | 2-6-3 | 798 | 186 | 1.364 | 788 | 188 | 1.379 | ∘ |
| Ex. 5-2 | a-SiC | HT-1 | 2-6-6 | 780 | 199 | 1.390 | 790 | 193 | 1.348 | ∘ |
| Ex. 5-3 | a-SiC | HT-1 | 2-6-8 | 780 | 188 | 1.340 | 785 | 184 | 1.311 | ∘ |
| Ex. 5-4 | a-SiC | HT-1 | 2-6-11 | 817 | 178 | 1.315 | 806 | 185 | 1.356 | ∘ |
| C. Ex. 1-1 | a-SiC | HT-1 | — | 817 | 205 | 1.500 | 745 | 244 | 1.785 | x |
| Ex. 5-5 | a-SiC | HT-3 | 2-6-3 | 793 | 216 | 1.503 | 802 | 214 | 1.489 | ∘ |
| Ex. 5-6 | a-SiC | HT-3 | 2-6-6 | 788 | 217 | 1.530 | 796 | 220 | 1.551 | ∘ |
| Ex. 5-7 | a-SiC | HT-3 | 2-6-8 | 785 | 215 | 1.476 | 782 | 212 | 1.455 | ∘ |
| Ex. 5-8 | a-SiC | HT-3 | 2-6-11 | 817 | 211 | 1.462 | 807 | 209 | 1.448 | ∘ |
| C. Ex. 1-2 | a-SiC | HT-3 | — | 804 | 232 | 1.667 | 748 | 252 | 1.810 | Δ |

DOT: Dioxotetracenedione compound

According to the results of the solvent resistance test listed in the table, all the electrophotosensitive materials of Examples 5-1 to 5-8 suffered no cracks nor delamination of the surface protective layer. It was thus concluded that the use of the dioxotetracenedione compound of the formula (2-6) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

### Examples 5-9 to 5-16

Electrophotosensitive materials of Examples 5-9 to 5-16 were fabricated the same way as in Examples 5-1 to 5-8 except that the same procedure as in Examples 1-13 to 1-24 was taken to form a surface protective layer of amorphous carbon (C) having a thickness of 0.5 μm, instead of the silicon-carbon composite film, over the surface of the single-layer photosensitive layer.

The electrophotosensitive materials of the above examples were subjected to the same photosensitivity test (I), durabilitytest (I) andsolvent resistancetest as the above and were evaluated for the characteristics thereof. The results as well as those of Comparative Examples 1-3, 1-4 are listed in Table 26.

TABLE 26

| | | | | Initial | | | After durability test | | | |
|---|---|---|---|---|---|---|---|---|---|---|
| | | | | | | HLE | | | HLE | |
| | | P-H | | SP | RP | E½ | SP | RP | E½ | |
| | SPL | TM | DOT | V₀(V) | Vr(V) | (μJ/cm²) | V₀(V) | Vr(V) | (μJ/cm²) | SRT |
| Ex. 5-9 | a-C | HT-1 | 2-6-3 | 817 | 195 | 1.435 | 809 | 193 | 1.420 | ∘ |
| Ex. 5-10 | a-C | HT-1 | 2-6-6 | 798 | 199 | 1.461 | 804 | 193 | 1.417 | ∘ |
| Ex. 5-11 | a-C | HT-1 | 2-6-8 | 801 | 187 | 1.408 | 809 | 189 | 1.423 | ∘ |
| Ex. 5-12 | a-C | HT-1 | 2-6-11 | 803 | 193 | 1.396 | 809 | 195 | 1.410 | ∘ |
| C. Ex. 1-3 | a-C | HT-1 | — | 793 | 208 | 1.563 | 742 | 238 | 1.788 | x |
| Ex. 5-13 | a-C | HT-3 | 2-6-3 | 814 | 215 | 1.583 | 804 | 210 | 1.536 | ∘ |
| Ex. 5-14 | a-C | HT-3 | 2-6-6 | 809 | 194 | 1.544 | 801 | 192 | 1.528 | ∘ |
| Ex. 5-15 | a-C | HT-3 | 2-6-8 | 780 | 185 | 1.489 | 788 | 190 | 1.529 | ∘ |
| Ex. 5-16 | a-C | HT-3 | 2-6-11 | 793 | 191 | 1.502 | 801 | 194 | 1.526 | ∘ |
| C. Ex. 1-4 | a-C | HT-3 | — | 788 | 222 | 1.667 | 746 | 240 | 1.792 | x |

It was confirmed from the table that if the type of the surface protective layer was changed, the same results as the above were obtained according to the compositions of the single-layer photosensitive layer as the base.

According to the results of the solvent resistance test listed in the table, all the electrophotosensitive materials of Examples 5-9 to 5-16 suffered no cracks nor delamination of the surface protective layer. It was thus concluded that the use of the dioxotetracenedione compound of the formula (2-6) contributed the improvement of the physical stability of the inorganic surface protective layer.

It was also confirmed that all the electrophotosensLtive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

### Examples 5-17, 5-18

Electrophotosensitive materials of Examples 5-17, 5-18 were fabricated the same way as in Examples 5-5, 5-7 except that the same procedure as in Examples 1-25, 1-26 was taken to form a surface protective layer of amorphous silicon-nitrogen (SiN) composite film having a thickness of 0.5 μm, instead of the silicon-carbon composite film, over the surface of the single-layer photosensitive layer.

### Examples 5-19, 5-20

Electrophotosensitive materials of Examples 5-19, 5-20 were fabricated the same way as in Examples 5-5, 5-7 except that the same procedure as in Examples 1-27, 1-28 was taken to form a surface protective layer of amorphous carbon-nitrogen (CN) composite film having a thickness of 0.5 μm, instead of the silicon-carbon composite film, over the surface of the single-layer photosensitive layer.

### Examples 5-21, 5-22

Electrophotosensitive materials of Examples 5-21, 5-22 were fabricated the same way as in Examples 5-5, 5-7 except that the same procedure as in Examples 1-29, 1-30 was taken to form a surface protective layer of amorphous carbon-boron (CB) composite film having a thickness of 0.5 μm, instead of the silicon-carbon composite film, over the surface of the single-layer photosensitive layer.

### Examples 5-23, 5-24

Electrophotosensitive materials of Examples 5-23, 5-24 were fabricated the same way as in Examples 5-5, 5-7 except that the same procedure as in ExampLes 1-31, 1-32 was taken to form a surface protective layer of amorphous carbon-fluorine (CF) composite film having a thickness of 0.5 μm, instead of the silicon-carbon composite film, over the surface of the single-layer photosensitive layer.

### Examples 5-25, 5-26

Electrophotosensitive materials of Examples 5-25, 5-26 were fabricated the same way as in Examples 5-5, 5-7 except that the same procedure as in Examples 1-33, 1-34 was taken to form a surface protective layer of amorphous boron-nitrogen (BN) composite film having a thickness of 0.5 μm, instead of the silicon-carbon composite film, over the surface of the single-layer photosensitive layer.

The electrophotosensitive materials of the above examples were subjected to the same photosensitivity test (I),durability test (I) and solvent resistance test as the above and were evaluated for the characteristics thereof. The results as well as those of Comparative Examples 1-5 to 1-9 are listed in Table 27.

TABLE 27

| | | | | Initial | | | After durability test | | | |
|---|---|---|---|---|---|---|---|---|---|---|
| | | | | | | HLE | | | HLE | |
| | | P-H | | SP | RP | E½ | SP | RP | E½ | |
| | SPL | TM | DOT | V₀(V) | Vr(V) | (μJ/cm²) | V₀(V) | Vr(V) | (μJ/cm²) | SRT |
| Ex. 5-17 | a-SiN | HT-3 | 2-6-3 | 817 | 233 | 1.670 | 817 | 231 | 1.656 | ∘ |
| Ex. 5-18 | a-SiN | HT-3 | 2-6-8 | 798 | 222 | 1.625 | 802 | 225 | 1.647 | ∘ |
| C. Ex. 1-5 | a-SiN | HT-3 | — | 812 | 245 | 1.787 | 749 | 263 | 1.918 | Δ |
| Ex. 5-19 | a-CN | HT-3 | 2-6-3 | 806 | 238 | 1.737 | 809 | 236 | 1.722 | ∘ |
| Ex. 5-20 | a-CN | HT-3 | 2-6-8 | 808 | 234 | 1.690 | 817 | 228 | 1.647 | ∘ |
| C. Ex. 1-6 | a-CN | HT-3 | — | 790 | 252 | 1.875 | 752 | 270 | 2.009 | Δ |
| Ex. 5-21 | a-CB | HT-3 | 2-6-3 | 786 | 197 | 1.463 | 796 | 202 | 1.501 | ∘ |
| Ex. 5-22 | a-CB | HT-3 | 2-6-8 | 791 | 196 | 1.437 | 798 | 201 | 1.474 | ∘ |
| C. Ex. 1-7 | a-CB | HT-3 | — | 801 | 222 | 1.667 | 746 | 238 | 1.787 | x |
| Ex. 5-23 | a-CF | HT-3 | 2-6-3 | 803 | 224 | 1.647 | 812 | 228 | 1.676 | ∘ |
| Ex. 5-24 | a-CF | HT-3 | 2-6-8 | 788 | 216 | 1.572 | 780 | 219 | 1.594 | ∘ |
| C. Ex. 1-8 | a-CF | HT-3 | — | 788 | 232 | 1.745 | 734 | 248 | 1.865 | x |
| Ex. 5-25 | a-BN | HT-3 | 2-6-3 | 806 | 184 | 1.450 | 817 | 189 | 1.489 | ∘ |
| Ex. 5-26 | a-BN | HT-3 | 2-6-8 | 788 | 188 | 1.401 | 793 | 185 | 1.379 | ∘ |
| C. Ex. 1-9 | a-BN | HT-3 | — | 785 | 203 | 1.595 | 752 | 233 | 1.831 | x |

It was confirmed from the table that if the type of the surface protective layer was further changed, the same results as the above were obtained according to the compositions of the single-layer photosensitive layer as the base.

According to the results of the solvent resistance test listed in the table, all the electrophotosensitive materials of Examples 5-17 to 5-26 suffered no cracks nor delamination of the surface protective layer. It was thus concluded that the use of the dioxotetracenedione compound of the formula (2-6) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

Multi-layer Electrophotosensitive Material

### Examples 5-27 to 5-30

Electrophotosensitive materials of Examples 5-27 to 5-30 were fabricated the same way as in Example 1-35 except that each of the examples used 0.2 parts by weight of dioxotetracenedione compound of the formula of a number listed in Table 28.

### Examples 5-31 to 5-34

Electrophotosensitive materials of Examples 5-31 to 5-34 were fabricated the same way as in Example 1-41 except that each of the examples used 40 parts by weight of dioxotetracenedione compound of the formula of a number listed in Table 28.

The electrophotosensitive materials of the above examples were subjected to the same photosensitivity test (II), durability test (II) and solvent resistance test as the above and were evaluated for the characteristics thereof. The results as well as those of Comparative Examples 1-10, 1-11 are listed in Table 28.

TABLE 28

| | | | | Initial | | | After durability test | | | |
|---|---|---|---|---|---|---|---|---|---|---|
| | | | | | | HLE | | | HLE | |
| | | P-H | | SP | RP | E½ | SP | RP | E½ | |
| | SPL | TM | DOT | V₀(V) | Vr(V) | (μJ/cm²) | V₀(V) | Vr(V) | (μJ/cm²) | SRT |
| Ex. 5-27 | a-SiC | HT-1 | 2-6-3 | −796 | −144 | 0.861 | −792 | −147 | 0.879 | ∘ |
| Ex. 5-28 | a-SiC | HT-1 | 2-6-6 | −795 | −145 | 0.877 | −802 | −152 | 0.919 | ∘ |
| Ex. 5-29 | a-SiC | HT-1 | 2-6-8 | −812 | −149 | 0.846 | −809 | −144 | 0.818 | ∘ |
| Ex. 5-30 | a-SiC | HT-1 | 2-6-11 | −793 | −139 | 0.830 | −790 | −147 | 0.878 | ∘ |
| C. Ex. | a-SiC | HT-1 | — | −806 | −165 | 0.938 | −782 | −192 | 1.052 | x |
| 1-10 | | | | | | | | | | |
| Ex. 5-31 | a-SiC | HT-3 | 2-6-3 | −817 | −132 | 0.948 | −808 | −137 | 0.984 | ∘ |
| Ex. 5-32 | a-SiC | HT-3 | 2-6-6 | −814 | −133 | 0.967 | −804 | −134 | 0.982 | ∘ |
| Ex. 5-33 | a-SiC | HT-3 | 2-6-8 | −812 | −124 | 0.931 | −810 | −126 | 0.946 | ∘ |
| Ex. 5-34 | a-SiC | HT-3 | 2-6-11 | −798 | −125 | 0.923 | −792 | −128 | 0.945 | ∘ |
| C. Ex. | a-SiC | HT-3 | — | −814 | −147 | 1.024 | −776 | −176 | 1.226 | x |
| 1-11 | | | | | | | | | | |

It was confirmed from the table that if the single-layer photosensitive layer was replaced by the multi-layer photosensitive layer, the same results as the above were obtained according to the compositions of the charge transport layer defining the outermost part thereof.

According to the results of the solvent resistance test listed in the table, all the electrophotosensitive materials of Examples 5-27 to 5-34 suffered no cracks nor delamination of the surface protective layer. It was thus concluded that the use of the dioxotetracenedione compound of the formula (2-6) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

### Examples 5-35 to 5-42

Electrophotosensitive materials of these examples were fabricated the same way as in Examples 5-27 to 5-34 except that the same procedure as in Examples 1-13 to 1-24 was taken to form a surface protective layer of amorphous carbon (C) having a thickness of 0.5 μm, instead of the silicon-carbon composite film, over the surface of the multi-layer photosensitive layer.

The electrophotosensitive materials of the above examples were subjected to the same photosensitivity test (II), durability test (II) and solvent resistance test as the above and were evaluated for the characteristics thereof. The results as well as those of Comparative Examples 1-12, 1-13 are listed in Table 29.

TABLE 29

| | | | | Initial | | | After durability test | | | |
|---|---|---|---|---|---|---|---|---|---|---|
| | | | | | | HLE | | | HLE | |
| | | P-H | | SP | RP | E½ | SP | RP | E½ | |
| | SPL | TM | DOT | V₀(V) | Vr(V) | (μJ/cm²) | V₀(V) | Vr(V) | (μJ/cm²) | SRT |
| Ex. 5-35 | a-C | HT-1 | 2-6-3 | −788 | −151 | 1.137 | −796 | −155 | 1.167 | ∘ |
| Ex. 5-36 | a-C | HT-1 | 2-6-6 | −790 | −161 | 1.137 | −798 | −158 | 1.116 | ∘ |
| Ex. 5-37 | a-C | HT-1 | 2-6-8 | −796 | −151 | 1.116 | −786 | −156 | 1.153 | ∘ |
| Ex. 5-38 | a-C | HT-1 | 2-6-11 | −790 | −157 | 1.106 | −788 | −154 | 1.085 | ∘ |
| C. Ex. | a-C | HT-1 | — | −785 | −172 | 1.216 | −748 | −198 | 1.400 | x |
| 1-12 | | | | | | | | | | |
| Ex. 5-39 | a-C | HT-3 | 2-6-3 | −801 | −136 | 1.017 | −809 | −133 | 0.995 | ∘ |
| Ex. 5-40 | a-C | HT-3 | 2-6-6 | −809 | −136 | 1.017 | −806 | −134 | 1.002 | ∘ |
| Ex. 5-41 | a-C | HT-3 | 2-6-8 | −790 | −126 | 0.998 | −788 | −130 | 1.030 | ∘ |
| Ex. 5-42 | a-C | HT-3 | 2-6-11 | −798 | −128 | 0.998 | −804 | −126 | 0.982 | ∘ |
| C. Ex. | a-C | HT-3 | — | −817 | −146 | 1.098 | −771 | −178 | 1.339 | x |
| 1-13 | | | | | | | | | | |

It was confirmed from the table that if the type of the surface protective layer was changed, the same results as the above were obtained according to the compositions of the charge transport layer of the multi-layer photosensitive layer as the base.

According to the results of the solvent resistance test listed in the table, all the electrophotosensitive materials of Examples 5-35 to 5-42 suffered no cracks nor delamination of the surface protective layer. It was thus concluded that the use of the dioxotetracenedione compound of the formula (2-6) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

### Examples 5-43, 5-44

Electrophotosensitive materials of these examples were fabricated the same way as in Examples 5-31, 5-33 except that the same procedure as in Examples 1-25, 1-26 was taken to form a surface protective layer of amorphous silicon-nitrogen (SiN) composite film having a thickness of 0.5 μm, instead of the silicon-carbon composite film, over the surface of the multi-layer photosensitive layer.

### Examples 5-45, 5-46

Electrophotosensitive materials of these examples were fabricated the same way as in Examples 5-31, 5-33 except that the same procedure as in Examples 1-27, 1-28 was taken to form a surface protective layer of amorphous carbon-nitrogen (CN) composite film having a thickness of 0.5 μm, instead of the silicon-carbon composite film, over the surface of the multi-layer photosensitive layer.

### Examples 5-47, 5-48

Electrophotosensitive materials of these examples were fabricated the same way as in Examples 5-31, 5-33 except that the same procedure as in Examples 1-29, 1-30 was taken to form a surface protective layer of amorphous carbon-boron (CB) composite film having a thickness of 0.5 μm, instead of the silicon-carbon composite film, over the surface of the multi-layer photosensitive layer.

### Examples 5-49, 5-50

Electrophotosensitive materials of these examples were fabricated the same way as in Examples 5-31, 5-33 except that the same procedure as in Examples 1-31, 1-32 was taken to form a surface protective layer of amorphous carbon-fluorine (CF) composite film having a thickness of 0.5 μm, instead of the silicon-carbon composite film, over the surface of the multi-layer photosensitive layer.

### Examples 5-51, 5-52

Electrophotosensitive materials of these examples were fabricated the same way as in Examples 5-31, 5-33 except that the same procedure as in Examples 1-33, 1-34 was taken to form a surface protective layer of amorphous boron-nitrogen (BN) composite film having a thickness of 0.5 μm, instead of the silicon-carbon composite film, over the surface of the multi-layer photosensitive layer.

The electrophotosensitive materials of the above examples were subjected to the same photosensitivity test (II), durability test (II) and solvent resistance test as the above and were evaluated for the characteristics thereof. The results as well as those of Comparative Examples 1-14 to 1-18 are listed in Table 30.

TABLE 30

| | | | | Initial | | | After durability test | | | |
|---|---|---|---|---|---|---|---|---|---|---|
| | | | | | | HLE | | | HLE | |
| | | P-H | | SP | RP | E½ | SP | RP | E½ | |
| | SPL | TM | DOT | V₀(V) | Vr(V) | (μJ/cm²) | V₀(V) | Vr(V) | (μJ/cm²) | SRT |
| Ex. 5-43 | a-SiN | HT-3 | 2-6-3 | −785 | −133 | 1.015 | −782 | −136 | 1.038 | ∘ |
| Ex. 5-44 | a-SiN | HT-3 | 2-6-8 | −796 | −132 | 0.987 | −795 | −130 | 0.972 | ∘ |
| C. Ex. | a-SiN | HT-3 | — | −785 | −149 | 1.095 | −758 | −186 | 1.367 | Δ |
| 1-14 | | | | | | | | | | |
| Ex. 5-45 | a-CN | HT-3 | 2-6-3 | −796 | −129 | 1.061 | −804 | −131 | 1.077 | ∘ |
| Ex. 5-46 | a-CN | HT-3 | 2-6-8 | −806 | −138 | 0.838 | −812 | −136 | 0.826 | ∘ |
| C. Ex. | a-CN | HT-3 | — | −793 | −148 | 1.155 | −762 | −177 | 1.381 | x |
| 1-15 | | | | | | | | | | |
| Ex. 5-47 | a-CB | HT-3 | 2-6-3 | −809 | −118 | 0.874 | −806 | −115 | 0.852 | ∘ |
| Ex. 5-48 | a-CB | HT-3 | 2-6-8 | −801 | −111 | 0.859 | −798 | −108 | 0.836 | ∘ |
| C. Ex. | a-CB | HT-3 | — | −793 | −137 | 0.979 | −746 | −167 | 1.193 | x |
| 1-16 | | | | | | | | | | |
| Ex. 5-49 | a-CF | HT-3 | 2-6-3 | −801 | −122 | 0.928 | −807 | −125 | 0.951 | ∘ |
| Ex. 5-50 | a-CF | HT-3 | 2-6-8 | −788 | −118 | 0.920 | −782 | −116 | 0.904 | ∘ |
| C. Ex. | a-CF | HT-3 | — | −793 | −139 | 1.021 | −766 | −178 | 1.307 | x |
| 1-17 | | | | | | | | | | |
| Ex. 5-51 | a-BN | HT-3 | 2-6-3 | −796 | −103 | 0.793 | −798 | −98 | 0.755 | ∘ |
| Ex. 5-52 | a-BN | HT-3 | 2-6-8 | −789 | −94 | 0.780 | −798 | −96 | 0.797 | ∘ |
| C. Ex. | a-BN | HT-3 | — | −780 | −117 | 0.904 | −748 | −146 | 1.128 | x |
| 1-18 | | | | | | | | | | |

It was confirmed from the table that if the type of the surface protective layer was further changed, the same results as the above were obtained according to the compositions of the charge transport layer of the multi-layer photosensitive layer as the base.

According to the results of the solvent resistance test listed in the table, all the electrophotosensitive materials of Examples 5-43 to 5-52 suffered no cracks nor delamination of the surface protective layer. It was thus concluded that the use of the dioxotetracenedione compound of the formula (2-6) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

Single-layer Electrophotosensitive Material

### Examples 6-1 to 6-4

Electrophotosensitive materials of Examples 6-1 to 6-4 were fabricated the same way as in Example 1-1 except that each of the examples used 40 parts by weight of naphthylene diimide derivative of the formula of a number listed in Table 31.

### Examples 6-5 to 6-8

Electrophotosensitive materials of Examples 6-5 to 6-8 were fabricated the same way as in Example 1-7 except that each of the examples used 40 parts by weight of naphthylene diimide derivative of the formula of a number listed in Table 31.

The electrophotosensitive materials of the above examples were subjected to the same photosensitivity test (I), durabilitytest (I) and solvent resistance test as the above and were evaluated for the characteristics thereof. The results as well as those of Comparative Examples 1-1, 1-2 are listed in Table 31.

TABLE 31

| | | | | Initial | | | After durability test | | | |
|---|---|---|---|---|---|---|---|---|---|---|
| | | | | | | HLE | | | HLE | |
| | | P-H | | SP | RP | E_{½} | SP | RP | E_{½} | |
| | SPL | TM | NDI | V₀(V) | Vr(V) | (μJ/cm²) | V₀(V) | Vr(V) | (μJ/cm²) | SRT |
| Ex. 6-1 | a-SiC | HT-1 | 3-1-3 | 809 | 145 | 1.049 | 798 | 147 | 1.063 | ◯ |
| Ex. 6-2 | a-SiC | HT-1 | 3-1-7 | 798 | 156 | 1.112 | 795 | 161 | 1.148 | ◯ |
| Ex. 6-3 | a-SiC | HT-1 | 3-1-10 | 796 | 165 | 1.154 | 793 | 168 | 1.175 | ◯ |
| Ex. 6-4 | a-SiC | HT-1 | 3-1-12 | 806 | 148 | 1.035 | 801 | 152 | 1.063 | ◯ |
| C. Ex. 1-1 | a-SiC | HT-1 | — | 817 | 205 | 1.500 | 745 | 244 | 1.785 | X |
| Ex. 6-5 | a-SiC | HT-3 | 3-1-3 | 795 | 172 | 1.183 | 785 | 174 | 1.197 | ◯ |
| Ex. 6-6 | a-SiC | HT-3 | 3-1-7 | 784 | 173 | 1.226 | 782 | 178 | 1.261 | ◯ |
| Ex. 6-7 | a-SiC | HT-3 | 3-1-10 | 788 | 183 | 1.264 | 785 | 181 | 1.250 | ◯ |
| Ex. 6-8 | a-SiC | HT-3 | 3-1-12 | 812 | 163 | 1.158 | 806 | 168 | 1.194 | ◯ |
| C. Ex. 1-2 | a-SiC | HT-3 | — | 804 | 232 | 1.667 | 748 | 252 | 1.810 | Δ |

NDI: Naphtylenediimide compound

According to the results of the solvent resistance test listed in the table, all the electrophotosensitive materials of Examples 6-1 to 6-8 suffered no cracks nor delamination of the surface protective layer. It was thus concluded that the use of the naphthylene diimide derivative of the formula (3) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products. Examples 6-9 to 6-16 Electrophotosensitive materials of Examples 6-9 to 6-16 were fabricated the same way as in Examples 6-1 to 6-8 except that the same procedure as in Examples 1-13 to 1-24 was taken to form a surface protective layer of amorphous carbon (C) having a thickness of 0.5 μm, instead of the silicon-carbon composite film, over the surface of the single-layer photosensitive layer.

The electrophotosensitive materials of the above examples were subjected to the same photosensitivity test (I), durability test (I) and solvent resistance test as the above and were evaluated for the characteristics thereof. The results as well as those of Comparative Examples 1-3, 1-4 are listed in Table 32.

TABLE 32

| | | | | Initial | | | After durability test | | | |
|---|---|---|---|---|---|---|---|---|---|---|
| | | | | | | HLE | | | HLE | |
| | | P-H | | SP | RP | E_{½} | SP | RP | E_{½} | |
| | SPL | TM | NDI | V₀(V) | Vr(V) | (μJ/cm²) | V₀(V) | Vr(V) | (μJ/cm²) | SRT |
| Ex. 6-9 | a-C | HT-1 | 3-1-3 | 806 | 151 | 1.117 | 798 | 158 | 1.169 | ◯ |
| Ex. 6-10 | a-C | HT-1 | 3-1-7 | 788 | 157 | 1.185 | 785 | 162 | 1.223 | ◯ |
| Ex. 6-11 | a-C | HT-1 | 3-1-10 | 801 | 170 | 1.222 | 792 | 172 | 1.236 | ◯ |
| Ex. 6-12 | a-C | HT-1 | 3-1-12 | 796 | 152 | 1.093 | 799 | 156 | 1.122 | ◯ |
| C. Ex. 1-3 | a-C | HT-1 | — | 793 | 208 | 1.563 | 742 | 238 | 1.788 | X |
| Ex. 6-13 | a-C | HT-3 | 3-1-3 | 795 | 162 | 1.182 | 790 | 164 | 1.197 | ◯ |
| Ex. 6-14 | a-C | HT-3 | 3-1-7 | 812 | 163 | 1.273 | 809 | 166 | 1.296 | ◯ |
| Ex. 6-15 | a-C | HT-3 | 3-1-10 | 782 | 170 | 1.282 | 785 | 172 | 1.297 | ◯ |
| Ex. 6-16 | a-C | HT-3 | 3-1-12 | 796 | 152 | 1.143 | 793 | 150 | 1.128 | ◯ |
| C. Ex. 1-4 | a-C | HT-3 | — | 788 | 222 | 1.667 | 746 | 240 | 1.792 | X |

It was confirmed from the table that if the type of the surface protective layer was changed, the same results as the above were obtained according to the compositions of the single-layer photosensitive layer as the base.

According to the results of the solvent resistance test listed in the table, all the electrophotosensitive materials of Examples 6-9 to 6-16 suffered no cracks nor delamination of the surface protective layer. It was thus concluded that the use of the naphthylene diimide derivative of the formula (3) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

### Examples 6-17, 6-18

Electrophotosensitive materials of Examples 6-17, 6-18 were fabricated the same way as in Examples 6-5, 6-8 except that the same procedure as in Examples 1-25, 1-26 was taken to form a surface protective layer of amorphous silicon-nitrogen (SiN) composite film having a thickness of 0.5 μm, instead of the silicon-carbon composite film, over the surface of the single-layer photosensitive layer.

### Examples 6-19, 6-20

Electrophotosensitive materials of Examples 6-19, 6-20 were fabricated the same way as in Examples 6-5, 6-8 except that the same procedure as in Examples 1-27, 1-28 was taken to form a surface protective layer of amorphous carbon-nitrogen (CN) composite film having a thickness of 0.5 μm, instead of the silicon-carbon composite film, over the surface of the single-layer photosensitive layer.

### Examples 6-21, 6-22

Electrophotosensitive materials of Examples 6-21, 6-22 were fabricated the same way as in Examples 6-5, 6-8 except that the same procedure as in Examples 1-29, 1-30 was taken to form a surface protective layer of amorphous carbon-boron (CB) composite film having a thickness of 0.5 μm, instead of the silicon-carbon composite film, over the surface of the single-layer photosensitive layer.

### Examples 6-23, 6-24

Electrophotosensitive materials of Examples 6-23, 6-24 were fabricated the same way as in Examples 6-5, 6-8 except that the same procedure as in Examples 1-31, 1-32 was taken to form a surface protective layer of amorphous carbon-fluorine (CF) composite film having a thickness of 0.5 μm, instead of the silicon-carbon composite film, over the surface of the single-layer photosensitive layer.

### Examples 6-25, 6-26

Electrophotosensitive materials of Examples 6-25, 6-26 were fabricated the same way as in Examples 6-5, 6-8 except that the same procedure as in Examples 1-33, 1-34 was taken to form a surface protective layer of amorphous boron-nitrogen (BN) composite film having a thickness of 0.5 μm, instead of the silicon-carbon composite film, over the surface of the single-layer photosensitive layer.

The electrophotosensitive materials of the above examples were subjected to the same photosensitivity test (I), durability test (I) and solvent resistance test as the above and were evaluated for the characteristics thereof. The results as well as those of Comparative Examples 1-5 to 1-9 are listed in Table 33.

TABLE 33

| | | | | Initial | | | After durability test | | | |
|---|---|---|---|---|---|---|---|---|---|---|
| | | | | | | HLE | | | HLE | |
| | | P-H | | SP | RP | E_{½} | SP | RP | E_{½} | |
| | SPL | TM | NDI | V₀(V) | Vr(V) | (μJ/cm²) | V₀(V) | Vr(V) | (μJ/cm²) | SRT |
| Ex. 6-17 | a-SiN | HT-3 | 3-1-3 | 812 | 185 | 1.315 | 803 | 187 | 1.329 | ◯ |
| Ex. 6-18 | a-SiN | HT-3 | 3-1-12 | 798 | 185 | 1.277 | 786 | 187 | 1.291 | ◯ |
| C. Ex. 1-5 | a-SiN | HT-3 | — | 812 | 245 | 1.787 | 749 | 263 | 1.918 | Δ |
| Ex. 6-19 | a-CN | HT-3 | 3-1-3 | 814 | 191 | 1.390 | 805 | 194 | 1.412 | ◯ |
| Ex. 6-20 | a-CN | HT-3 | 3-1-12 | 813 | 190 | 1.359 | 806 | 192 | 1.373 | ◯ |
| C. Ex. 1-6 | a-CN | HT-3 | — | 790 | 252 | 1.875 | 752 | 270 | 2.009 | Δ |
| Ex. 6-21 | a-CB | HT-3 | 3-1-3 | 793 | 157 | 1.183 | 788 | 160 | 1.206 | ◯ |
| Ex. 6-22 | a-CB | HT-3 | 3-1-12 | 811 | 162 | 1.167 | 803 | 160 | 1.153 | ◯ |
| C. Ex. 1-7 | a-CB | HT-3 | — | 801 | 222 | 1.667 | 746 | 238 | 1.787 | X |
| Ex. 6-23 | a-CF | HT-3 | 3-1-3 | 801 | 170 | 1.265 | 796 | 175 | 1.302 | ◯ |
| Ex. 6-24 | a-CF | HT-3 | 3-1-12 | 803 | 169 | 1.256 | 812 | 172 | 1.278 | ◯ |
| C. Ex. 1-8 | a-CF | HT-3 | — | 788 | 232 | 1.745 | 734 | 248 | 1.865 | X |
| Ex. 6-25 | a-BN | HT-3 | 3-1-3 | 814 | 144 | 1.116 | 809 | 148 | 1.147 | ◯ |
| Ex. 6-26 | a-BN | HT-3 | 3-1-12 | 801 | 139 | 1.093 | 807 | 141 | 1.109 | ◯ |
| C. Ex. 1-9 | a-BN | HT-3 | — | 785 | 203 | 1.595 | 752 | 233 | 1.831 | X |

It was confirmed from the table that if the type of the surface protective layer was further changed, the same results as the above were obtained according to the compositions of the single-layer photosensitive layer as the base.

According to the results of the solvent resistance test listed in the table, all the electrophotosensitive materials of Examples 6-17 to 6-26 suffered no cracks nor delamination of the surface protective layer. It was thus concluded that the use of the naphthylene diimide derivative of the formula (3) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

Multi-layer Electrophotosensitive Material

### Examples 6-27 to 6-30

Electrophotosensitive materials of Examples 6-27 to 6-30 were fabricated the same way as in Example 1-35 except that each of the examples used 0.2 parts by weight of naphthylene diimide derivative of the formula of a number listed in Table 34.

### Examples 6-31 to 6-34

Electrophotosensitive materials of Examples 6-31 to 6-34 were fabricated the same way as in Example 1-41 except that each of the examples used 40 parts by weight of naphthylene diimide derivative of the formula of a number listed in Table 34.

The electrophotosensitive materials of the above examples were subjected to the same photosensitivity test (II), durability test (II) and solvent resistance test as the above and were evaluated for the characteristics thereof. The results as well as those of Comparative Examples 1-10, 1-11 are listed in Table 34.

TABLE 34

| | | | | Initial | | | After durability test | | | |
|---|---|---|---|---|---|---|---|---|---|---|
| | | | | | | HLE | | | HLE | |
| | | P-H | | SP | RP | E_{½} | SP | RP | E_{½} | |
| | SPL | TM | NDI | V₀(V) | Vr(V) | (μJ/cm²) | V₀(V) | Vr(V) | (μJ/cm²) | SRT |
| Ex. 6-27 | a-SiC | HT-1 | 3-1-3 | −798 | −135 | 0.783 | −798 | −133 | 0.771 | ◯ |
| Ex. 6-28 | a-SiC | HT-1 | 3-1-7 | −788 | −147 | 0.845 | −801 | −144 | 0.828 | ◯ |
| Ex. 6-29 | a-SiC | HT-1 | 3-1-10 | −804 | −142 | 0.831 | −801 | −137 | 0.811 | ◯ |
| Ex. 6-30 | a-SiC | HT-1 | 3-1-12 | −790 | −135 | 0.763 | −798 | −132 | 0.746 | ◯ |
| C. Ex. 1-10 | a-SiC | HT-1 | — | −806 | −165 | 0.938 | −782 | −192 | 1.052 | X |
| Ex. 6-31 | a-SiC | HT-3 | 3-1-3 | −804 | −116 | 0.847 | −796 | −114 | 0.832 | ◯ |
| Ex. 6-32 | a-SiC | HT-3 | 3-1-7 | −817 | −132 | 0.932 | −806 | −127 | 0.897 | ◯ |
| Ex. 6-33 | a-SiC | HT-3 | 3-1-10 | −798 | −123 | 0.923 | −793 | −125 | 0.938 | ◯ |
| Ex. 6-34 | a-SiC | HT-3 | 3-1-12 | −801 | −122 | 0.846 | −798 | −116 | 0.804 | ◯ |
| C. Ex. 1-11 | a-SiC | HT-3 | — | −814 | −147 | 1.024 | −776 | −176 | 1.226 | X |

It was confirmed from the table that if the single-layer photosensitive layer was replaced by the multi-layer photosensitive layer, the same results as the above were obtained according to the compositions of the charge transport layer defining the outermost part thereof.

According to the results of the solvent resistance test listed in the table, all the electrophotosensitive materials of Examples 6-27 to 6-34 suffered no cracks nor delamination of the surface protective layer. It was thus concluded that the use of the naphthylene diimide derivative of the formula (3) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

### Examples 6-35 to 6-42

Electrophotosensitive materials of these examples were fabricated the same way as in Examples 6-27 to 6-34 except that the same procedure as in Examples 1-13 to 1-24 was taken to form a surface protective layer of amorphous carbon (C) having a thickness of 0.5 μm, instead of the silicon-carbon composite film, over the surface of the multi-layer photosensitive layer.

The electrophotosensitive materials of the above examples were subjected to the same photosensitivity test (II), durability test (II) and solvent resistance test as the above and were evaluated for the characteristics thereof. The results as well as those of Comparative Examples 1-12, 1-13 are listed in Table 35.

TABLE 35

| | | | | Initial | | | After durability test | | | |
|---|---|---|---|---|---|---|---|---|---|---|
| | | | | | | HLE | | | HLE | |
| | | P-H | | SP | RP | E_{½} | SP | RP | E_{½} | |
| | SPL | TM | NDI | V₀(V) | Vr(V) | (μJ/cm²) | V₀(V) | Vr(V) | (μJ/cm²) | SRT |
| Ex. 6-35 | a-C | HT-1 | 3-1-3 | −814 | −141 | 1.031 | −810 | −139 | 1.016 | ◯ |
| Ex. 6-36 | a-C | HT-1 | 3-1-7 | −793 | −160 | 1.126 | −798 | −155 | 1.091 | ◯ |
| Ex. 6-37 | a-C | HT-1 | 3-1-10 | −812 | −147 | 1.106 | −806 | −147 | 1.106 | ◯ |
| Ex. 6-38 | a-C | HT-1 | 3-1-12 | −798 | −145 | 1.022 | −793 | −140 | 0.987 | ◯ |
| C. Ex. 1-12 | a-C | HT-1 | — | −785 | −172 | 1.216 | −748 | −198 | 1.400 | X |
| Ex. 6-39 | a-C | HT-3 | 3-1-3 | −814 | −121 | 0.947 | −806 | −119 | 0.931 | ◯ |
| Ex. 6-40 | a-C | HT-3 | 3-1-7 | −817 | −124 | 1.007 | −806 | −128 | 1.039 | ◯ |
| Ex. 6-41 | a-C | HT-3 | 3-1-10 | −806 | −120 | 0.956 | −801 | −117 | 0.932 | ◯ |
| Ex. 6-42 | a-C | HT-3 | 3-1-12 | −788 | −130 | 0.972 | −790 | −126 | 0.942 | ◯ |
| C. Ex. 1-13 | a-C | HT-3 | — | −817 | −146 | 1.098 | −771 | −178 | 1.339 | X |

It was confirmed from the table that if the type of the surface protective layer was changed, the same results as the above were obtained according to the compositions of the charge transport layer of the multi-layer photosensitive layer as the base.

According to the results of the solvent resistance test listed in the table, all the electrophotosensitive materials of Examples 6-35 to 6-42 suffered no cracks nor delamination of the surface protective layer. It was thus concluded that the use of the naphthylene diimide derivative of the formula (3) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

### Examples 6-43, 6-44

Electrophotosensitive materials of these examples were fabricated the same way as in Examples 6-31, 6-34 except that the same procedure as in Examples 1-25, 1-26 was taken to form a surface protective layer of amorphous silicon-nitrogen (SiN) composite film having a thickness of 0.5 μm, instead of the silicon-carbon composite film, over the surface of the multi-layer photosensitive layer.

### Examples 6-45, 6-46

Electrophotosensitive materials of these examples were fabricated the same way as in Examples 6-31, 6-34 except that the same procedure as in Examples 1-27, 1-28 was taken to form a surface protective layer of amorphous carbon-nitrogen (CN) composite film having a thickness of 0.5 μm, instead of the silicon-carbon composite film, over the surface of the multi-layer photosensitive layer.

### Examples 6-47, 6-48

Electrophotosensitive materials of these examples were fabricated the same way as in Examples 6-31, 6-34 except that the same procedure as in Examples 1-29, 1-30 was taken to form a surface protective layer of amorphous carbon-boron (CB) composite film having a thickness of 0.5 μm, instead of the silicon-carbon composite film, over the surface of the multi-layer photosensitive layer.

### Examples 6-49, 6-50

Electrophotosensitive materials of these examples were fabricated the same way as in Examples 6-31, 6-34 except that the same procedure as in Examples 1-31, 1-32 was taken to form a surface protective layer of amorphous carbon-fluorine (CF) composite film having a thickness of 0.5 μm, instead of the silicon-carbon composite film, over the surface of the multi-layer photosensitive layer.

### Examples 6-51, 6-52

Electrophotosensitive materials of these examples were fabricated the same way as in Examples 6-31, 6-34 except that the same procedure as in Examples 1-33, 1-34 was taken to form a surface protective layer of amorphous boron-nitrogen (BN) composite film having a thickness of 0.5 μm, instead of the silicon-carbon composite film, over the surface of the multi-layer photosensitive layer.

The electrophotosensitive materials of the above examples were subjected to the same photosensitivity test (II), durability test (II) and solvent resistance test as the above and were evaluated for the characteristics thereof. The results as well as those of Comparative Examples 1-14 to 1-18 are listed in Table 36.

TABLE 36

| | | | | Initial | | | After durability test | | | |
|---|---|---|---|---|---|---|---|---|---|---|
| | | | | | | HLE | | | HLE | |
| | | P-H | | SP | RP | E_{½} | SP | RP | E_{½} | |
| | SPL | TM | NDI | V₀(V) | Vr(V) | (μJ/cm²) | V₀(V) | Vr(V) | (μJ/cm²) | SRT |
| Ex. 6-43 | a-SiN | HT-3 | 3-1-3 | −788 | −131 | 0.996 | −780 | −126 | 0.958 | ◯ |
| Ex. 6-44 | a-SiN | HT-3 | 3-1-12 | −793 | −126 | 0.978 | −796 | −124 | 0.962 | ◯ |
| C. Ex. 1-14 | a-SiN | HT-3 | — | −785 | −149 | 1.095 | −758 | −186 | 1.367 | Δ |
| Ex. 6-45 | a-CN | HT-3 | 3-1-3 | −814 | −123 | 1.031 | −812 | −121 | 1.014 | ◯ |
| Ex. 6-46 | a-CN | HT-3 | 3-1-12 | −801 | −145 | 0.823 | −796 | −138 | 0.783 | ◯ |
| C. Ex. 1-15 | a-CN | HT-3 | — | −793 | −148 | 1.155 | −762 | −177 | 1.381 | X |
| Ex. 6-47 | a-CB | HT-3 | 3-1-3 | −814 | −118 | 0.838 | −802 | −115 | 0.817 | ◯ |
| Ex. 6-48 | a-CB | HT-3 | 3-1-12 | −809 | −104 | 0.810 | −801 | −106 | 0.826 | ◯ |
| C. Ex. 1-16 | a-CB | HT-3 | — | −793 | −137 | 0.979 | −746 | −167 | 1.193 | X |
| Ex. 6-49 | a-CF | HT-3 | 3-1-3 | −814 | −118 | 0.937 | −793 | −126 | 1.001 | ◯ |
| Ex. 6-50 | a-CF | HT-3 | 3-1-12 | −812 | −119 | 0.904 | −817 | −121 | 0.919 | ◯ |
| C. Ex. 1-17 | a-CF | HT-3 | — | −793 | −139 | 1.021 | −766 | −178 | 1.307 | X |
| Ex. 6-51 | a-BN | HT-3 | 3-1-3 | −788 | −100 | 0.786 | −780 | −97 | 0.762 | ◯ |
| Ex. 6-52 | a-BN | HT-3 | 3-1-12 | −804 | −95 | 0.767 | −796 | −100 | 0.807 | ◯ |
| C. Ex. 1-18 | a-BN | HT-3 | — | −780 | −117 | 0.904 | −748 | −146 | 1.128 | X |

It was confirmed from the table that if the type of the surface protective layer was further changed, the same results as the above were obtained according to the compositions of the charge transport layer of the multi-layer photosensitive layer as the base.

According to the results of the solvent resistance test listed in the table, all the electrophotosensitive materials of Examples 6-43 to 6-52 suffered no cracks nor delamination of the surface protective layer. It was thus concluded that the use of the naphthylene diimide derivative of the formula (3) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

Single-layer Electrophotosensitive Material

### Examples 7-1 to 7-7

Electrophotosensitive materials of Examples 7-1 to 7-7 were fabricated the same way as in Example 1-1 except that each of the examples used 40 parts by weight of quinone derivative of the formula of a number listed in Table 37.

### Comparative Example 7-1

An electrophotosensitive material of Comparative Example 7-1 was fabricated the same way as in Examples 7-1 to 7-7 except that 40 parts by weight of isatin compound represented by the formula (ET-1) was used instead of the quinone derivative.

### Examples 7-8 to 7-14

Electrophotosensitive materials of Examples 7-8 to 7-14 were fabricated the same way as in Example 1-7 except that each of the examples used 40 parts by weight of quinone derivative of the formula of a number listed in Table 37.

### Comparative Example 7-2

An electrophotosensitive material of Comparative Example 7-2 was fabricated the same way as in Examples 7-8 to 7-14 except that 40 parts by weight of isatin compound represented by the formula (ET-1) was used instead of the quinone derivative.

The electrophotosensitive materials of the above examples and comparative examples were subjected to the same photosensitivity test (I), durability test (I) and solvent resistance test as the above and were evaluated for the characteristics thereof. The results as well as those of Comparative Examples 1-1, 1-2 are listed in Table 37.

TABLE 37

| | | | | Initial | | | After durability test | | | |
|---|---|---|---|---|---|---|---|---|---|---|
| | | | | | | HLE | | | HLE | |
| | | P-H | | SP | RP | E_{½} | SP | RP | E_{½} | |
| | SPL | TM | QC | V₀(V) | Vr(V) | (μJ/cm²) | V₀(V) | Vr(V) | (μJ/cm²) | SRT |
| Ex. 7-1 | a-SiC | HT-1 | 4-1-1 | 801 | 193 | 1.340 | 793 | 191 | 1.326 | ◯ |
| Ex. 7-2 | a-SiC | HT-1 | 4-1-11 | 814 | 185 | 1.305 | 807 | 178 | 1.276 | ◯ |
| Ex. 7-3 | a-SiC | HT-1 | 4-2-2 | 810 | 188 | 1.387 | 805 | 192 | 1.406 | ◯ |
| Ex. 7-4 | a-SiC | HT-1 | 4-2-15 | 808 | 194 | 1.403 | 814 | 198 | 1.422 | ◯ |
| Ex. 7-5 | a-SiC | HT-1 | 4-3-2 | 806 | 164 | 1.200 | 798 | 162 | 1.185 | ◯ |
| Ex. 7-6 | a-SiC | HT-1 | 4-3-3 | 802 | 176 | 1.272 | 798 | 174 | 1.258 | ◯ |
| Ex. 7-7 | a-SiC | HT-1 | 4-3-13 | 810 | 180 | 1.251 | 812 | 182 | 1.265 | ◯ |
| C. Ex. 1-1 | a-SiC | HT-1 | — | 817 | 205 | 1.500 | 745 | 244 | 1.785 | X |
| C. Ex. 7-1 | a-SiC | HT-1 | ET-1 | 809 | 198 | 1.488 | 753 | 226 | 1.769 | X |
| Ex. 7-8 | a-SiC | HT-3 | 4-1-1 | 814 | 216 | 1.502 | 817 | 218 | 1.516 | ◯ |
| Ex. 7-9 | a-SiC | HT-3 | 4-1-11 | 817 | 210 | 1.437 | 806 | 207 | 1.416 | ◯ |
| Ex. 7-10 | a-SiC | HT-3 | 4-2-2 | 782 | 224 | 1.544 | 780 | 221 | 1.523 | ◯ |
| Ex. 7-11 | a-SiC | HT-3 | 4-2-15 | 809 | 219 | 1.544 | 801 | 214 | 1.519 | ◯ |
| Ex. 7-12 | a-SiC | HT-3 | 4-3-2 | 802 | 184 | 1.324 | 809 | 186 | 1.338 | ◯ |
| Ex. 7-13 | a-SiC | HT-3 | 4-3-3 | 817 | 205 | 1.438 | 802 | 202 | 1.417 | ◯ |
| Ex. 7-14 | a-SiC | HT-3 | 4-3-13 | 814 | 195 | 1.367 | 804 | 193 | 1.353 | ◯ |
| C. Ex. 1-2 | a-SiC | HT-3 | — | 804 | 232 | 1.667 | 748 | 252 | 1.810 | Δ |
| C. Ex. 7-2 | a-SiC | HT-3 | ET-1 | 806 | 212 | 1.653 | 755 | 230 | 1.754 | Δ |

QC: Quinone compound

According to the results of the solvent resistance test listed in the table, the electrophotosensitive material of Comparative Example 7-1 suffered the delamination of the surface protective layer similarly to that of Comparative Example 1-1. Similarly to the electrophotosensitive material of Comparative Example 1-2, that of Comparative Example 7-2 was found to sustain cracks in the surface protective layer. It was thus concluded that adding a compound other than those of the formulas (1) to (4) to the photosensitive layer does not contribute the effect to improve the physical stability of the inorganic surface protective layer.

Furthermore, the electrophotosensitive materials of these comparative examples were found to have poor durability because they were significantly increased in residual potential and half-life exposure after the durability test.

In contrast, all the electrophotosensitive materials of Examples 7-1 to 7-14 suffered no cracks nor delamination of the surface protective layer in the solvent resistance test. It was thus concluded that the use of the quinone derivative of the formula (4) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

### Examples 7-15 to 7-28, Comparative Examples 7-3, 7-4

Electrophotosensitive materials of Examples 7-15 to 7-28 and Comparative Examples 7-3, 7-4 were fabricated the same way as in Examples 7-1 to 7-14 and Comparative Examples 7-1, 7-2 except that the same procedure as in Examples 1-13 to 1-24 was taken to form a surface protective layer of amorphous carbon (C) having a thickness of 0.5 μm, instead of the silicon-carbon composite film, over the surface of the single-layer photosensitive layer.

The electrophotosensitive materials of the above examples and comparative examples were subjected to the same photosensitivity test (I), durability test (I) and solvent resistance test as the above and were evaluated for the characteristics thereof. The results as well as those of Comparative Examples 1-3, 1-4 are listed in Table 38.

TABLE 38

| | | | | Initial | | | After durability test | | | |
|---|---|---|---|---|---|---|---|---|---|---|
| | | | | | | HLE | | | HLE | |
| | | P-H | | SP | RP | E_{½} | SP | RP | E_{½} | |
| | SPL | TM | QC | V₀(V) | Vr(V) | (μJ/cm²) | V₀(V) | Vr(V) | (μJ/cm²) | SRT |
| Ex. 7-15 | a-C | HT-1 | 4-1-1 | 814 | 194 | 1.421 | 809 | 191 | 1.399 | ◯ |
| Ex. 7-16 | a-C | HT-1 | 4-1-11 | 806 | 190 | 1.360 | 803 | 185 | 1.344 | ◯ |
| Ex. 7-17 | a-C | HT-1 | 4-2-2 | 796 | 201 | 1.461 | 804 | 204 | 1.483 | ◯ |
| Ex. 7-18 | a-C | HT-1 | 4-2-15 | 790 | 201 | 1.475 | 794 | 198 | 1.453 | ◯ |
| Ex. 7-19 | a-C | HT-1 | 4-3-2 | 805 | 163 | 1.232 | 814 | 173 | 1.259 | ◯ |
| Ex. 7-20 | a-C | HT-1 | 4-3-3 | 812 | 178 | 1.325 | 804 | 176 | 1.310 | ◯ |
| Ex. 7-21 | a-C | HT-1 | 4-3-13 | 796 | 176 | 1.292 | 790 | 184 | 1.331 | ◯ |
| C. Ex. 1-3 | a-C | HT-1 | — | 793 | 208 | 1.563 | 742 | 238 | 1.788 | X |
| C. Ex. 7-3 | a-C | HT-1 | ET-1 | 801 | 196 | 1.433 | 738 | 221 | 1.678 | X |
| Ex. 7-22 | a-C | HT-3 | 4-1-1 | 802 | 202 | 1.502 | 801 | 200 | 1.487 | ◯ |
| Ex. 7-23 | a-C | HT-3 | 4-1-11 | 798 | 198 | 1.437 | 790 | 193 | 1.401 | ◯ |
| Ex. 7-24 | a-C | HT-3 | 4-2-2 | 803 | 203 | 1.530 | 796 | 208 | 1.568 | ◯ |
| Ex. 7-25 | a-C | HT-3 | 4-2-15 | 805 | 215 | 1.544 | 801 | 208 | 1.494 | ◯ |
| Ex. 7-26 | a-C | HT-3 | 4-3-2 | 808 | 177 | 1.334 | 798 | 185 | 1.394 | ◯ |
| Ex. 7-27 | a-C | HT-3 | 4-3-3 | 798 | 193 | 1.437 | 804 | 191 | 1.422 | ◯ |
| Ex. 7-28 | a-C | HT-3 | 4-3-13 | 795 | 182 | 1.356 | 790 | 185 | 1.378 | ◯ |
| C. Ex. 1-4 | a-C | HT-3 | — | 788 | 222 | 1.667 | 746 | 240 | 1.792 | X |
| C. Ex. 7-4 | a-C | HT-3 | ET-1 | 812 | 214 | 1.601 | 752 | 232 | 1.604 | X |

It was confirmed from the table that if the type of the surface protective layer was changed, the same results as the above were obtained according to the compositions of the single-layer photosensitive layer as the base.

Specifically, both the electrophotosensitive material of Comparative Examples 7-3, 7-4 were found to suffer the delamination of the surface protective layer similarly to those of Comparatives Examples 1-3, 1-4. It was thus concluded that adding a compound other than those of the formulas (1) to (4) to the photosensitive layer does not contribute the effect to improve the physical stability of the inorganic surface protective layer.

Furthermore, the electrophotosensitive materials of these comparative examples were found to have poor durability because they were significantly increased in residual potential and half-life exposure after the durability test.

In contrast, all the electrophotosensitive materials of Examples 7-15 to 7-28 suffered no cracks nor delamination of the surface protective layer in the solvent resistance test. It was thus concluded that the use of the quinone derivative of the formula (4) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

### Examples 7-29 to 7-32, Comparative Example 7-5

Electrophotosensitive materials of Examples 7-29 to 7-32 and Comparative Example 7-5 were fabricated the same way as in Examples 7-8, 7-10, 7-11 and 7-13 and Comparative Example 7-2 except that the same procedure as in Examples 1-25, 1-26 was taken to form a surface protective layer of amorphous silicon-nitrogen (SiN) composite film having a thickness of 0.5 μm, instead of the silicon-carbon composite film, over the surface of the single-layer photosensitive layer.

### Examples 7-33 to 7-36, Comparative Example 7-6

Electrophotosensitive materials of Examples 7-33 to 7-36 and Comparative Example 7-6 were fabricated the same way as in Examples 7-8, 7-10, 7-11 and 7-13 and Comparative Example 7-2 except that the same procedure as in Examples 1-27, 1-28 was taken to form a surface protective layer of amorphous carbon-nitrogen (CN) composite film having a thickness of 0.5 μm, instead of the silicon-carbon composite film, over the surface of the single-layer photosensitive layer.

### Examples 7-37 to 7-40, Comparative Example 7-7

Electrophotosensitive materials of Examples 7-37 to 7-40 and Comparative Example 7-7 were fabricated the same way as in Examples 7-8, 7-10, 7-11 and 7-13 and Comparative Example 7-2 except that the same procedure as in Examples 1-29, 1-30 was taken to form a surface protective layer of amorphous carbon-boron (CB) composite film having a thickness of 0.5 μm, instead of the silicon-carbon composite film, over the surface of the single-layer photosensitive layer.

### Examples 7-41 to 7-44, Comparative Example 7-8

Electrophotosensitive materials of Examples 7-41 to 7-44 and Comparative Example 7-8 were fabricated the same way as in Examples 7-8, 7-10, 7-11 and 7-13 and Comparative Example 7-2 except that the same procedure as in Examples 1-31, 1-32 was taken to form a surface protective layer of amorphous carbon-fluorine (CF) composite film having a thickness of 0.5 μm, instead of the silicon-carbon composite film, over the surface of the single-layer photosensitive layer.

### Examples 7-45 to 7-48, Comparative Example 7-9

Electrophotosensitive materials of Examples 7-45 to 7-48 and Comparative Example 7-9 were fabricated the same way as in Examples 7-8, 7-10, 7-11 and 7-13 and Comparative Example 7-2 except that the same procedure as in Examples 1-33, 1-34 was taken to form a surface protective layer of amorphous boron-nitrogen (BN) composite film having a thickness of 0.5 μm, instead of the silicon-carbon composite film, over the surface of the single-layer photosensitive layer.

The electrophotosensitive materials of the above examples and comparative examples were subjected to the same photosensitivity test (I), durability test (I) and solvent resistance test as the above and were evaluated for the characteristics thereof. The results as well as those of Comparative Examples 1-5 to 1-9 are listed in Tables 39a, 39b.

TABLE 39a

| | | | | Initial | | | After durability test | | | |
|---|---|---|---|---|---|---|---|---|---|---|
| | | | | | | HLE | | | HLE | |
| | | P-H | | SP | RP | E_{½} | SP | RP | E_{½} | |
| | SPL | TM | QC | V₀(V) | Vr(V) | (μJ/cm²) | V₀(V) | Vr(V) | (μJ/cm²) | SRT |
| Ex. 7-29 | a-SiN | HT-3 | 4-1-1 | 806 | 227 | 1.625 | 795 | 222 | 1.589 | ◯ |
| Ex. 7-30 | a-SiN | HT-3 | 4-2-2 | 801 | 236 | 1.656 | 809 | 231 | 1.621 | ◯ |
| Ex. 7-31 | a-SiN | HT-3 | 4-2-15 | 813 | 203 | 1.442 | 806 | 197 | 1.399 | ◯ |
| Ex. 7-32 | a-SiN | HT-3 | 4-3-3 | 798 | 207 | 1.515 | 803 | 211 | 1.544 | ◯ |
| C. Ex. 1-5 | a-SiN | HT-3 | — | 812 | 245 | 1.787 | 749 | 263 | 1.918 | Δ |
| C. Ex. 7-5 | a-SiN | HT-3 | ET-1 | 814 | 240 | 1.766 | 753 | 260 | 1.897 | Δ |
| Ex. 7-33 | a-CN | HT-3 | 4-1-1 | 809 | 229 | 1.705 | 804 | 227 | 1.690 | ◯ |
| Ex. 7-34 | a-CN | HT-3 | 4-2-2 | 793 | 240 | 1.737 | 798 | 233 | 1.686 | ◯ |
| Ex. 7-35 | a-CN | HT-3 | 4-2-15 | 806 | 213 | 1.513 | 809 | 208 | 1.477 | ◯ |
| Ex. 7-36 | a-CN | HT-3 | 4-3-3 | 809 | 216 | 1.589 | 800 | 213 | 1.567 | ◯ |
| C. Ex. 1-6 | a-CN | HT-3 | — | 790 | 252 | 1.875 | 752 | 270 | 2.009 | Δ |
| C. Ex. 7-6 | a-CN | HT-3 | ET-1 | 814 | 248 | 1.866 | 760 | 268 | 1.905 | X |
| Ex. 7-37 | a-CB | HT-3 | 4-1-1 | 801 | 206 | 1.516 | 809 | 208 | 1.531 | ◯ |
| Ex. 7-38 | a-CB | HT-3 | 4-2-2 | 817 | 210 | 1.544 | 809 | 208 | 1.529 | ◯ |
| Ex. 7-39 | a-CB | HT-3 | 4-2-15 | 814 | 179 | 1.345 | 806 | 177 | 1.330 | ◯ |
| Ex. 7-40 | a-CB | HT-3 | 4-3-3 | 812 | 198 | 1.413 | 806 | 195 | 1.392 | ◯ |
| C. Ex. 1-7 | a-CB | HT-3 | — | 801 | 222 | 1.667 | 746 | 238 | 1.787 | X |
| C. Ex. 7-7 | a-CB | HT-3 | ET-1 | 803 | 211 | 1.568 | 754 | 234 | 1.742 | X |

TABLE 39b

| | | | | Initial | | | After durability test | | | |
|---|---|---|---|---|---|---|---|---|---|---|
| | | | | | | HLE | | | HLE | |
| | | P-H | | SP | RP | E_{½} | SP | RP | E_{½} | |
| | SPL | TM | QC | V₀(V) | Vr(V) | (μJ/cm²) | V₀(V) | Vr(V) | (μJ/cm²) | SRT |
| Ex. 7-41 | a-CF | HT-3 | 4-1-1 | 798 | 210 | 1.586 | 793 | 210 | 1.576 | ◯ |
| Ex. 7-42 | a-CF | HT-3 | 4-2-2 | 806 | 214 | 1.616 | 814 | 216 | 1.631 | ◯ |
| Ex. 7-43 | a-CF | HT-3 | 4-2-15 | 802 | 194 | 1.408 | 792 | 188 | 1.364 | ◯ |
| Ex. 7-44 | a-CF | HT-3 | 4-3-3 | 804 | 206 | 1.479 | 798 | 203 | 1.457 | ◯ |
| C. Ex. 1-8 | a-CF | HT-3 | — | 788 | 232 | 1.745 | 734 | 248 | 1.865 | X |
| C. Ex. 7-8 | a-CF | HT-3 | ET-1 | 804 | 222 | 1.668 | 751 | 235 | 1.745 | X |
| Ex. 7-45 | a-BN | HT-3 | 4-1-1 | 804 | 184 | 1.451 | 798 | 188 | 1.483 | ◯ |
| Ex. 7-46 | a-BN | HT-3 | 4-2-2 | 795 | 192 | 1.478 | 801 | 190 | 1.463 | ◯ |
| Ex. 7-47 | a-BN | HT-3 | 4-2-15 | 806 | 163 | 1.287 | 801 | 166 | 1.311 | ◯ |
| Ex. 7-48 | a-BN | HT-3 | 4-3-3 | 806 | 174 | 1.352 | 801 | 172 | 1.336 | ◯ |
| C. Ex. 1-9 | a-BN | HT-3 | — | 785 | 203 | 1.595 | 752 | 233 | 1.831 | X |
| C. Ex. 7-9 | a-BN | HT-3 | ET-1 | 793 | 196 | 1.471 | 756 | 228 | 1.688 | X |

It was confirmed from the tables that if the type of the surface protective layer was further changed, the same results as the above were obtained according to the compositions of the single-layer photosensitive layer as the base.

According to the results of the solvent resistance test listed in the tables, all the electrophotosensitive materials of Comparative Examples 7-6 to 7-9 suffered the delamination of the surface protective layer similarly to those of Comparative Examples 1-7 to 1-9. Similarly to the electrophotosensitive materials of Comparative Examples 1-5 and 1-6, those of Comparative Examples 7-5 was found to sustain cracks in the surface protective layer. It was thus concluded that adding a compound other than those of the formulas (1) to (4) to the photosensitive layer does not contribute the effect to improve the physical stability of the inorganic surface protective layer.

Furthermore, the electrophotosensitive materials of these comparative examples were found to have poor durability because they were significantly increased in residual potential and half-life exposure after the durability test.

In contrast, all the electrophotosensitive materials of Examples 7-29 to 7-48 suffered no cracks nor delamination of the surface protective layer in the solvent resistance test. It was thus concluded that the use of the quinone derivative of the formula (4) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

Multi-layer Electrophotosensitive Material

### Examples 7-49 to 7-55

Electrophotosensitive materials of Examples 7-49 to 7-55 were fabricated the same way as in Example 1-35 except that each of the examples used 0.2 parts by weight of quinone derivative of the formula of a number listed in Table 40.

### Comparative Example 7-10

An electrophotosensitive material of Comparative Example 7-10 was fabricated the same way as in Examples 7-49 to 7-55 except that 0.2 parts by weight of isatin compound represented by the formula (ET-1) was used instead of the quinone derivative.

### Examples 7-56 to 7-62

Electrophotosensitive materials of Examples 7-56 to 7-62 were fabricated the same way as in Example 1-41 except that each of the examples used 40 parts by weight of quinone derivative of the formula of a number listed in Table 40.

### Comparative Example 7-11

An electrophotosensitive material of Comparative Example 7-11 was fabricated the same way as in Examples 7-56 to 7-62 except that 0.2 parts by weight of isatin compound represented by the formula (ET-1) was used instead of the quinone derivative.

The electrophotosensitive materials of the above examples and comparative examples were subjected to the same photosensitivity test (II), durability test (II) and solvent resistance test as the above and were evaluated for the characteristics thereof. The results as well as those of Comparative Examples 1-10, 1-11 are listed in Table 40.

TABLE 40

| | | | | Initial | | | After durability test | | | |
|---|---|---|---|---|---|---|---|---|---|---|
| | | | | | | HLE | | | HLE | |
| | | P—H | | SP | RP | E_{½} | SP | RP | E_{½} | |
| | SPL | TM | QC | V₀(V) | Vr(V) | (μJ/cm²) | V₀(V) | Vr(V) | (μJ/cm²) | SRT |
| Ex.7-49 | a-SiC | HT-1 | 4-1-1 | −804 | −153 | 0.911 | −798 | −158 | 0.941 | ◯ |
| Ex.7-50 | a-SiC | HT-1 | 4-1-11 | −796 | −148 | 0.869 | −798 | −143 | 0.840 | ◯ |
| Ex.7-51 | a-SiC | HT-1 | 4-2-2 | −806 | −146 | 0.885 | −814 | −151 | 0.915 | ◯ |
| Ex.7-52 | a-SiC | HT-1 | 4-2-15 | −785 | −150 | 0.894 | −788 | −153 | 0.912 | ◯ |
| Ex.7-53 | a-SiC | HT-1 | 4-3-2 | −812 | −159 | 0.903 | −814 | −157 | 0.892 | ◯ |
| Ex.7-54 | a-SiC | HT-1 | 4-3-3 | −806 | −161 | 0.911 | −809 | −158 | 0.894 | ◯ |
| Ex.7-55 | a-SiC | HT-1 | 4-3-13 | −798 | −157 | 0.902 | −792 | −149 | 0.856 | ◯ |
| C.Ex.1-10 | a-SiC | HT-1 | — | −806 | −165 | 0.938 | −782 | −192 | 1.052 | X |
| C.Ex.7-10 | a-SiC | HT-1 | ET-1 | −796 | −167 | 1.217 | −766 | −196 | 1.307 | X |
| Ex.7-56 | a-SiC | HT-3 | 4-1-1 | −804 | −136 | 0.995 | −793 | −141 | 1.032 | ◯ |
| Ex.7-57 | a-SiC | HT-3 | 4-1-11 | −809 | −134 | 0.949 | −798 | −132 | 0.935 | ◯ |
| Ex.7-58 | a-SiC | HT-3 | 4-2-2 | −800 | −132 | 0.967 | −804 | −134 | 0.982 | ◯ |
| Ex.7-59 | a-SiC | HT-3 | 4-2-15 | −809 | −130 | 0.975 | −798 | −133 | 0.998 | ◯ |
| Ex.7-60 | a-SiC | HT-3 | 4-3-2 | −804 | −134 | 0.985 | −809 | −137 | 1.007 | ◯ |
| Ex.7-61 | a-SiC | HT-3 | 4-3-3 | −782 | −141 | 0.995 | −788 | −136 | 0.960 | ◯ |
| Ex.7-62 | a-SiC | HT-3 | 4-3-13 | −812 | −139 | 0.986 | −806 | −132 | 0.936 | ◯ |
| C.Ex.1-11 | a-SiC | HT-3 | — | −814 | −147 | 1.024 | −776 | −176 | 1.226 | X |
| C.Ex.7-11 | a-SiC | HT-3 | ET-1 | −780 | −153 | 1.098 | −753 | −186 | 1.289 | X |

It was confirmed from the table that if the single-layer photosensitive layer was replaced by the multi-layer photosensitive layer, the same results as the above were obtained according to the compositions of the charge transport layer defining the outermost part thereof.

Specifically, it was found in the solvent resistance test that both the electrophotosensitive materials of Comparative Examples 7-10, 7-11 suffered the delamination of the surface protective layer similarly to those of Comparative Examples 1-10, 1-11. It was thus concluded that adding a compound other than those of the formulas (1) to (4) to the photosensitive layer does not contribute the effect to improve the physical stability of the inorganic surface protective layer.

Furthermore, the electrophotosensitive materials of these comparative examples were found to have poor durability because they were significantly increased in residual potential and half-life exposure after the durability test.

In contrast, all the electrophotosensitive materials of Examples 7-49 to 7-62 suffered no cracks nor delamination of the surface protective layer in the solvent resistance test. It was thus concluded that the use of the quinone derivative of the formula (4) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

### Examples 7-63 to 7-76, Comparative Examples 7-12, 7

Electrophotosensitive materials of these examples and comparative examples were fabricated the same way as in Examples 7-49 to 7-62 and Comparative Examples 7-10, 7-11 except that the same procedure as in Examples 1-13 to 1-24 was taken to form a surface protective layer of amorphous carbon (C) having a thickness of 0.5 μm, instead of the silicon-carbon composite film, over the surface of the multi-layer photosensitive layer.

The electrophotosensitive materials of the above examples and comparative examples were subjected to the same photosensitivity test (II), durability test (II) and solvent resistance test as the above and were evaluated for the characteristics thereof. The results as well as those of Comparative Examples 1-12, 1-13 are listed in Table 41.

TABLE 41

| | | | | Initial | | | After durability test | | | |
|---|---|---|---|---|---|---|---|---|---|---|
| | | | | | | HLE | | | HLE | |
| | | P—H | | SP | RP | E_{½} | SP | RP | E_{½} | |
| | SPL | TM | QC | V₀(V) | Vr(V) | (μJ/cm²) | V₀(V) | Vr(V) | (μJ/cm²) | SRT |
| Ex.7-63 | a-C | HT-1 | 4-1-1 | −814 | −157 | 1.181 | −809 | −165 | 1.241 | ◯ |
| Ex.7-64 | a-C | HT-1 | 4-1-11 | −801 | −150 | 1.126 | −806 | −157 | 1.179 | ◯ |
| Ex.7-65 | a-C | HT-1 | 4-2-2 | −795 | −155 | 1.148 | −809 | −163 | 1.207 | ◯ |
| Ex.7-66 | a-C | HT-1 | 4-2-15 | −809 | −162 | 1.159 | −809 | −159 | 1.138 | ◯ |
| Ex.7-67 | a-C | HT-1 | 4-3-2 | −811 | −166 | 1.170 | −817 | −161 | 1.135 | ◯ |
| Ex.7-68 | a-C | HT-1 | 4-3-3 | −801 | −165 | 1.181 | −796 | −160 | 1.145 | ◯ |
| Ex.7-69 | a-C | HT-1 | 4-3-13 | −806 | −163 | 1.170 | −809 | −163 | 1.175 | ◯ |
| C.Ex.1-12 | a-C | HT-1 | — | −785 | −172 | 1.216 | −748 | −198 | 1.400 | X |
| C.Ex.7-12 | a-C | HT-1 | ET-1 | −801 | −169 | 1.251 | −732 | −201 | 1.422 | X |
| Ex.7-70 | a-C | HT-3 | 4-1-1 | −795 | −137 | 1.067 | −793 | −135 | 1.051 | ◯ |
| Ex.7-71 | a-C | HT-3 | 4-1-11 | −806 | −133 | 1.017 | −803 | −130 | 0.994 | ◯ |
| Ex.7-72 | a-C | HT-3 | 4-2-2 | −817 | −133 | 1.037 | −814 | −131 | 1.021 | ◯ |
| Ex.7-73 | a-C | HT-3 | 4-2-15 | −812 | −140 | 1.046 | −808 | −137 | 1.024 | ◯ |
| Ex.7-74 | a-C | HT-3 | 4-3-2 | −801 | −133 | 1.056 | −793 | −131 | 1.040 | ◯ |
| Ex.7-75 | a-C | HT-3 | 4-3-3 | −805 | −140 | 1.067 | −810 | −142 | 1.082 | ◯ |
| Ex.7-76 | a-C | HT-3 | 4-3-13 | −809 | −141 | 1.056 | −800 | −133 | 0.996 | ◯ |
| C.Ex.1-13 | a-C | HT-3 | — | −817 | −146 | 1.098 | −771 | −178 | 1.339 | X |
| C.Ex.7-13 | a-C | HT-3 | ET-1 | −790 | −156 | 1.154 | −743 | −186 | 1.403 | X |

It was confirmed from the table that if the type of the surface protective layer was changed, the same results as the above were obtained according to the compositions of the charge transport layer of the multi-layer photosensitive layer as the base.

Specifically, it was found in the solvent resistance test that both the electrophotosensitive materials of Comparative Examples 7-12, 7-13 suffered the delamination of the surface protective layer similarly to those of comparative Examples 1-12, 1-13. It was thus concluded that adding a compound other than those of the formulas (1) to (4) to the photosensitive layer does not contribute the effect to improve the physical stability of the inorganic surface protective layer.

It was also found that the electrophotosensitive materials of these comparative examples were significantly decreased in photosensitivity when formed with the surface protective layer, because they presented, in the initial stage, large residual potentials after light exposure and large half-life exposures.

Furthermore, the electrophotosensitive materials of these comparative examples were found to have poor durability because they were significantly increased in residual potential and half-life exposure after the durability test.

In contrast, all the electrophotosensitive materials of Examples 7-63 to 7-76 suffered no cracks nor delamination of the surface protective layer in the solvent resistance test. It was thus concluded that the use of the quinone derivative of the formula (4) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

### Examples 7-77 to 7-80, Comparative Example 7-14

Electrophotosensitive materials of these examples and comparative example were fabricated the same way as in Examples 7-56, 7-58, 7-59 and 7-61 and Comparative Example 7-11 except that the same procedure as in Examples 1-25, 1-26 was taken to form a surface protective layer of amorphous silicon-nitrogen (SiN) composite film having a thickness of 0.5 μm, instead of the silicon-carbon composite film, over the surface of the multi-layer photosensitive layer.

### Examples 7-81 to 7-84, Comparative Example 7-15

Electrophotosensitive materials of these examples and comparative example were fabricated the same way as in Examples 7-56, 7-58, 7-59 and 7-61 and Comparative Example 7-11 except that the same procedure as in Examples 1-27, 1-28 was taken to form a surface protective layer of amorphous carbon-nitrogen (CN) composite film having a thickness of 0.5 μm, instead of the silicon-carbon composite film, over the surface of the multi-layer photosensitive layer.

### Examples 7-85 to 7-88, Comparative Example 7-16

Electrophotosensitive materials of these examples and comparative example were fabricated the same way as in Examples 7-56, 7-58, 7-59 and 7-61 and Comparative Example 7-11 except that the same procedure as in Examples 1-29, 1-30 was taken to form a surface protective layer of amorphous carbon-boron (CB) composite film having a thickness of 0.5 μm, instead of the silicon-carbon composite film, over the surface of the multi-layer photosensitive layer.

### Examples 7-89 to 7-92, Comparative Example 7-17

Electrophotosensitive materials of these examples and comparative example were fabricated the same way as in Examples 7-56, 7-58, 7-59 and 7-61 and Comparative Example 7-11 except that the same procedure as in Examples 1-31, 1-32 was taken to form a surface protective layer of amorphous carbon-fluorine (CF) composite film having a thickness of 0.5 μm, instead of the silicon-carbon composite film, over the surface of the multi-layer photosensitive layer.

### Examples 7-93 to 7-96, Comparative Example 7-18

Electrophotosensitive materials of these examples and comparative example were fabricated the same way as in Examples 7-56, 7-58, 7-59 and 7-61 and Comparative Example 7-11 except that the same procedure as in Examples 1-33, 1-34 was taken to form a surface protective layer of amorphous boron-nitrogen (BN) composite film having a thickness of 0.5 μm, instead of the silicon-carbon composite film, over the surface of the multi-layer photosensitive layer.

The electrophotosensitive materials of the above examples and comparative example were subjected to the same photosensitivity test (II), durability test (II) and solvent resistance test as the above and were evaluated for the characteristics thereof. The results as well as those of Comparative Examples 1-14 to 1-18 are listed in Tables 42a, 42b.

TABLE 42a

| | | | | Initial | | | After durability test | | | |
|---|---|---|---|---|---|---|---|---|---|---|
| | | | | | | HLE | | | HLE | |
| | | P-H | | SP | RP | E_{1/2} | SP | RP | E_{1/2} | |
| | SPL | TM | QC | V₀(V) | Vr(V) | (μJ/cm²) | V₀(V) | Vr(V) | (μJ/cm²) | SRT |
| Ex. 7-77 | a-SiN | HT-3 | 4-1-1 | −814 | −144 | 1.074 | −806 | −142 | 1.059 | ◯ |
| Ex. 7-78 | a-SiN | HT-3 | 4-2-2 | −806 | −140 | 1.063 | −798 | −143 | 1.086 | ◯ |
| Ex. 7-79 | a-SiN | HT-3 | 4-2-15 | −798 | −139 | 1.033 | −806 | −141 | 1.048 | ◯ |
| Ex. 7-80 | a-SiN | HT-3 | 4-3-3 | −814 | −133 | 1.015 | −805 | −130 | 0.992 | ◯ |
| C. Ex. 1-14 | a-SiN | HT-3 | — | −785 | −149 | 1.095 | −758 | −186 | 1.367 | Δ |
| C. Ex. 7-14 | a-SiN | HT-3 | ET-1 | −801 | −160 | 1.125 | −750 | −193 | 1.407 | X |
| Ex. 7-81 | a-CN | HT-3 | 4-1-1 | −798 | −146 | 1.133 | −804 | −142 | 1.102 | ◯ |
| Ex. 7-82 | a-CN | HT-3 | 4-2-2 | −803 | −142 | 1.122 | −809 | −144 | 1.138 | ◯ |
| Ex. 7-83 | a-CN | HT-3 | 4-2-15 | −812 | −151 | 0.886 | −804 | −146 | 0.857 | ◯ |
| Ex. 7-84 | a-CN | HT-3 | 4-3-3 | −801 | −146 | 0.869 | −809 | −151 | 0.899 | ◯ |
| C. Ex. 1-15 | a-CN | HT-3 | — | −793 | −148 | 1.155 | −762 | −177 | 1.381 | X |
| C. Ex. 7-15 | a-CN | HT-3 | ET-1 | −817 | −156 | 1.254 | −752 | −186 | 1.465 | X |
| Ex. 7-85 | a-CB | HT-3 | 4-1-1 | −804 | −135 | 0.960 | −798 | −133 | 0.946 | ◯ |
| Ex. 7-86 | a-CB | HT-3 | 4-2-2 | −806 | −129 | 0.951 | −803 | −124 | 0.914 | ◯ |
| Ex. 7-87 | a-CB | HT-3 | 4-2-15 | −801 | −125 | 0.924 | −795 | −120 | 0.887 | ◯ |
| Ex. 7-88 | a-CB | HT-3 | 4-3-3 | −804 | −127 | 0.907 | −810 | −122 | 0.871 | ◯ |
| C. Ex. 1-16 | a-CB | HT-3 | — | −793 | −137 | 0.979 | −746 | −167 | 1.193 | X |
| C. Ex. 7-16 | a-CB | HT-3 | ET-1 | −812 | −130 | 0.979 | −753 | −160 | 1.184 | X |

TABLE 42b

| | | | | Initial | | | After durability test | | | |
|---|---|---|---|---|---|---|---|---|---|---|
| | | | | | | HLE | | | HLE | |
| | | P-H | | SP | RP | E_{1/2} | SP | RP | E_{1/2} | |
| | SPL | TM | QC | V₀(V) | Vr(V) | (μJ/cm²) | V₀(V) | Vr(V) | (μJ/cm²) | SRT |
| Ex. 7-89 | a-CF | HT-3 | 4-1-1 | −809 | −129 | 1.002 | −805 | −127 | 0.986 | ◯ |
| Ex. 7-90 | a-CF | HT-3 | 4-2-2 | −782 | −133 | 0.992 | −785 | −125 | 0.932 | ◯ |
| Ex. 7-91 | a-CF | HT-3 | 4-2-15 | −801 | −129 | 0.964 | −792 | −132 | 0.986 | ◯ |
| Ex. 7-92 | a-CF | HT-3 | 4-3-3 | −808 | −119 | 0.946 | −803 | −122 | 0.970 | ◯ |
| C. Ex. 1-17 | a-CF | HT-3 | — | −793 | −139 | 1.021 | −766 | −178 | 1.307 | X |
| C. Ex. 7-17 | a-CF | HT-3 | ET-1 | −804 | −141 | 1.024 | −758 | −188 | 1.394 | X |
| Ex. 7-93 | a-BN | HT-3 | 4-1-1 | −804 | −108 | 0.887 | −806 | −110 | 0.903 | ◯ |
| Ex. 7-94 | a-BN | HT-3 | 4-2-2 | −817 | −109 | 0.878 | −809 | −112 | 0.902 | ◯ |
| Ex. 7-95 | a-BN | HT-3 | 4-2-15 | −793 | −111 | 0.853 | −798 | −106 | 0.815 | ◯ |
| Ex. 7-96 | a-BN | HT-3 | 4-3-3 | −803 | −109 | 0.838 | −808 | −111 | 0.853 | ◯ |
| C. Ex. 1-18 | a-BN | HT-3 | — | −780 | −117 | 0.904 | −748 | −146 | 1.128 | X |
| C. Ex. 7-18 | a-BN | HT-3 | ET-1 | −790 | −120 | 0.921 | −755 | −149 | 1.195 | X |

It was confirmed from the tables that if the type of the surface protective layer was further changed, the same results as the above were obtained according to the compositions of the charge transport layer of the multi-layer photosensitive layer as the base.

According to the results of the solvent resistance test listed in the tables, all the electrophotosensitive materials of Comparative Examples 7-14 to 7-18 suffered the delamination of the surface protective layer. It was thus concluded that adding a compound 1 other than those of the formulas (1) to (4) to the photosensitive layer does not contribute the effect to improve the physical stability of the inorganic surface protective layer. Some of the electrophotosensitive materials were rather decreased in the stability (Comparative Examples 1-14 and 7-14).

It was also found that the electrophotosensitive materials of these comparative examples were significantly decreased in photosensitivity when formed with the surface protective layer, because they presented, in the initial stage, large residual potentials after light exposure and large half-life exposures.

Furthermore, the electrophotosensitive materials of these comparative examples were found to have poor durability because they were significantly increased in residual potential and half-life exposure after the durability test.

In contrast, all the electrophotosensitive materials of Examples 7-77 to 7-96 suffered no cracks nor delamination of the surface protective layer in the solvent resistance test. It was thus concluded that the use of the quinone derivative of the formula (4) contributed the improvement of the physical stability of the inorganic surface protective layer.

It was also confirmed that all the electrophotosensitive materials of these examples were free from serious decrease in photosensitivity when formed with the surface protective layer and thus maintained high photosensitivity, because they had small residual potentials after light exposure and half-life exposures.

In addition, all the electrophotosensitive materials of these examples were free from significant increase in residual potential and half-life exposure after the durability test. Based on this fact and the results of the solvent resistance test, it was concluded that these electrophotosensitive materials achieved greater improvement in durability than the prior-art products.

What is claimed is:

1. An electrophotosensitive material comprising an organic photosensitive layer and an inorganic surface protective layer laid over a conductive substrate in this order, wherein at least an outermost part of the organic photosensitive layer that contacts the surface protective layer contains at least one compound selected from the group consisting of a diphenoquinone derivative represented by a formula (1): 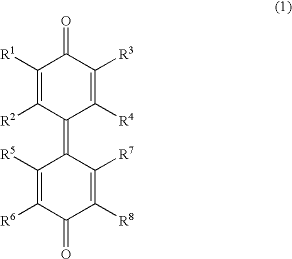
wherein R¹, R², R³, R⁴, R⁵, R⁶, R⁷ and R⁸ are the same or different and each denoting a hydrogen atom, alkyl group, alkoxy group, aryl group, cycloalkyl group or aralkyl group; and out of the groups R¹ to R⁸, two groups bonded to adjacent carbon atoms of the same ring may be linked together to form a condensed ring jointly with the ring; a naphthoquinone derivative represented by a formula (2): 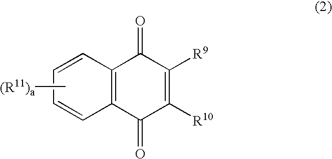
wherein R⁹ and R¹⁰ are the same or different and each denoting a hydrogen atom, alkyl group, alkoxy group, alkylthio group, aryl group, cycloalkyl group, aryloxy group, arylthio group or a group represented by a formula (2a) 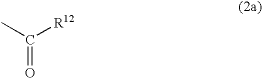
provided that R⁹ and R¹⁰ are not hydrogen atoms at the same time; R⁹ and R¹⁰ may be linked together to form a condensed ring jointly with the ring; R¹¹ denotes a hydrogen atom, halogen atom, alkyl group, alkoxy group, aryl group or aralkyl group; in which formula (2a), R¹² denotes an alkyl group, alkoxy group, aryl group or aryloxy group; and ‘a’ denotes an integer of 0 to 4; a naphthylene diimide derivative represented by a formula (3): 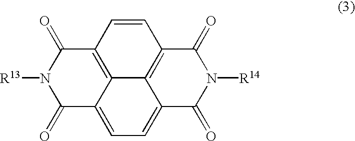
wherein R¹¹ and R¹⁴ are the same or different and each denoting a hydrogen atom, alkyl group, alkoxy group, aryl group, cycloalkyl group or aralkyl group; and a quinone derivative represented by a formula (4): 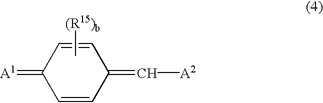
wherein R¹⁵ denotes a hydrogen atom, halogen atom, alkyl group, alkoxy group, aryl group, cycloalkyl group heterocyclic group or aralkyl group; ‘b’ denotes an integer of 0 to 4, provided that when ‘b’ is 2 or more, the two groups R¹⁵ bonded to adjacent carbon atoms of the ring may be linked together to form a condensed ring jointly with the ring; A¹ denotes an oxygen atom or a group represented by a formula (4a): 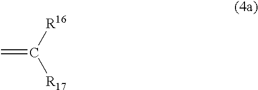
in which R¹⁴ and R¹⁷ are the same or different and each denoting a cyano group or alkoxycarbonyl group; A² denotes a group represented by a formula (4b): 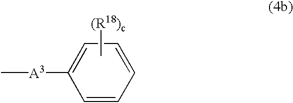
or a formula (4c): 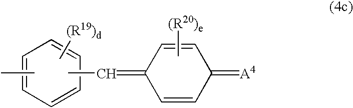
in which formula (4b), A³ denotes a —N═CH— group or —N═N— group; R¹⁸ denotes a hydrogen atom, halogen atom, alkyl group, alkoxy group, aryl group, cycloalkyl group heterocyclic group or aralkyl group; and ‘c’ denotes an integer of 0 to 5, provided that when ‘c’ is 2 or more, the groups R¹⁸ may be linked together to form a condensed ring jointly with the ring;
in which formula (4c), R¹⁹ and R²⁰ are the same or different and each denoting a hydrogen atom, halogen atom, alkyl group, alkoxy group, aryl group, cycloalkyl group or aralkyl group; ‘d’ denotes an integer of 0 to 4, provided that when ‘d’ is 2 or more, the groups R¹⁹ may be linked together to form a condensed ring jointly with the ring; ‘e’ denotes an integer of 0 to 5, provided that when ‘e’ is 2 or more, the two groups R²⁰ bonded to adjacent carbon atoms of the ring may be linked together to form a condensed ring jointly with the ring; and A⁴ denotes an oxygen atom or a group represented by a formula (4d): 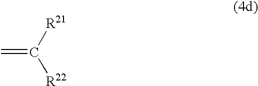
in which R²¹ and R²² are the same or different and each denoting a cyano group or alkoxycarbonyl group.

2. An electrophotosensitive material according to claim 1, wherein the diphenoquinone derivative represented by the formula (1) includes at least one selected from the group consisting of a diphenoquinone compound represented by a formula (1-1): 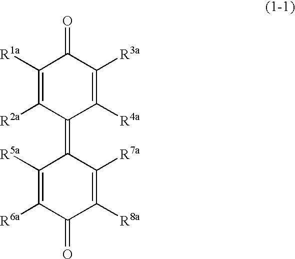
wherein R^{1a}, R^{2a}, R^{3a}, R^{4a}, R^{5a}, R^{6a}, R^{7a} and R^{8a} are the same or different and each denoting a hydrogen atom, alkyl group, alkoxy group, aryl group, cycloalkyl group or aralkyl group; and
a dinaphthoquinone compound represented by a formula (1-2): 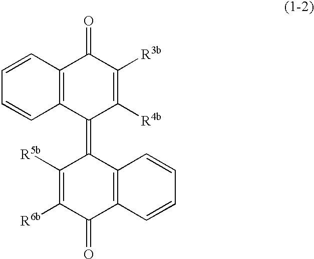
wherein R^{3b}, R^{4b}, R^{5b} and R^{6b} are the same or different and each denoting a hydrogen atom, alkyl group, alkoxy group, aryl group, cycloalkyl group or aralkyl group.

3. An electrophotosensitive material according to claim 1, wherein the naphthoquinone derivative represented by the formula (2) includes at least one selected from the group consisting of a naphthoquinone compound represented by a formula (2-1): 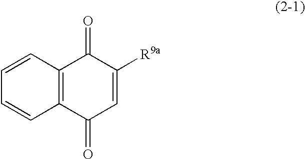
wherein R^{9a} denotes an alkyl group, cycloalkyl group or aryl group;
a naphthoquinone compound represented by a formula (2-2): 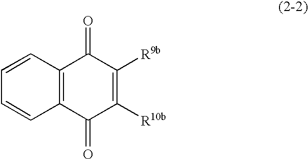
wherein R^{9b} and R^{10b} are the same or different and each denoting an alkoxy group, alkylthio group, aryloxy group or arylthio group;
a naphthoquinone compound represented by a formula (2-3): 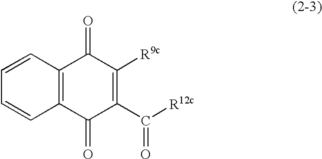
wherein R^{9c} denotes an alkyl group or aryl group; and R^{12c} denotes an alkyl group, alkoxy group, aryl group or aryloxy group;
a diindenopyrazine compound represented by a formula (2-4): 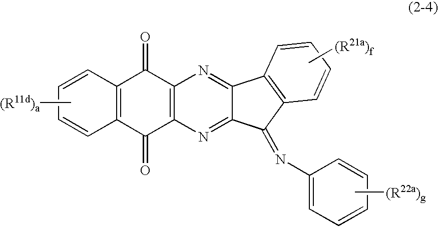
wherein R^{11d}, R^{21a} and R^{22a} are the same or different and each denoting a hydrogen atom, halogen atom, alkyl group, alkoxy group, aryl group or aralkyl group; ‘a’ and ‘f’ are the same or different and each denoting an integer of 0 to 4; and ‘g’ denotes an integer of 0 to 5;
a diindenopyrazine compound represented by a formula (2-5): 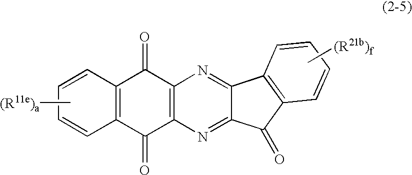
wherein R^{11e} and R^{21b} are the same or different and each denoting a hydrogen atom, halogen atom, alkyl group, alkoxy group, aryl group or aralkyl group; and ‘a’ and ‘f’ are the same or different and each denoting an integer of 0 to 4; and
a dioxotetracenedione compound represented by a formula (2-6): 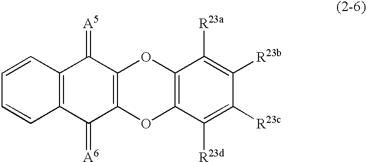
wherein A⁵ and A⁶ are the same or different and each denoting an oxygen atom or ═N—CN group; and R^{23a}, R^{23b}, R^{23c} and R^{23d} are the same or different and each denoting a hydrogen atom, alkyl group, alkoxycarbonyl group, cycloalkyl group or group represented by a formula (2-6a): 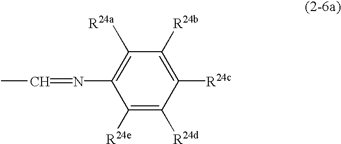
in which R^{24a}, R^{24b}, R^{24c}, R^{24d} and R^{24e} are the same or different and each denoting a hydrogen atom or alkyl group.

4. An electrophotosensitive material according to claim 1, wherein the quinone derivative represented by the formula (4) includes at least one selected from the group consisting of a compound represented by a formula (4-1): 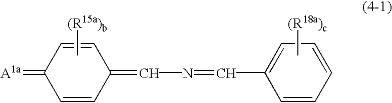
wherein R^{15a} and R^{18a} are the same or different and each denoting a hydrogen atom, halogen atom, alkyl group, alkoxy group, aryl group or aralkyl group; ‘b’ denotes an integer of 0 to 4, provided that when ‘b’ is 2 or more, the two groups R^{15a} bonded to adjacent carbon atoms of the ring may be linked together to form a condensed ring jointly with the ring; ‘c’ denotes an integer of 0 to 5, provided that when ‘c’ is 2 or more, the groups R^{18a} may be linked together to form a condensed ring jointly with the ring; and A^{1a} denotes an oxygen atom or the group represented by the formula (4a);
a compound represented by a formula (4-2): 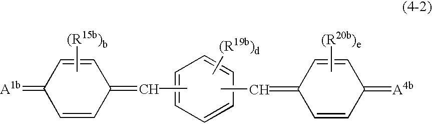
wherein R^{1b}, R^{19b} and R^{20b} are the same or different and each denoting a hydrogen atom, halogen atom, alkyl group, alkoxy group, aryl group, cycloalkyl group, hetero cyclic group or aralkyl group; ‘b’, ‘d’ and ‘e’ are the same or different and each denoting an integer of 0 to 4, provided that when ‘d’ is 2 or more, the groups may be linked together to form a condensed ring jointly with the ring; when ‘b’ or ‘e’ is 2 or more, the corresponding two groups bonded to adjacent carbon atoms of each ring may be linked together to form a condensed ring jointly with the ring; A denotes an oxygen atom or the group represented by the formula (4a); and A^{4b} denotes an oxygen atom or the group represented by the formula (4d); and a compound represented by a formula (4-3): 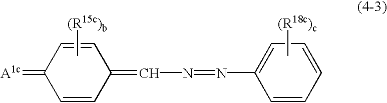
wherein R^{15c} and R^{18c} are the same or different and each denoting a hydrogen atom, halogen atom, alkyl group, alkoxy group, aryl group or aralkyl group; ‘b’ denotes an integer of 0 to 4, provided that when ‘b’ is 2 or more, the two groups R^{15c} bonded to adjacent carbon atoms of the ring may be linked together to form a condensed ring jointly with the ring; ‘c’ denotes an integer of 0 to 5, provided that when ‘c’ is 2 or more, the groups R^{18c} may be linked together to form a condensed ring jointly with the ring; and Ac denotes an oxygen atom or the group represented by the formula (4a).

5. An electrophotosensitive material according to claim 1, wherein the surface protective layer is a layer formed by a vapor deposition method.

6. An electrophotosensitive material according to claim 1, wherein the surface protective layer comprises at least one element selected from the group consisting of metallic elements and carbon or an inorganic compound containing any of these elements.

7. An electrophotosensitive material according to claim 1, wherein the organic photosensitive layer is a single-layer photosensitive layer comprising a binder resin containing therein a charge generating material and any one of the compounds represented by the formulas (1) to (4).

8. An electrophotosensitive material according to claim 1, wherein the organic photosensitive layer is a multi-layer photosensitive layer comprising a charge generating layer and a charge transport layer laminated in this order, the charge generating layer containing a charge generating material, the charge transport layer comprising a binder resin containing therein any one of the compounds represented by the formulas (1) to (4).
